(19) United States
(12) Patent Application Publication
(10) Pub. No.: US 2017/0286110 A1
(43) Pub. Date: Oct. 5, 2017

(54) Auxiliary Cache for Reducing Instruction Fetch and Decode Bandwidth Requirements

(71) Applicant: Intel Corporation, Santa Clara, CA (US)

(72) Inventors: Jason M. Agron, San Jose, CA (US); Alex Merrick, Sunnyvale, CA (US); Vineeth Mekkat, San Jose, CA (US)

(21) Appl. No.: 15/087,786

(22) Filed: Mar. 31, 2016

(51) Int. Cl. G06F 9/30; G06F 12/08

(52) U.S. Cl. CPC G06F 9/3016; G06F 12/0875; G06F 2212/452

(57) ABSTRACT

A hardware-software co-designed processor includes a front end to decode an instruction, an execution unit to execute the instruction, an auxiliary cache to store auxiliary information for consumption during execution of the instruction, an instruction blender, and a retirement unit to retire the instruction. The auxiliary information may include long immediate values, non-working instructions for emulating an untranslated instruction stream, or execution hints, and is not decoded by the front end. The auxiliary cache includes circuitry to receive the auxiliary information from a binary translator, to store the auxiliary information in the auxiliary cache, and to provide the auxiliary information to the instruction blender prior to execution. The instruction blender includes circuitry to receive the auxiliary information, to blend the instruction with the auxiliary information, and to provide the blended instruction to the execution unit. Use of the auxiliary cache may reduce fetch and decode bandwidth requirements.

### FIELD OF THE INVENTION

The present disclosure pertains to the field of processing logic, microprocessors, and associated instruction set architecture that, when executed by the processor or other processing logic, perform logical, mathematical, or other functional operations.

### DESCRIPTION OF RELATED ART

Multiprocessor systems are becoming more and more common. Applications of multiprocessor systems include dynamic domain partitioning all the way down to desktop computing. In order to take advantage of multiprocessor systems, code to be executed may be separated into multiple threads for execution by various processing entities. Each thread may be executed in parallel with one another. Pipelining of applications may be implemented in systems in order to more efficiently execute applications. Instructions as they are received on a processor may be decoded into terms or instruction words that are native, or more native, for execution on the processor. Processors may be implemented in a system on chip.

### DESCRIPTION OF THE FIGURES

Embodiments are illustrated by way of example and not limitation in the Figures of the accompanying drawings:

FIG. 1A is a block diagram of an exemplary computer system formed with a processor that may include execution units to execute an instruction, in accordance with embodiments of the present disclosure;

FIG. 1B illustrates a data processing system, in accordance with embodiments of the present disclosure;

FIG. 1C illustrates other embodiments of a data processing system for performing text string comparison operations;

FIG. 2 is a block diagram of the micro-architecture for a processor that may include logic circuits to perform instructions, in accordance with embodiments of the present disclosure;

FIG. 3A illustrates various packed data type representations in multimedia registers, in accordance with embodiments of the present disclosure;

FIG. 3B illustrates possible in-register data storage formats, in accordance with embodiments of the present disclosure;

FIG. 3C illustrates various signed and unsigned packed data type representations in multimedia registers, in accordance with embodiments of the present disclosure;

FIG. 3D illustrates an embodiment of an operation encoding format;

FIG. 3E illustrates another possible operation encoding format having forty or more bits, in accordance with embodiments of the present disclosure;

FIG. 3F illustrates yet another possible operation encoding format, in accordance with embodiments of the present disclosure;

FIG. 4A is a block diagram illustrating an in-order pipeline and a register renaming stage, out-of-order issue/execution pipeline, in accordance with embodiments of the present disclosure;

FIG. 4B is a block diagram illustrating an in-order architecture core and a register renaming logic, out-of-order issue/execution logic to be included in a processor, in accordance with embodiments of the present disclosure;

FIG. 5A is a block diagram of a processor, in accordance with embodiments of the present disclosure;

FIG. 5B is a block diagram of an example implementation of a core, in accordance with embodiments of the present disclosure;

FIG. 6 is a block diagram of a system, in accordance with embodiments of the present disclosure;

FIG. 7 is a block diagram of a second system, in accordance with embodiments of the present disclosure;

FIG. 8 is a block diagram of a third system in accordance with embodiments of the present disclosure;

FIG. 9 is a block diagram of a system-on-a-chip, in accordance with embodiments of the present disclosure;

FIG. 10 illustrates a processor containing a central processing unit and a graphics processing unit which may perform at least one instruction, in accordance with embodiments of the present disclosure;

FIG. 11 is a block diagram illustrating the development of IP cores, in accordance with embodiments of the present disclosure;

FIG. 12 illustrates how an instruction of a first type may be emulated by a processor of a different type, in accordance with embodiments of the present disclosure;

FIG. 13 illustrates a block diagram contrasting the use of a software instruction converter to convert binary instructions in a source instruction set to binary instructions in a target instruction set, in accordance with embodiments of the present disclosure;

FIG. 14 is a block diagram of an instruction set architecture of a processor, in accordance with embodiments of the present disclosure;

FIG. 15 is a more detailed block diagram of an instruction set architecture of a processor, in accordance with embodiments of the present disclosure;

FIG. 16 is a block diagram of an execution pipeline for an instruction set architecture of a processor, in accordance with embodiments of the present disclosure;

FIG. 17 is a block diagram of an electronic device for utilizing a processor, in accordance with embodiments of the present disclosure;

FIG. 18 is an illustration of an example system for utilizing an auxiliary cache to reduce instruction fetch and decode bandwidth requirements, according to embodiments of the present disclosure;

FIG. 19 is an illustration of an example auxiliary cache, according to embodiments of the present disclosure;

FIG. 20 is an illustration of the operation of a binary translator that utilizes an auxiliary cache, according to embodiments of the present disclosure;

FIG. 21 is an illustration of a method for translating a super block of instructions so that an auxiliary cache is utilized during their execution, according to embodiments of the present disclosure;

FIG. 22 is an illustration of a method for executing an instruction stream that utilizes an auxiliary cache, according to embodiments of the present disclosure; and

FIG. 23 is an illustration of a method for dynamically retranslating an instruction stream to take advantage of an auxiliary cache, according to embodiments of the present disclosure.

### DETAILED DESCRIPTION

The following description describes a processing apparatus and processing logic for utilizing an auxiliary cache to reduce instruction fetch and decode bandwidth requirements. Such a processing apparatus may include an out-of-order processor. In the following description, numerous specific details such as processing logic, processor types, micro-architectural conditions, events, enablement mechanisms, and the like are set forth in order to provide a more thorough understanding of embodiments of the present disclosure. It will be appreciated, however, by one skilled in the art that the embodiments may be practiced without such specific details. Additionally, some well-known structures, circuits, and the like have not been shown in detail to avoid unnecessarily obscuring embodiments of the present disclosure.

Although the following embodiments are described with reference to a processor, other embodiments are applicable to other types of integrated circuits and logic devices. Similar techniques and teachings of embodiments of the present disclosure may be applied to other types of circuits or semiconductor devices that may benefit from higher pipeline throughput and improved performance. The teachings of embodiments of the present disclosure are applicable to any processor or machine that performs data manipulations. However, the embodiments are not limited to processors or machines that perform 512-bit, 256-bit, 128-bit, 64-bit, 32-bit, or 16-bit data operations and may be applied to any processor and machine in which manipulation or management of data may be performed. In addition, the following description provides examples, and the accompanying drawings show various examples for the purposes of illustration. However, these examples should not be construed in a limiting sense as they are merely intended to provide examples of embodiments of the present disclosure rather than to provide an exhaustive list of all possible implementations of embodiments of the present disclosure.

Although the below examples describe instruction handling and distribution in the context of execution units and logic circuits, other embodiments of the present disclosure may be accomplished by way of a data or instructions stored on a machine-readable, tangible medium, which when performed by a machine cause the machine to perform functions consistent with at least one embodiment of the disclosure. In one embodiment, functions associated with embodiments of the present disclosure are embodied in machine-executable instructions. The instructions may be used to cause a general-purpose or special-purpose processor that may be programmed with the instructions to perform the steps of the present disclosure. Embodiments of the present disclosure may be provided as a computer program product or software which may include a machine or computer-readable medium having stored thereon instructions which may be used to program a computer (or other electronic devices) to perform one or more operations according to embodiments of the present disclosure. Furthermore, steps of embodiments of the present disclosure might be performed by specific hardware components that contain fixed-function logic for performing the steps, or by any combination of programmed computer components and fixed-function hardware components.

Instructions used to program logic to perform embodiments of the present disclosure may be stored within a memory in the system, such as DRAM, cache, flash memory, or other storage. Furthermore, the instructions may be distributed via a network or by way of other computer-readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium may include any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as may be useful in simulations, the hardware may be represented using a hardware description language or another functional description language. Additionally, a circuit level model with logic and/or transistor gates may be produced at some stages of the design process. Furthermore, designs, at some stage, may reach a level of data representing the physical placement of various devices in the hardware model. In cases wherein some semiconductor fabrication techniques are used, the data representing the hardware model may be the data specifying the presence or absence of various features on different mask layers for masks used to produce the integrated circuit. In any representation of the design, the data may be stored in any form of a machine-readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or retransmission of the electrical signal is performed, a new copy may be made. Thus, a communication provider or a network provider may store on a tangible, machine-readable medium, at least temporarily, an article, such as information encoded into a carrier wave, embodying techniques of embodiments of the present disclosure.

In modern processors, a number of different execution units may be used to process and execute a variety of code and instructions. Some instructions may be quicker to complete while others may take a number of clock cycles to complete. The faster the throughput of instructions, the better the overall performance of the processor. Thus it would be advantageous to have as many instructions execute as fast as possible. However, there may be certain instructions that have greater complexity and require more in terms of execution time and processor resources, such as floating point instructions, load/store operations, data moves, etc.

As more computer systems are used in internet, text, and multimedia applications, additional processor support has been introduced over time. In one embodiment, an instruction set may be associated with one or more computer architectures, including data types, instructions, register architecture, addressing modes, memory architecture, interrupt and exception handling, and external input and output (I/O).

In one embodiment, the instruction set architecture (ISA) may be implemented by one or more micro-architectures, which may include processor logic and circuits used to implement one or more instruction sets. Accordingly, processors with different micro-architectures may share at least a portion of a common instruction set. For example, Intel® Pentium 4 processors, Intel® Core™ processors, and processors from Advanced Micro Devices, Inc. of Sunnyvale Calif. implement nearly identical versions of the x86 instruction set (with some extensions that have been added with newer versions), but have different internal designs. Similarly, processors designed by other processor development companies, such as ARM Holdings, Ltd., MIPS, or their licensees or adopters, may share at least a portion of a common instruction set, but may include different processor designs. For example, the same register architecture of the ISA may be implemented in different ways in different micro-architectures using new or well-known techniques, including dedicated physical registers, one or more dynamically allocated physical registers using a register renaming mechanism (e.g., the use of a Register Alias Table (RAT), a Reorder Buffer (ROB) and a retirement register file. In one embodiment, registers may include one or more registers, register architectures, register files, or other register sets that may or may not be addressable by a software programmer.

An instruction may include one or more instruction formats. In one embodiment, an instruction format may indicate various fields (number of bits, location of bits, etc.) to specify, among other things, the operation to be performed and the operands on which that operation will be performed. In a further embodiment, some instruction formats may be further defined by instruction templates (or sub-formats). For example, the instruction templates of a given instruction format may be defined to have different subsets of the instruction format's fields and/or defined to have a given field interpreted differently. In one embodiment, an instruction may be expressed using an instruction format (and, if defined, in a given one of the instruction templates of that instruction format) and specifies or indicates the operation and the operands upon which the operation will operate.

Scientific, financial, auto-vectorized general purpose, RMS (recognition, mining, and synthesis), and visual and multimedia applications (e.g., 2D/3D graphics, image processing, video compression/decompression, voice recognition algorithms and audio manipulation) may require the same operation to be performed on a large number of data items. In one embodiment, Single Instruction Multiple Data (SIMD) refers to a type of instruction that causes a processor to perform an operation on multiple data elements. SIMD technology may be used in processors that may logically divide the bits in a register into a number of fixed-sized or variable-sized data elements, each of which represents a separate value. For example, in one embodiment, the bits in a 64-bit register may be organized as a source operand containing four separate 16-bit data elements, each of which represents a separate 16-bit value. This type of data may be referred to as ‘packed’ data type or ‘vector’ data type, and operands of this data type may be referred to as packed data operands or vector operands. In one embodiment, a packed data item or vector may be a sequence of packed data elements stored within a single register, and a packed data operand or a vector operand may a source or destination operand of a SIMD instruction (or ‘packed data instruction’ or a ‘vector instruction’). In one embodiment, a SIMD instruction specifies a single vector operation to be performed on two source vector operands to generate a destination vector operand (also referred to as a result vector operand) of the same or different size, with the same or different number of data elements, and in the same or different data element order.

SIMD technology, such as that employed by the Intel® Core™ processors having an instruction set including x86, MMX™, Streaming SIMD Extensions (SSE), SSE2, SSE3, SSE4.1, and SSE4.2 instructions, ARM processors, such as the ARM Cortex® family of processors having an instruction set including the Vector Floating Point (VFP) and/or NEON instructions, and MIPS processors, such as the Loongson family of processors developed by the Institute of Computing Technology (ICT) of the Chinese Academy of Sciences, has enabled a significant improvement in application performance (Core™ and MMX™ are registered trademarks or trademarks of Intel Corporation of Santa Clara, Calif.).

In one embodiment, destination and source registers/data may be generic terms to represent the source and destination of the corresponding data or operation. In some embodiments, they may be implemented by registers, memory, or other storage areas having other names or functions than those depicted. For example, in one embodiment, “DEST1” may be a temporary storage register or other storage area, whereas “SRC1” and “SRC2” may be a first and second source storage register or other storage area, and so forth. In other embodiments, two or more of the SRC and DEST storage areas may correspond to different data storage elements within the same storage area (e.g., a SIMD register). In one embodiment, one of the source registers may also act as a destination register by, for example, writing back the result of an operation performed on the first and second source data to one of the two source registers serving as a destination registers.

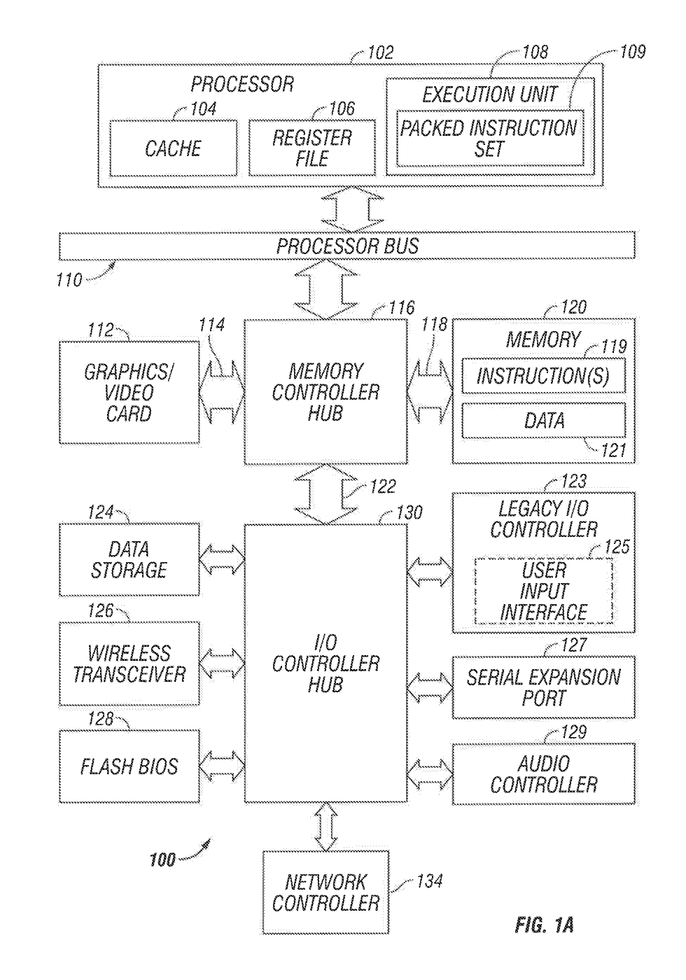

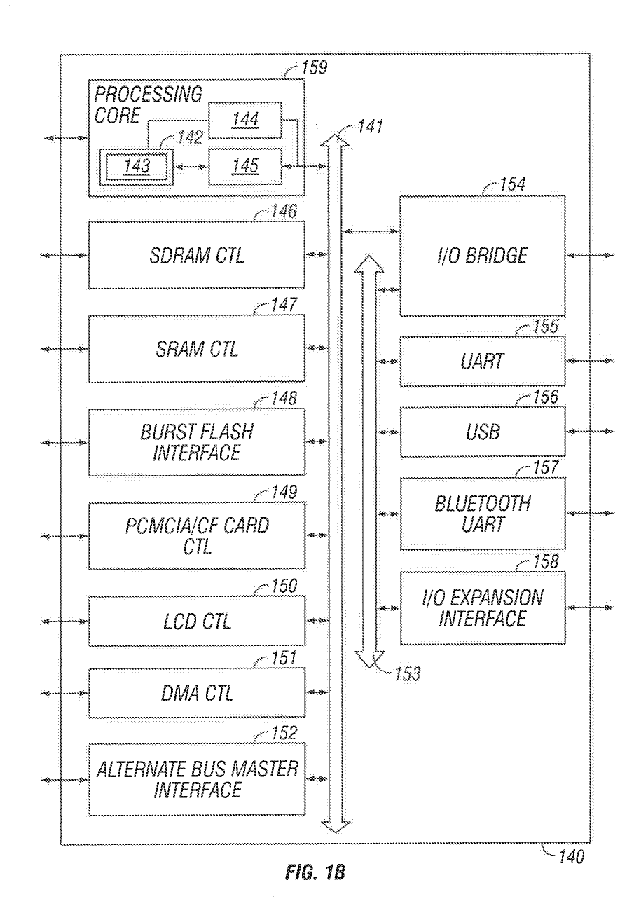

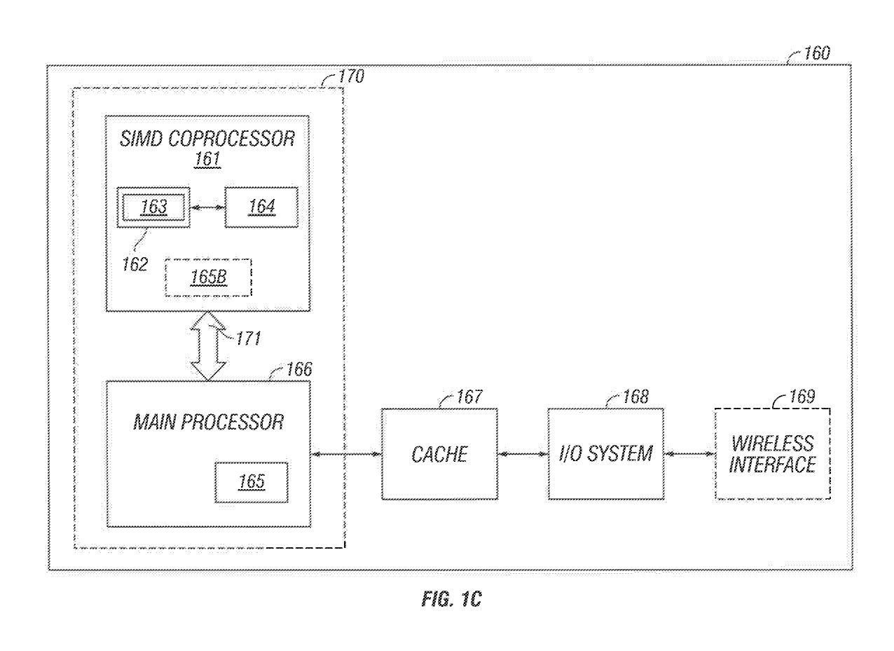

FIG. 1A is a block diagram of an exemplary computer system formed with a processor that may include execution units to execute an instruction, in accordance with embodiments of the present disclosure. System 100 may include a component, such as a processor 102 to employ execution units including logic to perform algorithms for process data, in accordance with the present disclosure, such as in the embodiment described herein. System 100 may be representative of processing systems based on the PENTIUM® III, PENTIUM® 4, Xeon™, Itanium®, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 100 may execute a version of the WINDOWS™ operating system available from Microsoft Corporation of Redmond, Wash., although other operating systems (UNIX and Linux for example), embedded software, and/or graphical user interfaces, may also be used. Thus, embodiments of the present disclosure are not limited to any specific combination of hardware circuitry and software.

Embodiments are not limited to computer systems. Embodiments of the present disclosure may be used in other devices such as handheld devices and embedded applications. Some examples of handheld devices include cellular phones, Internet Protocol devices, digital cameras, personal digital assistants (PDAs), and handheld PCs. Embedded applications may include a micro controller, a digital signal processor (DSP), system on a chip, network computers (NetPC), set-top boxes, network hubs, wide area network (WAN) switches, or any other system that may perform one or more instructions in accordance with at least one embodiment.

Computer system 100 may include a processor 102 that may include one or more execution units 108 to perform an algorithm to perform at least one instruction in accordance with one embodiment of the present disclosure. One embodiment may be described in the context of a single processor desktop or server system, but other embodiments may be included in a multiprocessor system. System 100 may be an example of a ‘hub’ system architecture. System 100 may include a processor 102 for processing data signals. Processor 102 may include a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. In one embodiment, processor 102 may be coupled to a processor bus 110 that may transmit data signals between processor 102 and other components in system 100. The elements of system 100 may perform conventional functions that are well known to those familiar with the art.

In one embodiment, processor 102 may include a Level 1 (L1) internal cache memory 104. Depending on the architecture, the processor 102 may have a single internal cache or multiple levels of internal cache. In another embodiment, the cache memory may reside external to processor 102. Other embodiments may also include a combination of both internal and external caches depending on the particular implementation and needs. Register file 106 may store different types of data in various registers including integer registers, floating point registers, status registers, and instruction pointer register.

Execution unit 108, including logic to perform integer and floating point operations, also resides in processor 102. Processor 102 may also include a microcode (ucode) ROM that stores microcode for certain macroinstructions. In one embodiment, execution unit 108 may include logic to handle a packed instruction set 109. By including the packed instruction set 109 in the instruction set of a general-purpose processor 102, along with associated circuitry to execute the instructions, the operations used by many multimedia applications may be performed using packed data in a general-purpose processor 102. Thus, many multimedia applications may be accelerated and executed more efficiently by using the full width of a processor's data bus for performing operations on packed data. This may eliminate the need to transfer smaller units of data across the processor's data bus to perform one or more operations one data element at a time.

Embodiments of an execution unit 108 may also be used in micro controllers, embedded processors, graphics devices, DSPs, and other types of logic circuits. System 100 may include a memory 120. Memory 120 may be implemented as a dynamic random access memory (DRAM) device, a static random access memory (SRAM) device, flash memory device, or other memory device. Memory 120 may store instructions 119 and/or data 121 represented by data signals that may be executed by processor 102.

A system logic chip 116 may be coupled to processor bus 110 and memory 120. System logic chip 116 may include a memory controller hub (MCH). Processor 102 may communicate with MCH 116 via a processor bus 110. MCH 116 may provide a high bandwidth memory path 118 to memory 120 for storage of instructions 119 and data 121 and for storage of graphics commands, data and textures. MCH 116 may direct data signals between processor 102, memory 120, and other components in system 100 and to bridge the data signals between processor bus 110, memory 120, and system I/O 122. In some embodiments, the system logic chip 116 may provide a graphics port for coupling to a graphics controller 112. MCH 116 may be coupled to memory 120 through a memory interface 118. Graphics card 112 may be coupled to MCH 116 through an Accelerated Graphics Port (AGP) interconnect 114.

System 100 may use a proprietary hub interface bus 122 to couple MCH 116 to I/O controller hub (ICH) 130. In one embodiment, ICH 130 may provide direct connections to some I/O devices via a local I/O bus. The local I/O bus may include a high-speed I/O bus for connecting peripherals to memory 120, chipset, and processor 102. Examples may include the audio controller 129, firmware hub (flash BIOS) 128, wireless transceiver 126, data storage 124, legacy I/O controller 123 containing user input interface 125 (which may include a keyboard interface), a serial expansion port 127 such as Universal Serial Bus (USB), and a network controller 134. Data storage device 124 may comprise a hard disk drive, a floppy disk drive, a CD-ROM device, a flash memory device, or other mass storage device.

For another embodiment of a system, an instruction in accordance with one embodiment may be used with a system on a chip. One embodiment of a system on a chip comprises of a processor and a memory. The memory for one such system may include a flash memory. The flash memory may be located on the same die as the processor and other system components. Additionally, other logic blocks such as a memory controller or graphics controller may also be located on a system on a chip.

FIG. 1B illustrates a data processing system 140 which implements the principles of embodiments of the present disclosure. It will be readily appreciated by one of skill in the art that the embodiments described herein may operate with alternative processing systems without departure from the scope of embodiments of the disclosure.

Computer system 140 comprises a processing core 159 for performing at least one instruction in accordance with one embodiment. In one embodiment, processing core 159 represents a processing unit of any type of architecture, including but not limited to a CISC, a RISC or a VLIW type architecture. Processing core 159 may also be suitable for manufacture in one or more process technologies and by being represented on a machine-readable media in sufficient detail, may be suitable to facilitate said manufacture.

Processing core 159 comprises an execution unit 142, a set of register files 145, and a decoder 144. Processing core 159 may also include additional circuitry (not shown) which may be unnecessary to the understanding of embodiments of the present disclosure. Execution unit 142 may execute instructions received by processing core 159. In addition to performing typical processor instructions, execution unit 142 may perform instructions in packed instruction set 143 for performing operations on packed data formats. Packed instruction set 143 may include instructions for performing embodiments of the disclosure and other packed instructions. Execution unit 142 may be coupled to register file 145 by an internal bus. Register file 145 may represent a storage area on processing core 159 for storing information, including data. As previously mentioned, it is understood that the storage area may store the packed data might not be critical. Execution unit 142 may be coupled to decoder 144. Decoder 144 may decode instructions received by processing core 159 into control signals and/or microcode entry points. In response to these control signals and/or microcode entry points, execution unit 142 performs the appropriate operations. In one embodiment, the decoder may interpret the opcode of the instruction, which will indicate what operation should be performed on the corresponding data indicated within the instruction.

Processing core 159 may be coupled with bus 141 for communicating with various other system devices, which may include but are not limited to, for example, synchronous dynamic random access memory (SDRAM) control 146, static random access memory (SRAM) control 147, burst flash memory interface 148, personal computer memory card international association (PCMCIA)/compact flash (CF) card control 149, liquid crystal display (LCD) control 150, direct memory access (DMA) controller 151, and alternative bus master interface 152. In one embodiment, data processing system 140 may also comprise an I/O bridge 154 for communicating with various I/O devices via an I/O bus 153. Such I/O devices may include but are not limited to, for example, universal asynchronous receiver/transmitter (UART) 155, universal serial bus (USB) 156, Bluetooth wireless UART 157 and I/O expansion interface 158.

One embodiment of data processing system 140 provides for mobile, network and/or wireless communications and a processing core 159 that may perform SIMD operations including a text string comparison operation. Processing core 159 may be programmed with various audio, video, imaging and communications algorithms including discrete transformations such as a Walsh-Hadamard transform, a fast Fourier transform (FFT), a discrete cosine transform (DCT), and their respective inverse transforms; compression/decompression techniques such as color space transformation, video encode motion estimation or video decode motion compensation; and modulation/demodulation (MODEM) functions such as pulse coded modulation (PCM).

FIG. 1C illustrates other embodiments of a data processing system that performs SIMD text string comparison operations. In one embodiment, data processing system 160 may include a main processor 166, a SIMD coprocessor 161, a cache memory 167, and an input/output system 168. Input/output system 168 may optionally be coupled to a wireless interface 169. SIMD coprocessor 161 may perform operations including instructions in accordance with one embodiment. In one embodiment, processing core 170 may be suitable for manufacture in one or more process technologies and by being represented on a machine-readable media in sufficient detail, may be suitable to facilitate the manufacture of all or part of data processing system 160 including processing core 170.

In one embodiment, SIMD coprocessor 161 comprises an execution unit 162 and a set of register files 164. One embodiment of main processor 166 comprises a decoder 165 to recognize instructions of instruction set 163 including instructions in accordance with one embodiment for execution by execution unit 162. In other embodiments, SIMD coprocessor 161 also comprises at least part of decoder 165 (shown as 165B) to decode instructions of instruction set 163. Processing core 170 may also include additional circuitry (not shown) which may be unnecessary to the understanding of embodiments of the present disclosure.

In operation, main processor 166 executes a stream of data processing instructions that control data processing operations of a general type including interactions with cache memory 167, and input/output system 168. Embedded within the stream of data processing instructions may be SIMD coprocessor instructions. Decoder 165 of main processor 166 recognizes these SIMD coprocessor instructions as being of a type that should be executed by an attached SIMD coprocessor 161. Accordingly, main processor 166 issues these SIMD coprocessor instructions (or control signals representing SIMD coprocessor instructions) on the coprocessor bus 166. From coprocessor bus 171, these instructions may be received by any attached SIMD coprocessors. In this case, SIMD coprocessor 161 may accept and execute any received SIMD coprocessor instructions intended for it.

Data may be received via wireless interface 169 for processing by the SIMD coprocessor instructions. For one example, voice communication may be received in the form of a digital signal, which may be processed by the SIMD coprocessor instructions to regenerate digital audio samples representative of the voice communications. For another example, compressed audio and/or video may be received in the form of a digital bit stream, which may be processed by the SIMD coprocessor instructions to regenerate digital audio samples and/or motion video frames. In one embodiment of processing core 170, main processor 166, and a SIMD coprocessor 161 may be integrated into a single processing core 170 comprising an execution unit 162, a set of register files 164, and a decoder 165 to recognize instructions of instruction set 163 including instructions in accordance with one embodiment.

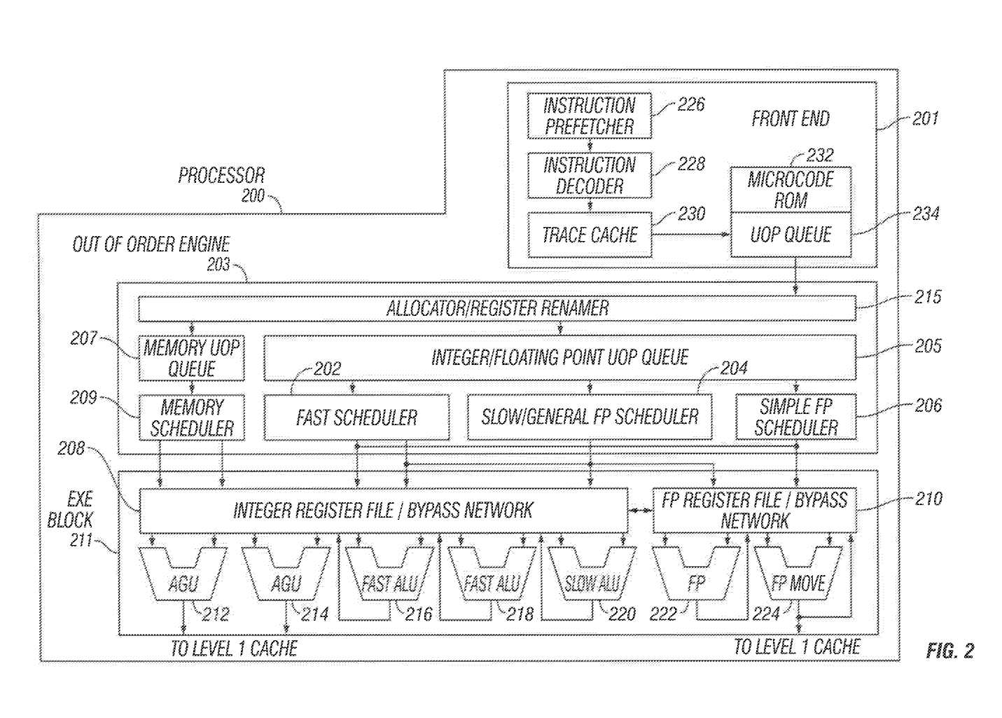

FIG. 2 is a block diagram of the micro-architecture for a processor 200 that may include logic circuits to perform instructions, in accordance with embodiments of the present disclosure. In some embodiments, an instruction in accordance with one embodiment may be implemented to operate on data elements having sizes of byte, word, doubleword, quadword, etc., as well as datatypes, such as single and double precision integer and floating point datatypes. In one embodiment, in-order front end 201 may implement a part of processor 200 that may fetch instructions to be executed and prepares the instructions to be used later in the processor pipeline. Front end 201 may include several units. In one embodiment, instruction prefetcher 226 fetches instructions from memory and feeds the instructions to an instruction decoder 228 which in turn decodes or interprets the instructions. For example, in one embodiment, the decoder decodes a received instruction into one or more operations called “micro-instructions” or “micro-operations” (also called micro op or uops) that the machine may execute. In other embodiments, the decoder parses the instruction into an opcode and corresponding data and control fields that may be used by the micro-architecture to perform operations in accordance with one embodiment. In one embodiment, trace cache 230 may assemble decoded uops into program ordered sequences or traces in uop queue 234 for execution. When trace cache 230 encounters a complex instruction, microcode ROM 232 provides the uops needed to complete the operation.

Some instructions may be converted into a single micro-op, whereas others need several micro-ops to complete the full operation. In one embodiment, if more than four micro-ops are needed to complete an instruction, decoder 228 may access microcode ROM 232 to perform the instruction. In one embodiment, an instruction may be decoded into a small number of micro ops for processing at instruction decoder 228. In another embodiment, an instruction may be stored within microcode ROM 232 should a number of micro-ops be needed to accomplish the operation. Trace cache 230 refers to an entry point programmable logic array (PLA) to determine a correct micro-instruction pointer for reading the micro-code sequences to complete one or more instructions in accordance with one embodiment from micro-code ROM 232. After microcode ROM 232 finishes sequencing micro-ops for an instruction, front end 201 of the machine may resume fetching micro-ops from trace cache 230.

Out-of-order execution engine 203 may prepare instructions for execution. The out-of-order execution logic has a number of buffers to smooth out and re-order the flow of instructions to optimize performance as they go down the pipeline and get scheduled for execution. The allocator logic in allocator/register renamer 215 allocates the machine buffers and resources that each uop needs in order to execute. The register renaming logic in allocator/register renamer 215 renames logic registers onto entries in a register file. The allocator 215 also allocates an entry for each uop in one of the two uop queues, one for memory operations (memory uop queue 207) and one for non-memory operations (integer/floating point uop queue 205), in front of the instruction schedulers: memory scheduler 209, fast scheduler 202, slow/general floating point scheduler 204, and simple floating point scheduler 206. Uop schedulers 202, 204, 206, determine when a uop is ready to execute based on the readiness of their dependent input register operand sources and the availability of the execution resources the uops need to complete their operation. Fast scheduler 202 of one embodiment may schedule on each half of the main clock cycle while the other schedulers may only schedule once per main processor clock cycle. The schedulers arbitrate for the dispatch ports to schedule uops for execution.

Register files 208, 210 may be arranged between schedulers 202, 204, 206, and execution units 212, 214, 216, 218, 220, 222, 224 in execution block 211. Each of register files 208, 210 perform integer and floating point operations, respectively. Each register file 208, 210, may include a bypass network that may bypass or forward just completed results that have not yet been written into the register file to new dependent uops. Integer register file 208 and floating point register file 210 may communicate data with the other. In one embodiment, integer register file 208 may be split into two separate register files, one register file for low-order thirty-two bits of data and a second register file for high order thirty-two bits of data. Floating point register file 210 may include 128-bit wide entries because floating point instructions typically have operands from 64 to 128 bits in width.

Execution block 211 may contain execution units 212, 214, 216, 218, 220, 222, 224. Execution units 212, 214, 216, 218, 220, 222, 224 may execute the instructions. Execution block 211 may include register files 208, 210 that store the integer and floating point data operand values that the micro-instructions need to execute. In one embodiment, processor 200 may comprise a number of execution units: address generation unit (AGU) 212, AGU 214, fast ALU 216, fast ALU 218, slow ALU 220, floating point ALU 222, floating point move unit 224. In another embodiment, floating point execution blocks 222, 224, may execute floating point, MMX, SIMD, and SSE, or other operations. In yet another embodiment, floating point ALU 222 may include a 64-bit by 64-bit floating point divider to execute divide, square root, and remainder micro-ops. In various embodiments, instructions involving a floating point value may be handled with the floating point hardware. In one embodiment, ALU operations may be passed to high-speed ALU execution units 216, 218. High-speed ALUs 216, 218 may execute fast operations with an effective latency of half a clock cycle. In one embodiment, most complex integer operations go to slow ALU 220 as slow ALU 220 may include integer execution hardware for long-latency type of operations, such as a multiplier, shifts, flag logic, and branch processing. Memory load/store operations may be executed by AGUs 212, 214. In one embodiment, integer ALUs 216, 218, 220 may perform integer operations on 64-bit data operands. In other embodiments, ALUs 216, 218, 220 may be implemented to support a variety of data bit sizes including sixteen, thirty-two, 128, 256, etc. Similarly, floating point units 222, 224 may be implemented to support a range of operands having bits of various widths. In one embodiment, floating point units 222, 224, may operate on 128-bit wide packed data operands in conjunction with SIMD and multimedia instructions.

In one embodiment, uops schedulers 202, 204, 206, dispatch dependent operations before the parent load has finished executing. As uops may be speculatively scheduled and executed in processor 200, processor 200 may also include logic to handle memory misses. If a data load misses in the data cache, there may be dependent operations in flight in the pipeline that have left the scheduler with temporarily incorrect data. A replay mechanism tracks and re-executes instructions that use incorrect data. Only the dependent operations might need to be replayed and the independent ones may be allowed to complete. The schedulers and replay mechanism of one embodiment of a processor may also be designed to catch instruction sequences for text string comparison operations.

The term “registers” may refer to the on-board processor storage locations that may be used as part of instructions to identify operands. In other words, registers may be those that may be usable from the outside of the processor (from a programmer's perspective). However, in some embodiments registers might not be limited to a particular type of circuit. Rather, a register may store data, provide data, and perform the functions described herein. The registers described herein may be implemented by circuitry within a processor using any number of different techniques, such as dedicated physical registers, dynamically allocated physical registers using register renaming, combinations of dedicated and dynamically allocated physical registers, etc. In one embodiment, integer registers store 32-bit integer data. A register file of one embodiment also contains eight multimedia SIMD registers for packed data. For the discussions below, the registers may be understood to be data registers designed to hold packed data, such as 64-bit wide MMX™ registers (also referred to as ‘mm’ registers in some instances) in microprocessors enabled with MMX technology from Intel Corporation of Santa Clara, Calif. These MMX registers, available in both integer and floating point forms, may operate with packed data elements that accompany SIMD and SSE instructions. Similarly, 128-bit wide XMM registers relating to SSE2, SSE3, SSE4, or beyond (referred to generically as “SSEx”) technology may hold such packed data operands. In one embodiment, in storing packed data and integer data, the registers do not need to differentiate between the two data types. In one embodiment, integer and floating point data may be contained in the same register file or different register files. Furthermore, in one embodiment, floating point and integer data may be stored in different registers or the same registers.

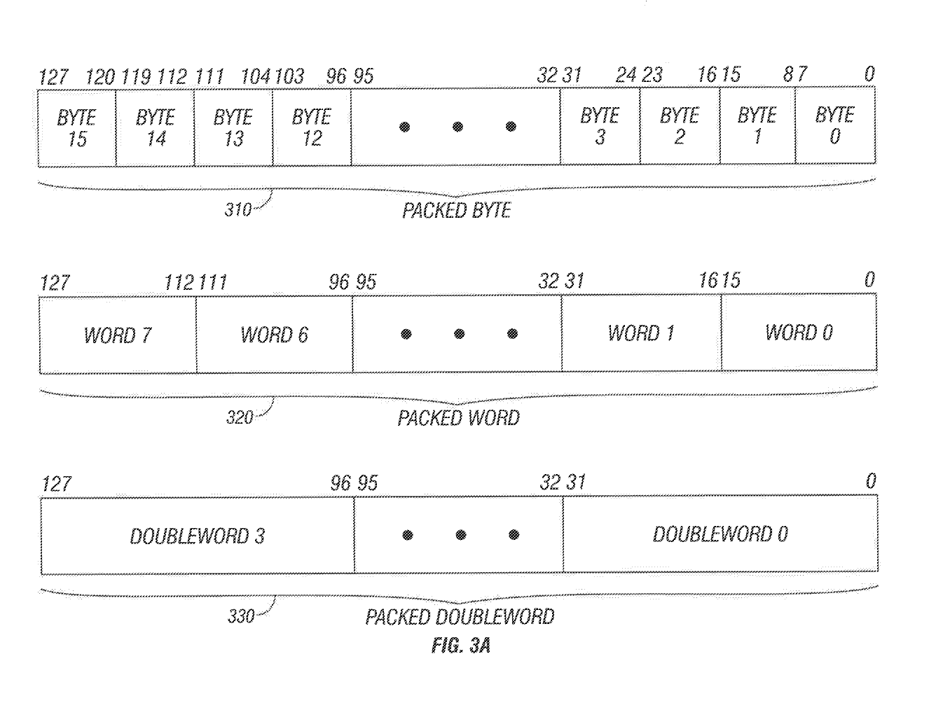

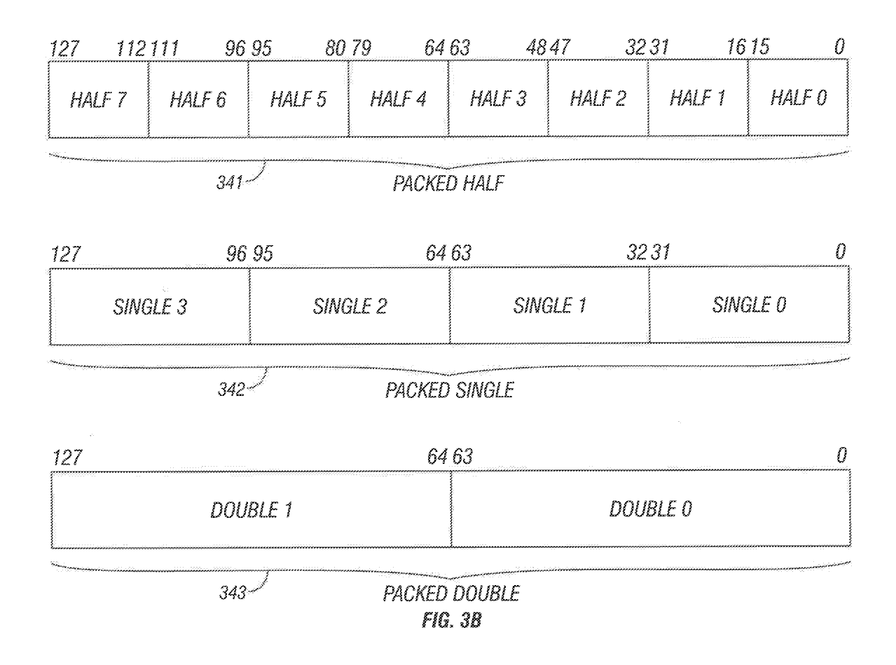

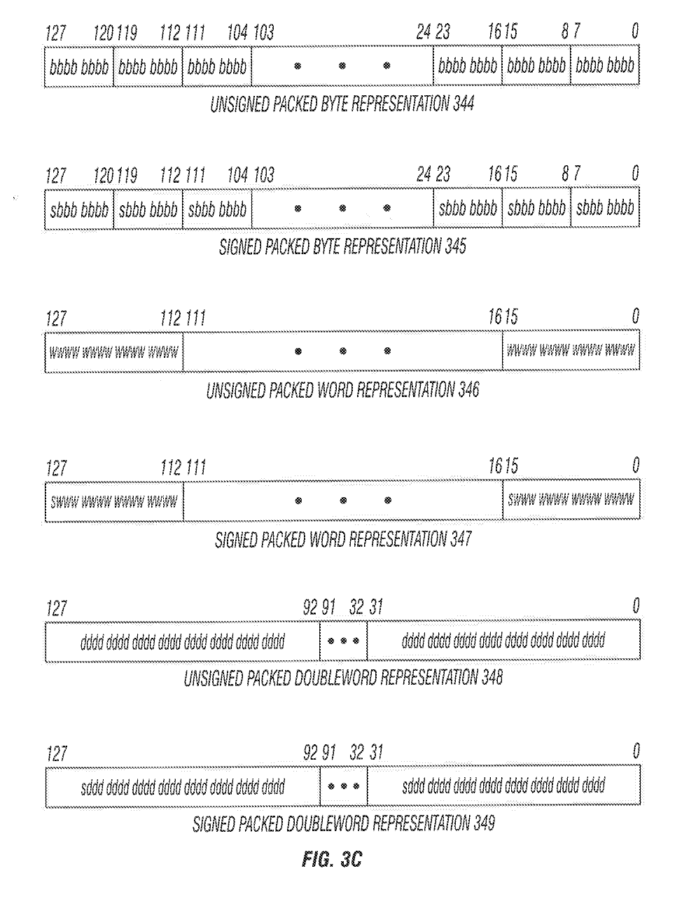

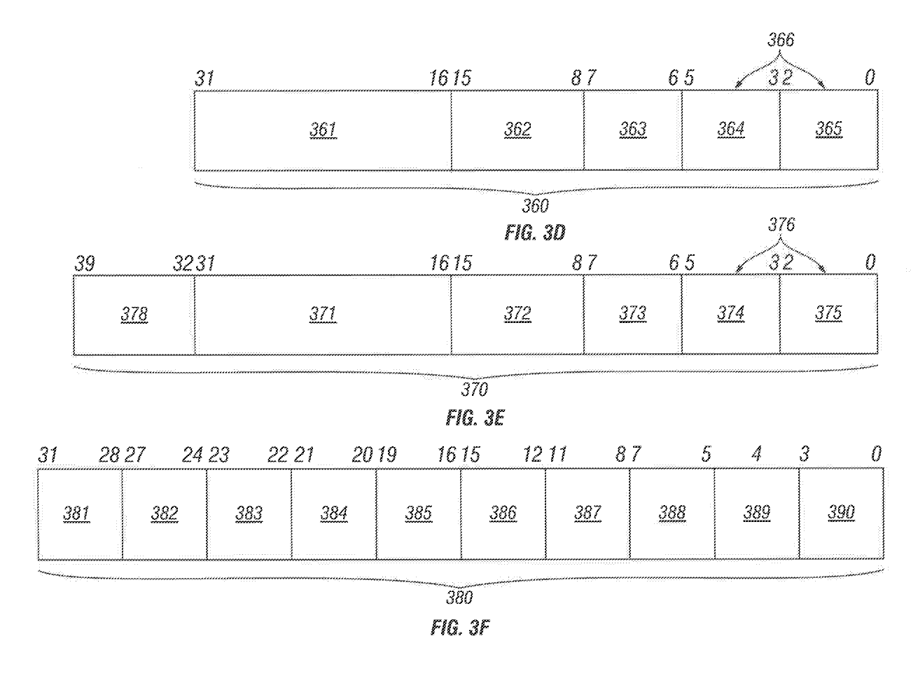

In the examples of the following figures, a number of data operands may be described. FIG. 3A illustrates various packed data type representations in multimedia registers, in accordance with embodiments of the present disclosure. FIG. 3A illustrates data types for a packed byte 310, a packed word 320, and a packed doubleword (dword) 330 for 128-bit wide operands. Packed byte format 310 of this example may be 128 bits long and contains sixteen packed byte data elements. A byte may be defined, for example, as eight bits of data. Information for each byte data element may be stored in bit 7 through bit 0 for byte 0, bit 15 through bit 8 for byte 1, bit 23 through bit 16 for byte 2, and finally bit 120 through bit 127 for byte 15. Thus, all available bits may be used in the register. This storage arrangement increases the storage efficiency of the processor. As well, with sixteen data elements accessed, one operation may now be performed on sixteen data elements in parallel.

Generally, a data element may include an individual piece of data that is stored in a single register or memory location with other data elements of the same length. In packed data sequences relating to SSEx technology, the number of data elements stored in a XMM register may be 128 bits divided by the length in bits of an individual data element. Similarly, in packed data sequences relating to MMX and SSE technology, the number of data elements stored in an MMX register may be 64 bits divided by the length in bits of an individual data element. Although the data types illustrated in FIG. 3A may be 128 bits long, embodiments of the present disclosure may also operate with 64-bit wide or other sized operands. Packed word format 320 of this example may be 128 bits long and contains eight packed word data elements. Each packed word contains sixteen bits of information. Packed doubleword format 330 of FIG. 3A may be 128 bits long and contains four packed doubleword data elements. Each packed doubleword data element contains thirty-two bits of information. A packed quadword may be 128 bits long and contain two packed quad-word data elements.

FIG. 3B illustrates possible in-register data storage formats, in accordance with embodiments of the present disclosure. Each packed data may include more than one independent data element. Three packed data formats are illustrated; packed half 341, packed single 342, and packed double 343. One embodiment of packed half 341, packed single 342, and packed double 343 contain fixed-point data elements. For another embodiment one or more of packed half 341, packed single 342, and packed double 343 may contain floating-point data elements. One embodiment of packed half 341 may be 128 bits long containing eight 16-bit data elements. One embodiment of packed single 342 may be 128 bits long and contains four 32-bit data elements. One embodiment of packed double 343 may be 128 bits long and contains two 64-bit data elements. It will be appreciated that such packed data formats may be further extended to other register lengths, for example, to 96-bits, 160-bits, 192-bits, 224-bits, 256-bits or more.

FIG. 3C illustrates various signed and unsigned packed data type representations in multimedia registers, in accordance with embodiments of the present disclosure. Unsigned packed byte representation 344 illustrates the storage of an unsigned packed byte in a SIMD register. Information for each byte data element may be stored in bit 7 through bit 0 for byte 0, bit 15 through bit 8 for byte 1, bit 23 through bit 16 for byte 2, and finally bit 120 through bit 127 for byte 15. Thus, all available bits may be used in the register. This storage arrangement may increase the storage efficiency of the processor. As well, with sixteen data elements accessed, one operation may now be performed on sixteen data elements in a parallel fashion. Signed packed byte representation 345 illustrates the storage of a signed packed byte. Note that the eighth bit of every byte data element may be the sign indicator. Unsigned packed word representation 346 illustrates how word seven through word zero may be stored in a SIMD register. Signed packed word representation 347 may be similar to the unsigned packed word in-register representation 346. Note that the sixteenth bit of each word data element may be the sign indicator. Unsigned packed doubleword representation 348 shows how doubleword data elements are stored. Signed packed doubleword representation 349 may be similar to unsigned packed doubleword in-register representation 348. Note that the necessary sign bit may be the thirty-second bit of each doubleword data element.

FIG. 3D illustrates an embodiment of an operation encoding (opcode). Furthermore, format 360 may include register/memory operand addressing modes corresponding with a type of opcode format described in the “IA-32 Intel Architecture Software Developer's Manual Volume 2: Instruction Set Reference,” which is available from Intel Corporation, Santa Clara, Calif. on the world-wide-web (www) at intel.com/design/litcentr. In one embodiment, an instruction may be encoded by one or more of fields 361 and 362. Up to two operand locations per instruction may be identified, including up to two source operand identifiers 364 and 365. In one embodiment, destination operand identifier 366 may be the same as source operand identifier 364, whereas in other embodiments they may be different. In another embodiment, destination operand identifier 366 may be the same as source operand identifier 365, whereas in other embodiments they may be different. In one embodiment, one of the source operands identified by source operand identifiers 364 and 365 may be overwritten by the results of the text string comparison operations, whereas in other embodiments identifier 364 corresponds to a source register element and identifier 365 corresponds to a destination register element. In one embodiment, operand identifiers 364 and 365 may identify 32-bit or 64-bit source and destination operands.

FIG. 3E illustrates another possible operation encoding (opcode) format 370, having forty or more bits, in accordance with embodiments of the present disclosure. Opcode format 370 corresponds with opcode format 360 and comprises an optional prefix byte 378. An instruction according to one embodiment may be encoded by one or more of fields 378, 371, and 372. Up to two operand locations per instruction may be identified by source operand identifiers 374 and 375 and by prefix byte 378. In one embodiment, prefix byte 378 may be used to identify 32-bit or 64-bit source and destination operands. In one embodiment, destination operand identifier 376 may be the same as source operand identifier 374, whereas in other embodiments they may be different. For another embodiment, destination operand identifier 376 may be the same as source operand identifier 375, whereas in other embodiments they may be different. In one embodiment, an instruction operates on one or more of the operands identified by operand identifiers 374 and 375 and one or more operands identified by operand identifiers 374 and 375 may be overwritten by the results of the instruction, whereas in other embodiments, operands identified by identifiers 374 and 375 may be written to another data element in another register. Opcode formats 360 and 370 allow register to register, memory to register, register by memory, register by register, register by immediate, register to memory addressing specified in part by MOD fields 363 and 373 and by optional scale-index-base and displacement bytes.

FIG. 3F illustrates yet another possible operation encoding (opcode) format, in accordance with embodiments of the present disclosure. 64-bit single instruction multiple data (SIMD) arithmetic operations may be performed through a coprocessor data processing (CDP) instruction. Operation encoding (opcode) format 380 depicts one such CDP instruction having CDP opcode fields 382 and 389. The type of CDP instruction, for another embodiment, operations may be encoded by one or more of fields 383, 384, 387, and 388. Up to three operand locations per instruction may be identified, including up to two source operand identifiers 385 and 390 and one destination operand identifier 386. One embodiment of the coprocessor may operate on eight, sixteen, thirty-two, and 64-bit values. In one embodiment, an instruction may be performed on integer data elements. In some embodiments, an instruction may be executed conditionally, using condition field 381. For some embodiments, source data sizes may be encoded by field 383. In some embodiments, Zero (Z), negative (N), carry (C), and overflow (V) detection may be done on SIMD fields. For some instructions, the type of saturation may be encoded by field 384.

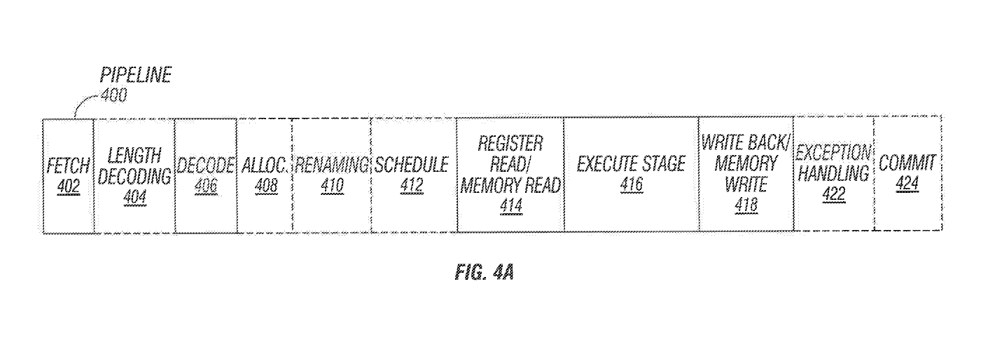

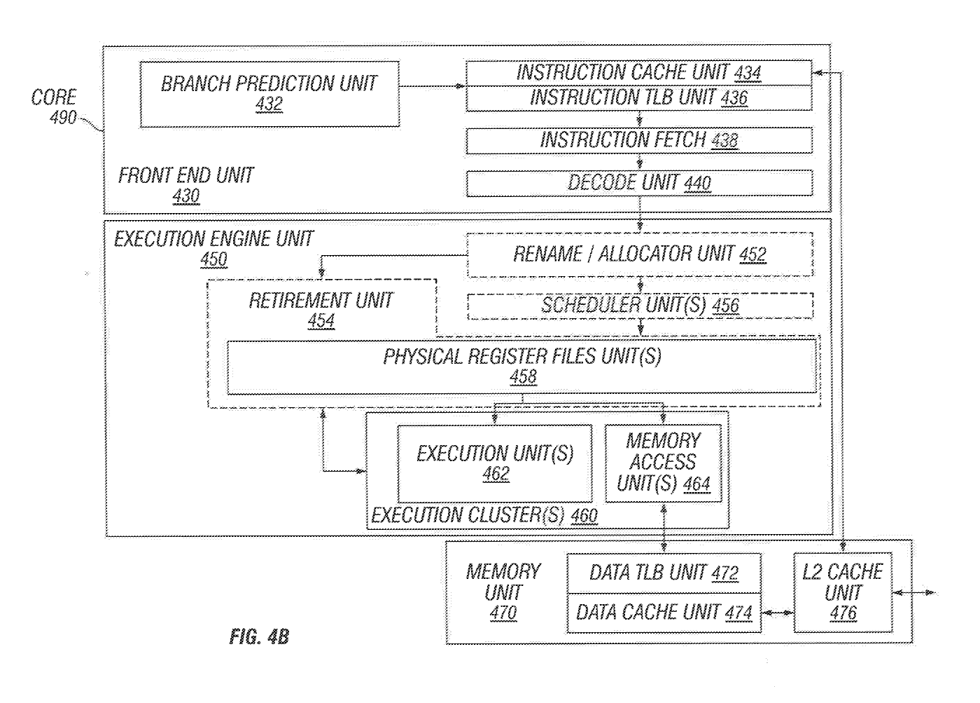

FIG. 4A is a block diagram illustrating an in-order pipeline and a register renaming stage, out-of-order issue/execution pipeline, in accordance with embodiments of the present disclosure. FIG. 4B is a block diagram illustrating an in-order architecture core and a register renaming logic, out-of-order issue/execution logic to be included in a processor, in accordance with embodiments of the present disclosure. The solid lined boxes in FIG. 4A illustrate the in-order pipeline, while the dashed lined boxes illustrates the register renaming, out-of-order issue/execution pipeline. Similarly, the solid lined boxes in FIG. 4B illustrate the in-order architecture logic, while the dashed lined boxes illustrates the register renaming logic and out-of-order issue/execution logic.

In FIG. 4A, a processor pipeline 400 may include a fetch stage 402, a length decode stage 404, a decode stage 406, an allocation stage 408, a renaming stage 410, a scheduling (also known as a dispatch or issue) stage 412, a register read/memory read stage 414, an execute stage 416, a write-back/memory-write stage 418, an exception handling stage 422, and a commit stage 424.

In FIG. 4B, arrows denote a coupling between two or more units and the direction of the arrow indicates a direction of data flow between those units. FIG. 4B shows processor core 490 including a front end unit 430 coupled to an execution engine unit 450, and both may be coupled to a memory unit 470.

Core 490 may be a reduced instruction set computing (RISC) core, a complex instruction set computing (CISC) core, a very long instruction word (VLIW) core, or a hybrid or alternative core type. In one embodiment, core 490 may be a special-purpose core, such as, for example, a network or communication core, compression engine, graphics core, or the like.

Front end unit 430 may include a branch prediction unit 432 coupled to an instruction cache unit 434. Instruction cache unit 434 may be coupled to an instruction translation lookaside buffer (TLB) 436. TLB 436 may be coupled to an instruction fetch unit 438, which is coupled to a decode unit 440. Decode unit 440 may decode instructions, and generate as an output one or more micro-operations, micro-code entry points, microinstructions, other instructions, or other control signals, which may be decoded from, or which otherwise reflect, or may be derived from, the original instructions. The decoder may be implemented using various different mechanisms. Examples of suitable mechanisms include, but are not limited to, look-up tables, hardware implementations, programmable logic arrays (PLAs), microcode read-only memories (ROMs), etc. In one embodiment, instruction cache unit 434 may be further coupled to a level 2 (L2) cache unit 476 in memory unit 470. Decode unit 440 may be coupled to a rename/allocator unit 452 in execution engine unit 450.

Execution engine unit 450 may include rename/allocator unit 452 coupled to a retirement unit 454 and a set of one or more scheduler units 456. Scheduler units 456 represent any number of different schedulers, including reservations stations, central instruction window, etc. Scheduler units 456 may be coupled to physical register file units 458. Each of physical register file units 458 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. Physical register file units 458 may be overlapped by retirement unit 454 to illustrate various ways in which register renaming and out-of-order execution may be implemented (e.g., using one or more reorder buffers and one or more retirement register files, using one or more future files, one or more history buffers, and one or more retirement register files; using register maps and a pool of registers; etc.). Generally, the architectural registers may be visible from the outside of the processor or from a programmer's perspective. The registers might not be limited to any known particular type of circuit. Various different types of registers may be suitable as long as they store and provide data as described herein. Examples of suitable registers include, but might not be limited to, dedicated physical registers, dynamically allocated physical registers using register renaming, combinations of dedicated and dynamically allocated physical registers, etc. Retirement unit 454 and physical register file units 458 may be coupled to execution clusters 460. Execution clusters 460 may include a set of one or more execution units 462 and a set of one or more memory access units 464. Execution units 462 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. Scheduler units 456, physical register file units 458, and execution clusters 460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file unit, and/or execution cluster—and in the case of a separate memory access pipeline, certain embodiments may be implemented in which only the execution cluster of this pipeline has memory access units 464). It should also be understood that where separate pipelines are used, one or more of these pipelines may be out-of-order issue/execution and the rest in-order.

The set of memory access units 464 may be coupled to memory unit 470, which may include a data TLB unit 472 coupled to a data cache unit 474 coupled to a level 2 (L2) cache unit 476. In one exemplary embodiment, memory access units 464 may include a load unit, a store address unit, and a store data unit, each of which may be coupled to data TLB unit 472 in memory unit 470. L2 cache unit 476 may be coupled to one or more other levels of cache and eventually to a main memory.

By way of example, the exemplary register renaming, out-of-order issue/execution core architecture may implement pipeline 400 as follows: 1) instruction fetch 438 may perform fetch and length decoding stages 402 and 404; 2) decode unit 440 may perform decode stage 406; 3) rename/allocator unit 452 may perform allocation stage 408 and renaming stage 410; 4) scheduler units 456 may perform schedule stage 412; 5) physical register file units 458 and memory unit 470 may perform register read/memory read stage 414; execution cluster 460 may perform execute stage 416; 6) memory unit 470 and physical register file units 458 may perform write-back/memory-write stage 418; 7) various units may be involved in the performance of exception handling stage 422; and 8) retirement unit 454 and physical register file units 458 may perform commit stage 424.

Core 490 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.).

It should be understood that the core may support multithreading (executing two or more parallel sets of operations or threads) in a variety of manners. Multithreading support may be performed by, for example, including time sliced multithreading, simultaneous multithreading (where a single physical core provides a logical core for each of the threads that physical core is simultaneously multithreading), or a combination thereof. Such a combination may include, for example, time sliced fetching and decoding and simultaneous multithreading thereafter such as in the Intel® Hyperthreading technology.

While register renaming may be described in the context of out-of-order execution, it should be understood that register renaming may be used in an in-order architecture. While the illustrated embodiment of the processor may also include a separate instruction and data cache units 434/474 and a shared L2 cache unit 476, other embodiments may have a single internal cache for both instructions and data, such as, for example, a Level 1 (L1) internal cache, or multiple levels of internal cache. In some embodiments, the system may include a combination of an internal cache and an external cache that may be external to the core and/or the processor. In other embodiments, all of the caches may be external to the core and/or the processor.

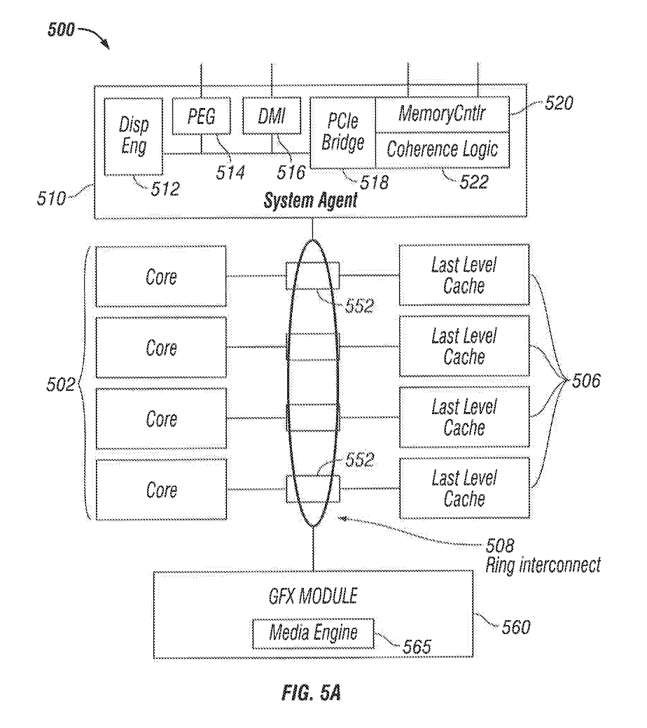

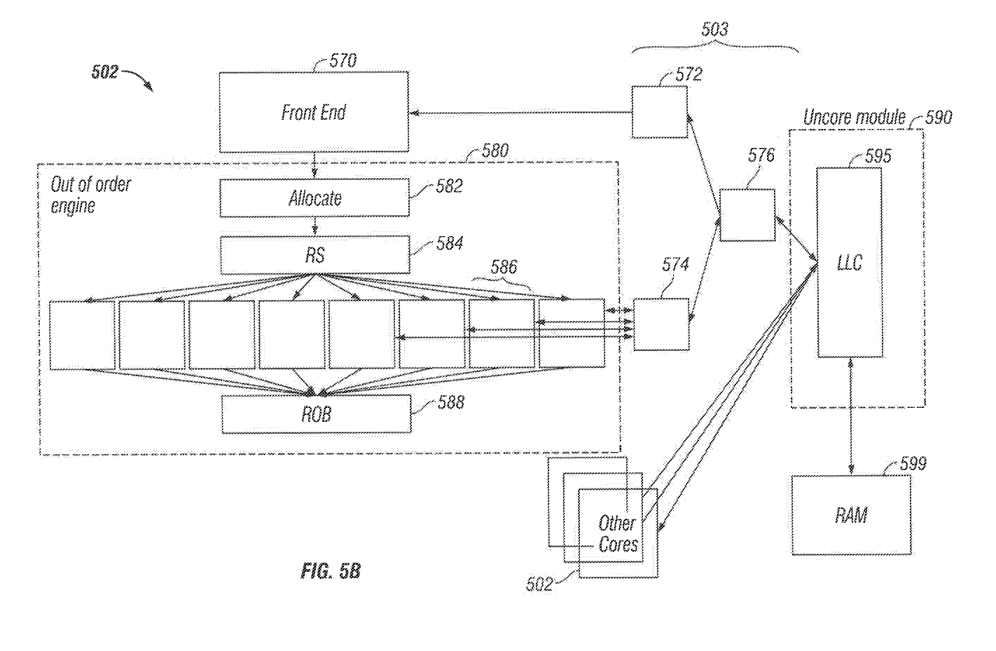

FIG. 5A is a block diagram of a processor 500, in accordance with embodiments of the present disclosure. In one embodiment, processor 500 may include a multicore processor. Processor 500 may include a system agent 510 communicatively coupled to one or more cores 502. Furthermore, cores 502 and system agent 510 may be communicatively coupled to one or more caches 506. Cores 502, system agent 510, and caches 506 may be communicatively coupled via one or more memory control units 552. Furthermore, cores 502, system agent 510, and caches 506 may be communicatively coupled to a graphics module 560 via memory control units 552.

Processor 500 may include any suitable mechanism for interconnecting cores 502, system agent 510, and caches 506, and graphics module 560. In one embodiment, processor 500 may include a ring-based interconnect unit 508 to interconnect cores 502, system agent 510, and caches 506, and graphics module 560. In other embodiments, processor 500 may include any number of well-known techniques for interconnecting such units. Ring-based interconnect unit 508 may utilize memory control units 552 to facilitate interconnections.

Processor 500 may include a memory hierarchy comprising one or more levels of caches within the cores, one or more shared cache units such as caches 506, or external memory (not shown) coupled to the set of integrated memory controller units 552. Caches 506 may include any suitable cache. In one embodiment, caches 506 may include one or more mid-level caches, such as level 2 (L2), level 3 (L3), level 4 (L4), or other levels of cache, a last level cache (LLC), and/or combinations thereof.

In various embodiments, one or more of cores 502 may perform multi-threading. System agent 510 may include components for coordinating and operating cores 502. System agent unit 510 may include for example a power control unit (PCU). The PCU may be or include logic and components needed for regulating the power state of cores 502. System agent 510 may include a display engine 512 for driving one or more externally connected displays or graphics module 560. System agent 510 may include an interface 514 for communications busses for graphics. In one embodiment, interface 514 may be implemented by PCI Express (PCIe). In a further embodiment, interface 514 may be implemented by PCI Express Graphics (PEG). System agent 510 may include a direct media interface (DMI) 516. DMI 516 may provide links between different bridges on a motherboard or other portion of a computer system. System agent 510 may include a PCIe bridge 518 for providing PCIe links to other elements of a computing system. PCIe bridge 518 may be implemented using a memory controller 520 and coherence logic 522.

Cores 502 may be implemented in any suitable manner. Cores 502 may be homogenous or heterogeneous in terms of architecture and/or instruction set. In one embodiment, some of cores 502 may be in-order while others may be out-of-order. In another embodiment, two or more of cores 502 may execute the same instruction set, while others may execute only a subset of that instruction set or a different instruction set.

Processor 500 may include a general-purpose processor, such as a Core™ i3, i5, i7, 2 Duo and Quad, Xeon™, Itanium™, XScale™ or StrongARM™ processor, which may be available from Intel Corporation, of Santa Clara, Calif. Processor 500 may be provided from another company, such as ARM Holdings, Ltd, MIPS, etc. Processor 500 may be a special-purpose processor, such as, for example, a network or communication processor, compression engine, graphics processor, co-processor, embedded processor, or the like. Processor 500 may be implemented on one or more chips. Processor 500 may be a part of and/or may be implemented on one or more substrates using any of a number of process technologies, such as, for example, BiCMOS, CMOS, or NMOS.

In one embodiment, a given one of caches 506 may be shared by multiple ones of cores 502. In another embodiment, a given one of caches 506 may be dedicated to one of cores 502. The assignment of caches 506 to cores 502 may be handled by a cache controller or other suitable mechanism. A given one of caches 506 may be shared by two or more cores 502 by implementing time-slices of a given cache 506.

Graphics module 560 may implement an integrated graphics processing subsystem. In one embodiment, graphics module 560 may include a graphics processor. Furthermore, graphics module 560 may include a media engine 565. Media engine 565 may provide media encoding and video decoding.

FIG. 5B is a block diagram of an example implementation of a core 502, in accordance with embodiments of the present disclosure. Core 502 may include a front end 570 communicatively coupled to an out-of-order engine 580. Core 502 may be communicatively coupled to other portions of processor 500 through cache hierarchy 503.

Front end 570 may be implemented in any suitable manner, such as fully or in part by front end 201 as described above. In one embodiment, front end 570 may communicate with other portions of processor 500 through cache hierarchy 503. In a further embodiment, front end 570 may fetch instructions from portions of processor 500 and prepare the instructions to be used later in the processor pipeline as they are passed to out-of-order execution engine 580.

Out-of-order execution engine 580 may be implemented in any suitable manner, such as fully or in part by out-of-order execution engine 203 as described above. Out-of-order execution engine 580 may prepare instructions received from front end 570 for execution. Out-of-order execution engine 580 may include an allocate module 582. In one embodiment, allocate module 582 may allocate resources of processor 500 or other resources, such as registers or buffers, to execute a given instruction. Allocate module 582 may make allocations in schedulers, such as a memory scheduler, fast scheduler, or floating point scheduler. Such schedulers may be represented in FIG. 5B by resource schedulers 584. Allocate module 582 may be implemented fully or in part by the allocation logic described in conjunction with FIG. 2. Resource schedulers 584 may determine when an instruction is ready to execute based on the readiness of a given resource's sources and the availability of execution resources needed to execute an instruction. Resource schedulers 584 may be implemented by, for example, schedulers 202, 204, 206 as discussed above. Resource schedulers 584 may schedule the execution of instructions upon one or more resources. In one embodiment, such resources may be internal to core 502, and may be illustrated, for example, as resources 586. In another embodiment, such resources may be external to core 502 and may be accessible by, for example, cache hierarchy 503. Resources may include, for example, memory, caches, register files, or registers. Resources internal to core 502 may be represented by resources 586 in FIG. 5B. As necessary, values written to or read from resources 586 may be coordinated with other portions of processor 500 through, for example, cache hierarchy 503. As instructions are assigned resources, they may be placed into a reorder buffer 588. Reorder buffer 588 may track instructions as they are executed and may selectively reorder their execution based upon any suitable criteria of processor 500. In one embodiment, reorder buffer 588 may identify instructions or a series of instructions that may be executed independently. Such instructions or a series of instructions may be executed in parallel from other such instructions. Parallel execution in core 502 may be performed by any suitable number of separate execution blocks or virtual processors. In one embodiment, shared resources—such as memory, registers, and caches—may be accessible to multiple virtual processors within a given core 502. In other embodiments, shared resources may be accessible to multiple processing entities within processor 500.

Cache hierarchy 503 may be implemented in any suitable manner. For example, cache hierarchy 503 may include one or more lower or mid-level caches, such as caches 572, 574. In one embodiment, cache hierarchy 503 may include an LLC 595 communicatively coupled to caches 572, 574. In another embodiment, LLC 595 may be implemented in a module 590 accessible to all processing entities of processor 500. In a further embodiment, module 590 may be implemented in an uncore module of processors from Intel, Inc. Module 590 may include portions or subsystems of processor 500 necessary for the execution of core 502 but might not be implemented within core 502. Besides LLC 595, Module 590 may include, for example, hardware interfaces, memory coherency coordinators, interprocessor interconnects, instruction pipelines, or memory controllers. Access to RAM 599 available to processor 500 may be made through module 590 and, more specifically, LLC 595. Furthermore, other instances of core 502 may similarly access module 590. Coordination of the instances of core 502 may be facilitated in part through module 590.

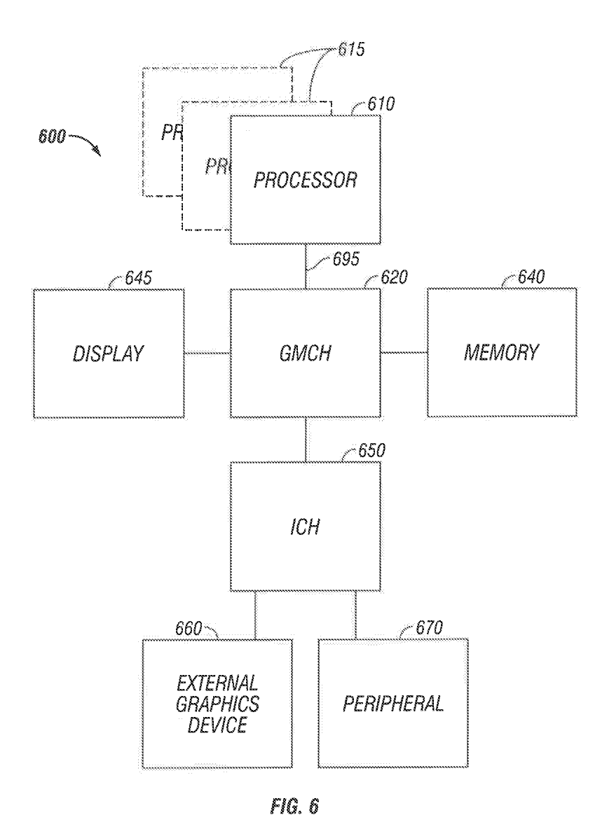

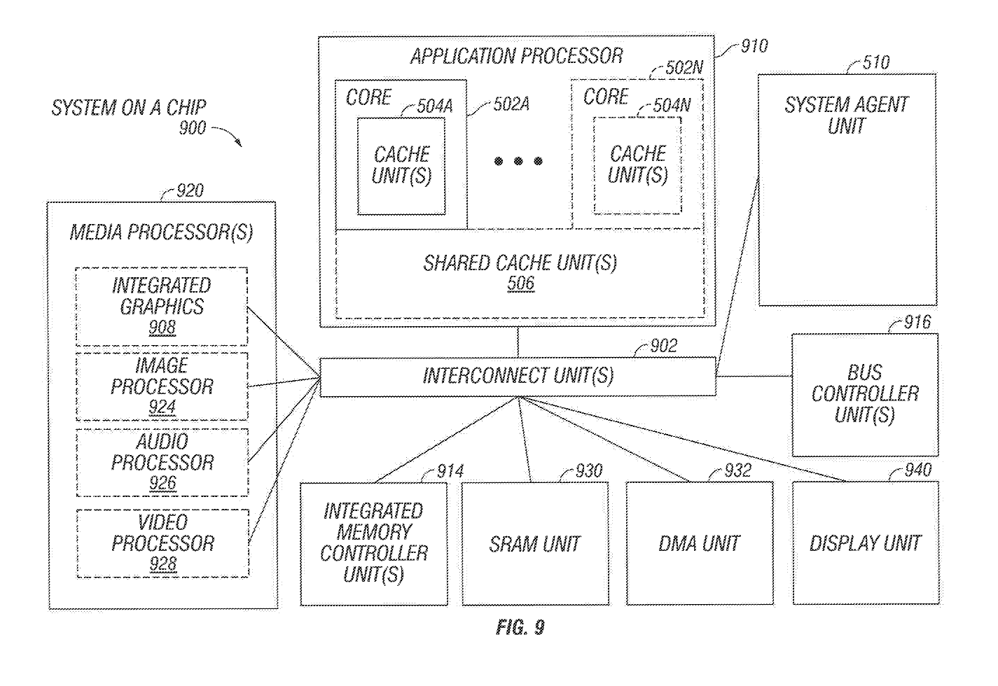

FIGS. 6-8 may illustrate exemplary systems suitable for including processor 500, while FIG. 9 may illustrate an exemplary system on a chip (SoC) that may include one or more of cores 502. Other system designs and implementations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, may also be suitable. In general, a huge variety of systems or electronic devices that incorporate a processor and/or other execution logic as disclosed herein may be generally suitable.

FIG. 6 illustrates a block diagram of a system 600, in accordance with embodiments of the present disclosure. System 600 may include one or more processors 610, 615, which may be coupled to graphics memory controller hub (GMCH) 620. The optional nature of additional processors 615 is denoted in FIG. 6 with broken lines.

Each processor 610,615 may be some version of processor 500. However, it should be noted that integrated graphics logic and integrated memory control units might not exist in processors 610,615. FIG. 6 illustrates that GMCH 620 may be coupled to a memory 640 that may be, for example, a dynamic random access memory (DRAM). The DRAM may, for at least one embodiment, be associated with a non-volatile cache.

GMCH 620 may be a chipset, or a portion of a chipset. GMCH 620 may communicate with processors 610, 615 and control interaction between processors 610, 615 and memory 640. GMCH 620 may also act as an accelerated bus interface between the processors 610, 615 and other elements of system 600. In one embodiment, GMCH 620 communicates with processors 610, 615 via a multi-drop bus, such as a frontside bus (FSB) 695.

Furthermore, GMCH 620 may be coupled to a display 645 (such as a flat panel display). In one embodiment, GMCH 620 may include an integrated graphics accelerator. GMCH 620 may be further coupled to an input/output (I/O) controller hub (ICH) 650, which may be used to couple various peripheral devices to system 600. External graphics device 660 may include a discrete graphics device coupled to ICH 650 along with another peripheral device 670.

In other embodiments, additional or different processors may also be present in system 600. For example, additional processors 610, 615 may include additional processors that may be the same as processor 610, additional processors that may be heterogeneous or asymmetric to processor 610, accelerators (such as, e.g., graphics accelerators or digital signal processing (DSP) units), field programmable gate arrays, or any other processor. There may be a variety of differences between the physical resources 610, 615 in terms of a spectrum of metrics of merit including architectural, micro-architectural, thermal, power consumption characteristics, and the like. These differences may effectively manifest themselves as asymmetry and heterogeneity amongst processors 610, 615. For at least one embodiment, various processors 610, 615 may reside in the same die package.

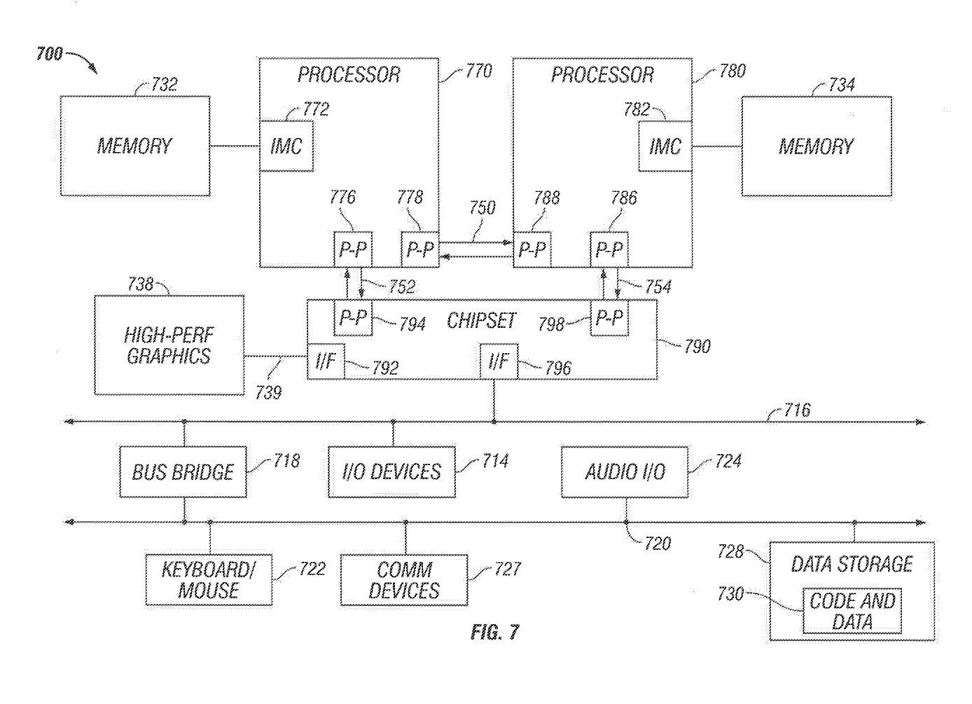

FIG. 7 illustrates a block diagram of a second system 700, in accordance with embodiments of the present disclosure. As shown in FIG. 7, multiprocessor system 700 may include a point-to-point interconnect system, and may include a first processor 770 and a second processor 780 coupled via a point-to-point interconnect 750. Each of processors 770 and 780 may be some version of processor 500 as one or more of processors 610,615.

While FIG. 7 may illustrate two processors 770, 780, it is to be understood that the scope of the present disclosure is not so limited. In other embodiments, one or more additional processors may be present in a given processor.

Processors 770 and 780 are shown including integrated memory controller units 772 and 782, respectively. Processor 770 may also include as part of its bus controller units point-to-point (P-P) interfaces 776 and 778; similarly, second processor 780 may include P-P interfaces 786 and 788. Processors 770, 780 may exchange information via a point-to-point (P-P) interface 750 using P-P interface circuits 778, 788. As shown in FIG. 7, IMCs 772 and 782 may couple the processors to respective memories, namely a memory 732 and a memory 734, which in one embodiment may be portions of main memory locally attached to the respective processors.

Processors 770, 780 may each exchange information with a chipset 790 via individual P-P interfaces 752, 754 using point to point interface circuits 776, 794, 786, 798. In one embodiment, chipset 790 may also exchange information with a high-performance graphics circuit 738 via a high-performance graphics interface 739.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present disclosure is not so limited.

As shown in FIG. 7, various I/O devices 714 may be coupled to first bus 716, along with a bus bridge 718 which couples first bus 716 to a second bus 720. In one embodiment, second bus 720 may be a low pin count (LPC) bus. Various devices may be coupled to second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to second bus 720. Note that other architectures may be possible. For example, instead of the point-to-point architecture of FIG. 7, a system may implement a multi-drop bus or other such architecture.

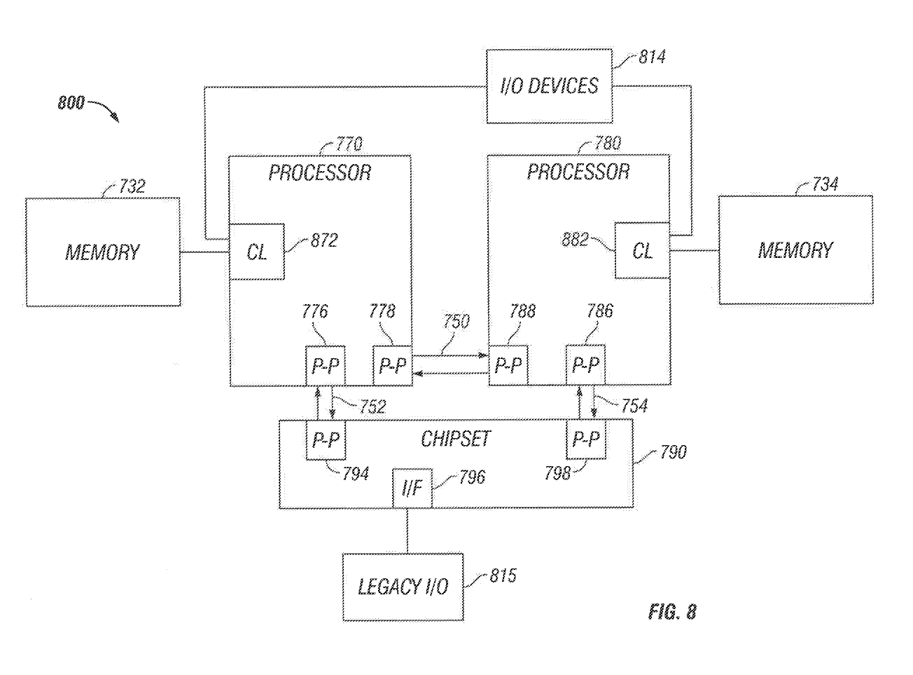

FIG. 8 illustrates a block diagram of a third system 800 in accordance with embodiments of the present disclosure. Like elements in FIGS. 7 and 8 bear like reference numerals, and certain aspects of FIG. 7 have been omitted from FIG. 8 in order to avoid obscuring other aspects of FIG. 8.

FIG. 8 illustrates that processors 770, 780 may include integrated memory and I/O control logic (“CL”) 872 and 882, respectively. For at least one embodiment, CL 872, 882 may include integrated memory controller units such as that described above in connection with FIGS. 5 and 7. In addition. CL 872, 882 may also include I/O control logic. FIG. 8 illustrates that not only memories 732, 734 may be coupled to CL 872, 882, but also that I/O devices 814 may also be coupled to control logic 872, 882. Legacy I/O devices 815 may be coupled to chipset 790.

FIG. 9 illustrates a block diagram of a SoC 900, in accordance with embodiments of the present disclosure. Similar elements in FIG. 5 bear like reference numerals. Also, dashed lined boxes may represent optional features on more advanced SoCs. An interconnect units 902 may be coupled to: an application processor 910 which may include a set of one or more cores 502A-N and shared cache units 506; a system agent unit 510; a bus controller units 916; an integrated memory controller units 914; a set of one or more media processors 920 which may include integrated graphics logic 908, an image processor 924 for providing still and/or video camera functionality, an audio processor 926 for providing hardware audio acceleration, and a video processor 928 for providing video encode/decode acceleration; an static random access memory (SRAM) unit 930; a direct memory access (DMA) unit 932; and a display unit 940 for coupling to one or more external displays.

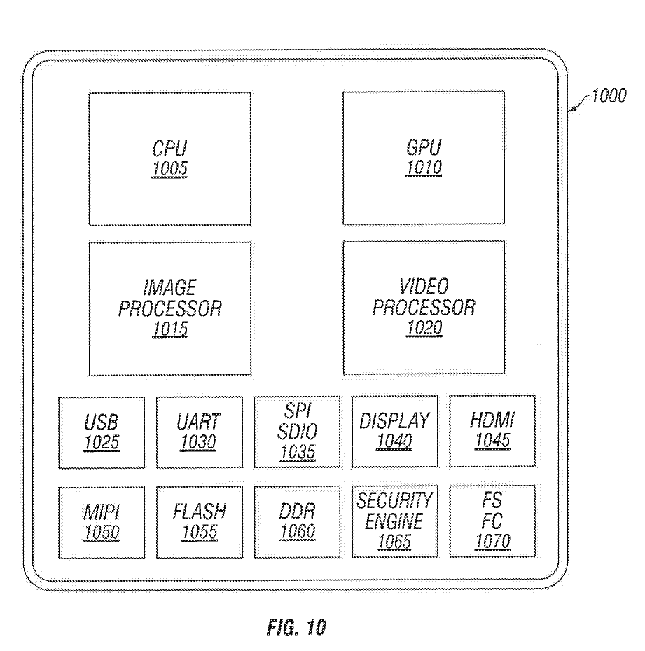

FIG. 10 illustrates a processor containing a central processing unit (CPU) and a graphics processing unit (GPU), which may perform at least one instruction, in accordance with embodiments of the present disclosure. In one embodiment, an instruction to perform operations according to at least one embodiment could be performed by the CPU. In another embodiment, the instruction could be performed by the GPU. In still another embodiment, the instruction may be performed through a combination of operations performed by the GPU and the CPU. For example, in one embodiment, an instruction in accordance with one embodiment may be received and decoded for execution on the GPU. However, one or more operations within the decoded instruction may be performed by a CPU and the result returned to the GPU for final retirement of the instruction. Conversely, in some embodiments, the CPU may act as the primary processor and the GPU as the co-processor.

In some embodiments, instructions that benefit from highly parallel, throughput processors may be performed by the GPU, while instructions that benefit from the performance of processors that benefit from deeply pipelined architectures may be performed by the CPU. For example, graphics, scientific applications, financial applications and other parallel workloads may benefit from the performance of the GPU and be executed accordingly, whereas more sequential applications, such as operating system kernel or application code may be better suited for the CPU.

In FIG. 10, processor 1000 includes a CPU 1005, GPU 1010, image processor 1015, video processor 1020, USB controller 1025, UART controller 1030, SPI/SDIO controller 1035, display device 1040, memory interface controller 1045, MIPI controller 1050, flash memory controller 1055, dual data rate (DDR) controller 1060, security engine 1065, and I²S/I²C controller 1070. Other logic and circuits may be included in the processor of FIG. 10, including more CPUs or GPUs and other peripheral interface controllers.

One or more aspects of at least one embodiment may be implemented by representative data stored on a machine-readable medium which represents various logic within the processor, which when read by a machine causes the machine to fabricate logic to perform the techniques described herein. Such representations, known as “IP cores” may be stored on a tangible, machine-readable medium (“tape”) and supplied to various customers or manufacturing facilities to load into the fabrication machines that actually make the logic or processor. For example, IP cores, such as the Cortex™ family of processors developed by ARM Holdings, Ltd. and Loongson IP cores developed the Institute of Computing Technology (ICT) of the Chinese Academy of Sciences may be licensed or sold to various customers or licensees, such as Texas Instruments, Qualcomm, Apple, or Samsung and implemented in processors produced by these customers or licensees.

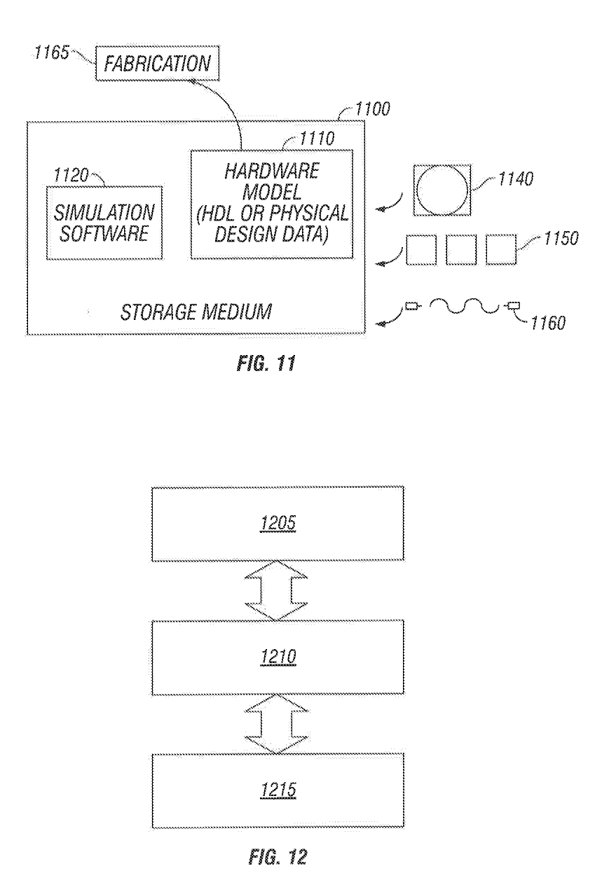

FIG. 11 illustrates a block diagram illustrating the development of IP cores, in accordance with embodiments of the present disclosure. Storage 1100 may include simulation software 1120 and/or hardware or software model 1110. In one embodiment, the data representing the IP core design may be provided to storage 1100 via memory 1140 (e.g., hard disk), wired connection (e.g., internet) 1150 or wireless connection 1160. The IP core information generated by the simulation tool and model may then be transmitted to a fabrication facility 1165 where it may be fabricated by a 3^{rd} party to perform at least one instruction in accordance with at least one embodiment.

In some embodiments, one or more instructions may correspond to a first type or architecture (e.g., x86) and be translated or emulated on a processor of a different type or architecture (e.g., ARM). An instruction, according to one embodiment, may therefore be performed on any processor or processor type, including ARM, x86, MIPS, a GPU, or other processor type or architecture.

FIG. 12 illustrates how an instruction of a first type may be emulated by a processor of a different type, in accordance with embodiments of the present disclosure. In FIG. 12, program 1205 contains some instructions that may perform the same or substantially the same function as an instruction according to one embodiment. However the instructions of program 1205 may be of a type and/or format that is different from or incompatible with processor 1215, meaning the instructions of the type in program 1205 may not be able to execute natively by the processor 1215. However, with the help of emulation logic, 1210, the instructions of program 1205 may be translated into instructions that may be natively be executed by the processor 1215. In one embodiment, the emulation logic may be embodied in hardware. In another embodiment, the emulation logic may be embodied in a tangible, machine-readable medium containing software to translate instructions of the type in program 1205 into the type natively executable by processor 1215. In other embodiments, emulation logic may be a combination of fixed-function or programmable hardware and a program stored on a tangible, machine-readable medium. In one embodiment, the processor contains the emulation logic, whereas in other embodiments, the emulation logic exists outside of the processor and may be provided by a third party. In one embodiment, the processor may load the emulation logic embodied in a tangible, machine-readable medium containing software by executing microcode or firmware contained in or associated with the processor.

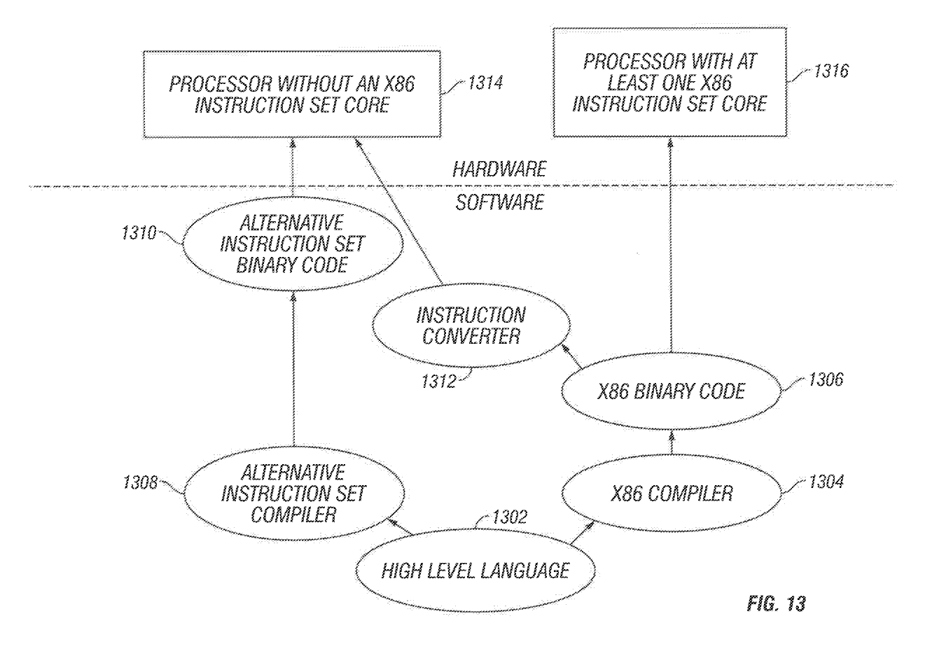

FIG. 13 illustrates a block diagram contrasting the use of a software instruction converter to convert binary instructions in a source instruction set to binary instructions in a target instruction set, in accordance with embodiments of the present disclosure. In the illustrated embodiment, the instruction converter may be a software instruction converter, although the instruction converter may be implemented in software, firmware, hardware, or various combinations thereof. FIG. 13 shows a program in a high level language 1302 may be compiled using an x86 compiler 1304 to generate x86 binary code 1306 that may be natively executed by a processor with at least one x86 instruction set core 1316. The processor with at least one x86 instruction set core 1316 represents any processor that may perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. x86 compiler 1304 represents a compiler that may be operable to generate x86 binary code 1306 (e.g., object code) that may, with or without additional linkage processing, be executed on the processor with at least one x86 instruction set core 1316. Similarly, FIG. 13 shows the program in high level language 1302 may be compiled using an alternative instruction set compiler 1308 to generate alternative instruction set binary code 1310 that may be natively executed by a processor without at least one x86 instruction set core 1314 (e.g., a processor with cores that execute the MIPS instruction set of MIPS Technologies of Sunnyvale, Calif. and/or that execute the ARM instruction set of ARM Holdings of Sunnyvale, Calif.). Instruction converter 1312 may be used to convert x86 binary code 1306 into code that may be natively executed by the processor without an x86 instruction set core 1314. This converted code might not be the same as alternative instruction set binary code 1310; however, the converted code will accomplish the general operation and be made up of instructions from the alternative instruction set. Thus, instruction converter 1312 represents software, firmware, hardware, or a combination thereof that, through emulation, simulation or any other process, allows a processor or other electronic device that does not have an x86 instruction set processor or core to execute x86 binary code 1306.

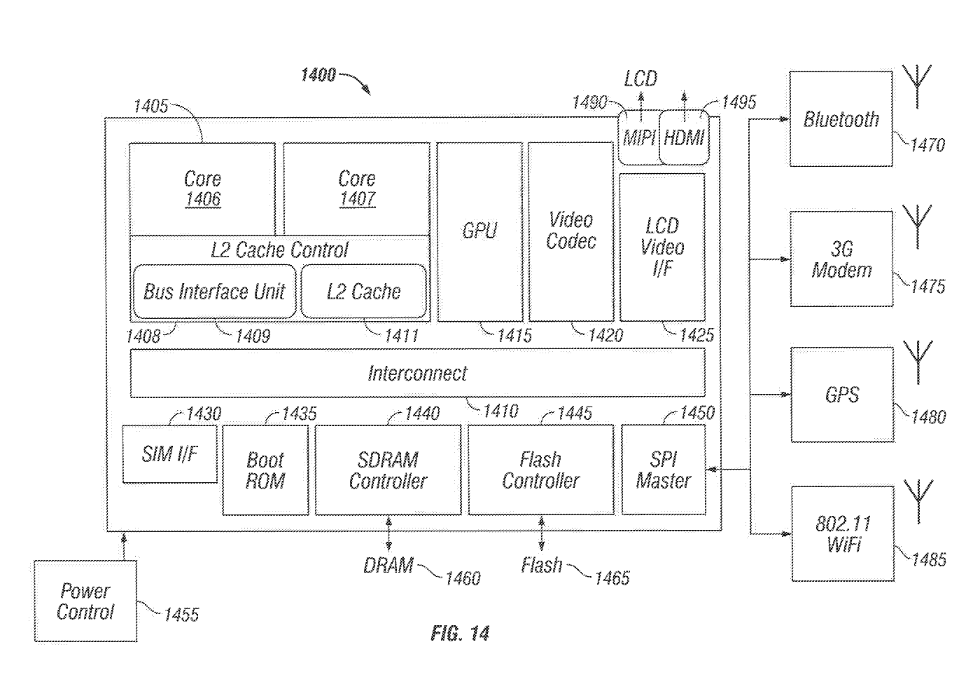

FIG. 14 is a block diagram of an instruction set architecture 1400 of a processor, in accordance with embodiments of the present disclosure. Instruction set architecture 1400 may include any suitable number or kind of components.

For example, instruction set architecture 1400 may include processing entities such as one or more cores 1406, 1407 and a graphics processing unit 1415. Cores 1406, 1407 may be communicatively coupled to the rest of instruction set architecture 1400 through any suitable mechanism, such as through a bus or cache. In one embodiment, cores 1406, 1407 may be communicatively coupled through an L2 cache control 1408, which may include a bus interface unit 1409 and an L2 cache 1411. Cores 1406, 1407 and graphics processing unit 1415 may be communicatively coupled to each other and to the remainder of instruction set architecture 1400 through interconnect 1410. In one embodiment, graphics processing unit 1415 may use a video code 1420 defining the manner in which particular video signals will be encoded and decoded for output.

Instruction set architecture 1400 may also include any number or kind of interfaces, controllers, or other mechanisms for interfacing or communicating with other portions of an electronic device or system. Such mechanisms may facilitate interaction with, for example, peripherals, communications devices, other processors, or memory. In the example of FIG. 14, instruction set architecture 1400 may include a liquid crystal display (LCD) video interface 1425, a subscriber interface module (SIM) interface 1430, a boot ROM interface 1435, a synchronous dynamic random access memory (SDRAM) controller 1440, a flash controller 1445, and a serial peripheral interface (SPI) master unit 1450. LCD video interface 1425 may provide output of video signals from, for example, GPU 1415 and through, for example, a mobile industry processor interface (MIPI) 1490 or a high-definition multimedia interface (HDMI) 1495 to a display. Such a display may include, for example, an LCD. SIM interface 1430 may provide access to or from a SIM card or device. SDRAM controller 1440 may provide access to or from memory such as an SDRAM chip or module 1460. Flash controller 1445 may provide access to or from memory such as flash memory 1465 or other instances of RAM. SPI master unit 1450 may provide access to or from communications modules, such as a Bluetooth module 1470, high-speed 3G modem 1475, global positioning system module 1480, or wireless module 1485 implementing a communications standard such as 802.11.

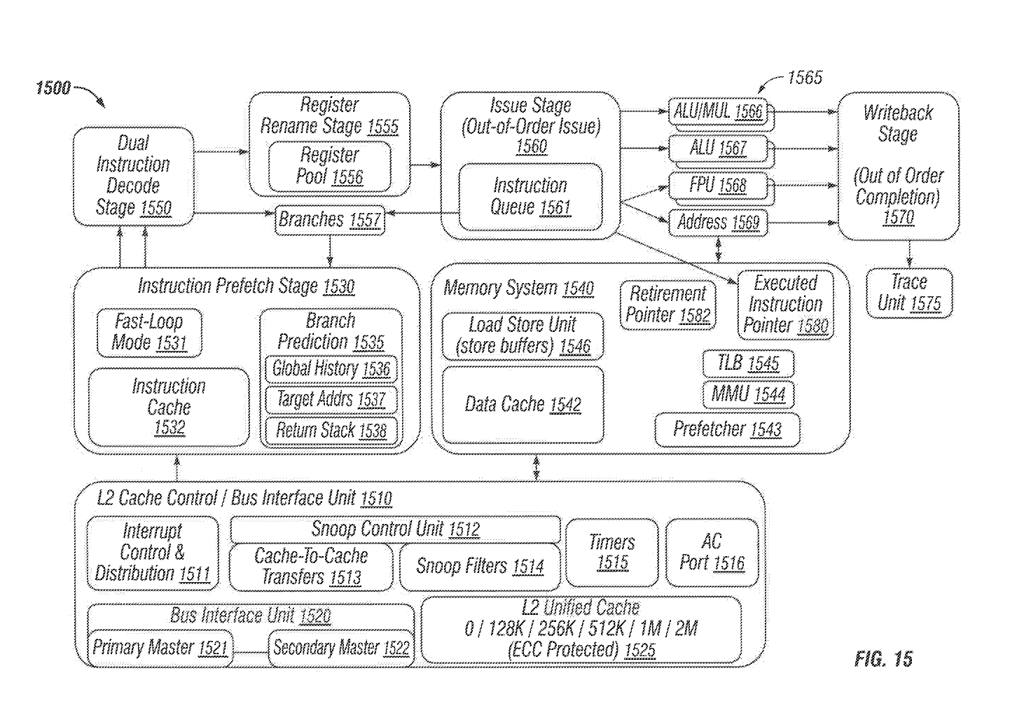

FIG. 15 is a more detailed block diagram of an instruction set architecture 1500 of a processor, in accordance with embodiments of the present disclosure. Instruction architecture 1500 may implement one or more aspects of instruction set architecture 1400. Furthermore, instruction set architecture 1500 may illustrate modules and mechanisms for the execution of instructions within a processor.

Instruction architecture 1500 may include a memory system 1540 communicatively coupled to one or more execution entities 1565. Furthermore, instruction architecture 1500 may include a caching and bus interface unit such as unit 1510 communicatively coupled to execution entities 1565 and memory system 1540. In one embodiment, loading of instructions into execution entities 1565 may be performed by one or more stages of execution. Such stages may include, for example, instruction prefetch stage 1530, dual instruction decode stage 1550, register rename stage 1555, issue stage 1560, and writeback stage 1570.

In one embodiment, memory system 1540 may include an executed instruction pointer 1580. Executed instruction pointer 1580 may store a value identifying the oldest, undispatched instruction within a batch of instructions. The oldest instruction may correspond to the lowest Program Order (PO) value. A PO may include a unique number of an instruction. Such an instruction may be a single instruction within a thread represented by multiple strands. A PO may be used in ordering instructions to ensure correct execution semantics of code. A PO may be reconstructed by mechanisms such as evaluating increments to PO encoded in the instruction rather than an absolute value. Such a reconstructed PO may be known as an “RPO.” Although a PO may be referenced herein, such a PO may be used interchangeably with an RPO. A strand may include a sequence of instructions that are data dependent upon each other. The strand may be arranged by a binary translator at compilation time. Hardware executing a strand may execute the instructions of a given strand in order according to the PO of the various instructions. A thread may include multiple strands such that instructions of different strands may depend upon each other. A PO of a given strand may be the PO of the oldest instruction in the strand which has not yet been dispatched to execution from an issue stage. Accordingly, given a thread of multiple strands, each strand including instructions ordered by PO, executed instruction pointer 1580 may store the oldest—illustrated by the lowest number—PO in the thread.

In another embodiment, memory system 1540 may include a retirement pointer 1582. Retirement pointer 1582 may store a value identifying the PO of the last retired instruction. Retirement pointer 1582 may be set by, for example, retirement unit 454. If no instructions have yet been retired, retirement pointer 1582 may include a null value.

Execution entities 1565 may include any suitable number and kind of mechanisms by which a processor may execute instructions. In the example of FIG. 15, execution entities 1565 may include ALU/multiplication units (MUL) 1566, ALUs 1567, and floating point units (FPU) 1568. In one embodiment, such entities may make use of information contained within a given address 1569. Execution entities 1565 in combination with stages 1530, 1550, 1555, 1560, 1570 may collectively form an execution unit.

Unit 1510 may be implemented in any suitable manner. In one embodiment, unit 1510 may perform cache control. In such an embodiment, unit 1510 may thus include a cache 1525. Cache 1525 may be implemented, in a further embodiment, as an L2 unified cache with any suitable size, such as zero, 128k, 256k, 512k, 1M, or 2M bytes of memory. In another, further embodiment, cache 1525 may be implemented in error-correcting code memory. In another embodiment, unit 1510 may perform bus interfacing to other portions of a processor or electronic device. In such an embodiment, unit 1510 may thus include a bus interface unit 1520 for communicating over an interconnect, intraprocessor bus, interprocessor bus, or other communication bus, port, or line. Bus interface unit 1520 may provide interfacing in order to perform, for example, generation of the memory and input/output addresses for the transfer of data between execution entities 1565 and the portions of a system external to instruction architecture 1500.

To further facilitate its functions, bus interface unit 1520 may include an interrupt control and distribution unit 1511 for generating interrupts and other communications to other portions of a processor or electronic device. In one embodiment, bus interface unit 1520 may include a snoop control unit 1512 that handles cache access and coherency for multiple processing cores. In a further embodiment, to provide such functionality, snoop control unit 1512 may include a cache-to-cache transfer unit that handles information exchanges between different caches. In another, further embodiment, snoop control unit 1512 may include one or more snoop filters 1514 that monitors the coherency of other caches (not shown) so that a cache controller, such as unit 1510, does not have to perform such monitoring directly. Unit 1510 may include any suitable number of timers 1515 for synchronizing the actions of instruction architecture 1500. Also, unit 1510 may include an AC port 1516.

Memory system 1540 may include any suitable number and kind of mechanisms for storing information for the processing needs of instruction architecture 1500. In one embodiment, memory system 1540 may include a load store unit 1546 for storing information such as buffers written to or read back from memory or registers. In another embodiment, memory system 1540 may include a translation lookaside buffer (TLB) 1545 that provides look-up of address values between physical and virtual addresses. In yet another embodiment, memory system 1540 may include a memory management unit (MMU) 1544 for facilitating access to virtual memory. In still yet another embodiment, memory system 1540 may include a prefetcher 1543 for requesting instructions from memory before such instructions are actually needed to be executed, in order to reduce latency.

The operation of instruction architecture 1500 to execute an instruction may be performed through different stages. For example, using unit 1510 instruction prefetch stage 1530 may access an instruction through prefetcher 1543. Instructions retrieved may be stored in instruction cache 1532. Prefetch stage 1530 may enable an option 1531 for fast-loop mode, wherein a series of instructions forming a loop that is small enough to fit within a given cache are executed. In one embodiment, such an execution may be performed without needing to access additional instructions from, for example, instruction cache 1532. Determination of what instructions to prefetch may be made by, for example, branch prediction unit 1535, which may access indications of execution in global history 1536, indications of target addresses 1537, or contents of a return stack 1538 to determine which of branches 1557 of code will be executed next. Such branches may be possibly prefetched as a result. Branches 1557 may be produced through other stages of operation as described below. Instruction prefetch stage 1530 may provide instructions as well as any predictions about future instructions to dual instruction decode stage 1550.

Dual instruction decode stage 1550 may translate a received instruction into microcode-based instructions that may be executed. Dual instruction decode stage 1550 may simultaneously decode two instructions per clock cycle. Furthermore, dual instruction decode stage 1550 may pass its results to register rename stage 1555. In addition, dual instruction decode stage 1550 may determine any resulting branches from its decoding and eventual execution of the microcode. Such results may be input into branches 1557.

Register rename stage 1555 may translate references to virtual registers or other resources into references to physical registers or resources. Register rename stage 1555 may include indications of such mapping in a register pool 1556. Register rename stage 1555 may alter the instructions as received and send the result to issue stage 1560.

Issue stage 1560 may issue or dispatch commands to execution entities 1565. Such issuance may be performed in an out-of-order fashion. In one embodiment, multiple instructions may be held at issue stage 1560 before being executed. Issue stage 1560 may include an instruction queue 1561 for holding such multiple commands. Instructions may be issued by issue stage 1560 to a particular processing entity 1565 based upon any acceptable criteria, such as availability or suitability of resources for execution of a given instruction. In one embodiment, issue stage 1560 may reorder the instructions within instruction queue 1561 such that the first instructions received might not be the first instructions executed. Based upon the ordering of instruction queue 1561, additional branching information may be provided to branches 1557. Issue stage 1560 may pass instructions to executing entities 1565 for execution.

Upon execution, writeback stage 1570 may write data into registers, queues, or other structures of instruction set architecture 1500 to communicate the completion of a given command. Depending upon the order of instructions arranged in issue stage 1560, the operation of writeback stage 1570 may enable additional instructions to be executed. Performance of instruction set architecture 1500 may be monitored or debugged by trace unit 1575.

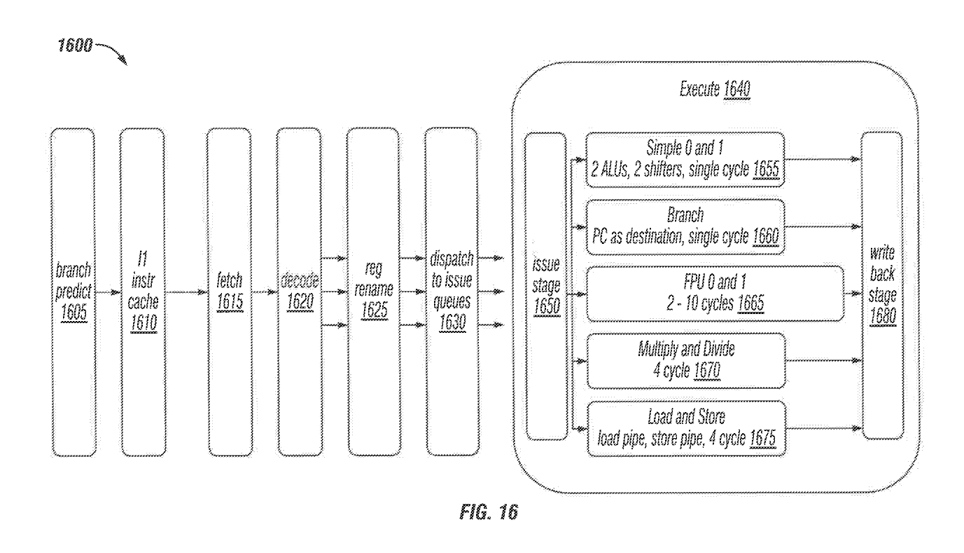

FIG. 16 is a block diagram of an execution pipeline 1600 for an instruction set architecture of a processor, in accordance with embodiments of the present disclosure. Execution pipeline 1600 may illustrate operation of, for example, instruction architecture 1500 of FIG. 15.

Execution pipeline 1600 may include any suitable combination of steps or operations. In 1605, predictions of the branch that is to be executed next may be made. In one embodiment, such predictions may be based upon previous executions of instructions and the results thereof. In 1610, instructions corresponding to the predicted branch of execution may be loaded into an instruction cache. In 1615, one or more such instructions in the instruction cache may be fetched for execution. In 1620, the instructions that have been fetched may be decoded into microcode or more specific machine language. In one embodiment, multiple instructions may be simultaneously decoded. In 1625, references to registers or other resources within the decoded instructions may be reassigned. For example, references to virtual registers may be replaced with references to corresponding physical registers. In 1630, the instructions may be dispatched to queues for execution. In 1640, the instructions may be executed. Such execution may be performed in any suitable manner. In 1650, the instructions may be issued to a suitable execution entity. The manner in which the instruction is executed may depend upon the specific entity executing the instruction. For example, at 1655, an ALU may perform arithmetic functions. The ALU may utilize a single clock cycle for its operation, as well as two shifters. In one embodiment, two ALUs may be employed, and thus two instructions may be executed at 1655. At 1660, a determination of a resulting branch may be made. A program counter may be used to designate the destination to which the branch will be made. 1660 may be executed within a single clock cycle. At 1665, floating point arithmetic may be performed by one or more FPUs. The floating point operation may require multiple clock cycles to execute, such as two to ten cycles. At 1670, multiplication and division operations may be performed. Such operations may be performed in four clock cycles. At 1675, loading and storing operations to registers or other portions of pipeline 1600 may be performed. The operations may include loading and storing addresses. Such operations may be performed in four clock cycles. At 1680, write-back operations may be performed as required by the resulting operations of 1655-1675.

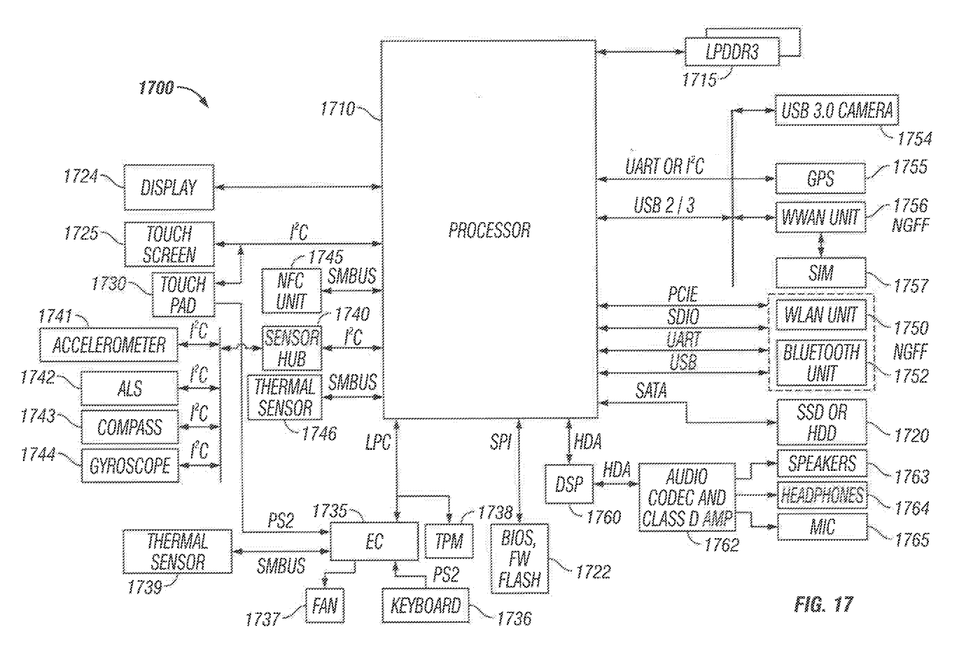

FIG. 17 is a block diagram of an electronic device 1700 for utilizing a processor 1710, in accordance with embodiments of the present disclosure. Electronic device 1700 may include, for example, a notebook, an ultrabook, a computer, a tower server, a rack server, a blade server, a laptop, a desktop, a tablet, a mobile device, a phone, an embedded computer, or any other suitable electronic device.

Electronic device 1700 may include processor 1710 communicatively coupled to any suitable number or kind of components, peripherals, modules, or devices. Such coupling may be accomplished by any suitable kind of bus or interface, such as I²C bus, system management bus (SMBus), low pin count (LPC) bus, SPI, high definition audio (HDA) bus, Serial Advance Technology Attachment (SATA) bus, USB bus (versions 1, 2, 3), or Universal Asynchronous Receiver/Transmitter (UART) bus.

Such components may include, for example, a display 1724, a touch screen 1725, a touch pad 1730, a near field communications (NFC) unit 1745, a sensor hub 1740, a thermal sensor 1746, an express chipset (EC) 1735, a trusted platform module (TPM) 1738, BIOS/firmware/flash memory 1722, a digital signal processor 1760, a drive 1720 such as a solid state disk (SSD) or a hard disk drive (HDD), a wireless local area network (WLAN) unit 1750, a Bluetooth unit 1752, a wireless wide area network (WWAN) unit 1756, a global positioning system (GPS) 1775, a camera 1754 such as a USB 3.0 camera, or a low power double data rate (LPDDR) memory unit 1715 implemented in, for example, the LPDDR3 standard. These components may each be implemented in any suitable manner.

Furthermore, in various embodiments other components may be communicatively coupled to processor 1710 through the components discussed above. For example, an accelerometer 1741, ambient light sensor (ALS) 1742, compass 1743, and gyroscope 1744 may be communicatively coupled to sensor hub 1740. A thermal sensor 1739, fan 1737, keyboard 1736, and touch pad 1730 may be communicatively coupled to EC 1735. Speakers 1763, headphones 1764, and a microphone 1765 may be communicatively coupled to an audio unit 1762, which may in turn be communicatively coupled to DSP 1760. Audio unit 1762 may include, for example, an audio codec and a class D amplifier. A SIM card 1757 may be communicatively coupled to WWAN unit 1756. Components such as WLAN unit 1750 and Bluetooth unit 1752, as well as WWAN unit 1756 may be implemented in a next generation form factor (NGFF).

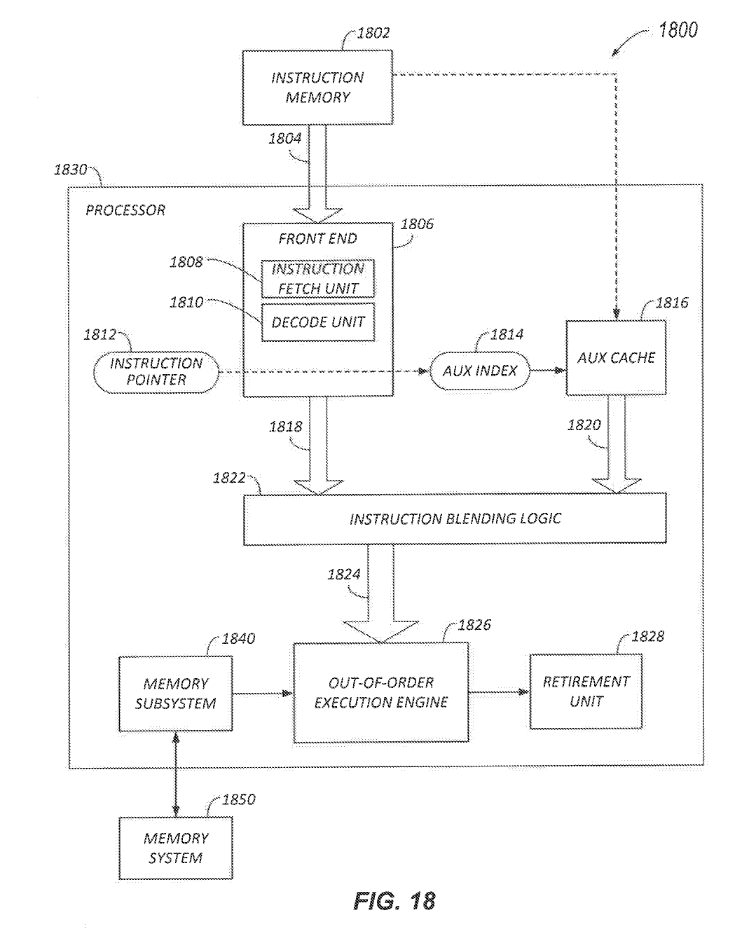

Embodiments of the present disclosure involve a processing apparatus and processing logic or circuitry for utilizing an auxiliary cache to reduce instruction fetch and decode bandwidth requirements. FIG. 18 is an illustration of an example system 1800 for utilizing an auxiliary cache to reduce instruction fetch and decode bandwidth requirements, according to embodiments of the present disclosure. As the size of instructions increases in some processors, in some cases due to an increase in the size of immediate values, there can be additional pressure on fetch and decode bandwidth. In a hardware-software co-designed processor, auxiliary instructions (sometimes referred to as non-working instructions, or NWIs) can be introduced by a binary translator, putting additional pressure on fetch and decode bandwidth. For example, a binary translation system emulates the original behavior of a source program. When the source program is broken down into a different set of steps and translated to a different memory space by the binary translator, one or more ancillary instructions may be introduced in order to properly emulate the original program behavior. Since these instructions are considered to be “extra”, as they do not explicit correspond to instructions in the original program sequence, they may be considered non-working instructions, or NWIs. Embodiments of the present disclosure, such as system 1800, may include a hardware-software co-designed mechanism for reducing the pressure on fetch and decode bandwidth. For example, these systems may include an on-chip hardware memory structure that is closely-coupled to the processor pipeline. This memory structure, referred to herein as an “auxiliary cache” or “AUX Cache”, may be managed by any combination of hardware or software. The techniques described herein for utilizing such an auxiliary cache may provide mechanisms for efficiently handling the execution of NWIs. For example, in some embodiments, the pressure on fetch and decode bandwidth may be reduced by reducing the number of NWIs that are introduced by the binary translator. In other embodiments, the pressure on fetch and decode bandwidth may be reduced by reducing the size of instructions that have long immediate values.

System 1800 may include a processor, SoC, integrated circuit, or other mechanism. For example, system 1800 may include processor 1830. Although processor 1830 is shown and described as an example in FIG. 18, any suitable mechanism may be used. For example, some or all of the functionality of processor 1804 described herein may be implemented by a digital signal processor (DSP), circuitry, instructions for reconfiguring circuitry, a microcontroller, an application specific integrated circuit (ASIC), or a microprocessor having more, fewer, or different elements than those illustrated in FIG. 18. Processor 1830 may include any suitable mechanisms for utilizing an auxiliary cache to reduce instruction fetch and decode bandwidth requirements. In at least some embodiments, such mechanisms may be implemented in hardware. For example, in some embodiments, some or all of the elements of processor 1804 illustrated in FIG. 18 and/or described herein may be implemented fully or in part using hardware circuitry. In some embodiments, this circuitry may include static (fixed-function) logic devices that collectively implement some or all of the functionality of processor 1804. In other embodiments, this circuitry may include programmable logic devices, such as field programmable logic gates or arrays thereof, that collectively implement some or all of the functionality of processor 1804. In still other embodiments, this circuitry may include static, dynamic, and/or programmable memory devices that, when operating in conjunction with other hardware elements, implement some or all of the functionality of processor 1804. For example, processor 1804 may include a hardware memory having stored therein instructions which may be used to program system 1800 to perform one or more operations according to embodiments of the present disclosure. Embodiments of system 1800 and processor 1804 are not limited to any specific combination of hardware circuitry and software. Processor 1830 may be implemented fully or in part by the elements described in FIGS. 1-17.

System 1800 may include an instruction memory 1802. Instruction memory 1802 may be communicatively coupled to processor 1830 and may store instructions to be executed by processor 1830. Processor 1830 may include one or more cores, each of which may include an execution unit. In one embodiment, processor 1830 may include an out-of-order execution engine 1826. In one embodiment, out-of-order execution engine 1826 may be a hardware-software co-designed execution engine.

In one embodiment, processor 1830 may receive instructions from instruction memory 1802 for execution as instruction stream 1804. The instructions in instruction stream 1804 may include instructions defined by an instruction set architecture (ISA) that is exposed to programmers. For example, in one embodiment, instruction stream 1804 may include instructions of a particular version of the x86 instruction set. In some embodiments, instruction stream 1804 may include instructions that have been translated from one ISA to another ISA by a binary translator. For example, a binary translator may translate instructions of an ISA that is exposed to programmers to instructions of an internal-only ISA that is implemented by processor 1830. In this case, execution of the translated instructions by processor 1830 may emulate the execution of the original (untranslated) instructions. In one embodiment, a binary translator may translate instructions of a particular version of the x86 instruction set to instructions of an internal-only ISA that is implemented by processor 1830. In the descriptions that follow, an internal-only ISA that is implemented by a processor may sometimes be referred to as a “micro-ISA”.

In some embodiments, a binary translator may translate various original instructions (including, for example, instructions that perform mathematical operations, logical operations, or control flow operations) to instructions of an internal-only ISA that perform the same functions as the original instructions, but are optimized for execution on processor 1830. The translation may affect which memory locations are accessed, as the translated instructions may be executed out of a different portion of the instruction memory. In one embodiment, the translated instructions may be executed out of a private portion of the instruction memory, such as a portion of the instruction memory that is concealed from the programmer. In some embodiments, the translation may change the number, type, or target addresses of branches in the instruction stream. In some embodiments, the translation may change the number of instructions that are executed to perform the operations of the original instructions. For example, executing the translated instruction stream may include sequencing through a different number of instructions than were present in the original instruction stream, and those instructions may be obtained from concealed memory locations. In one embodiment, executing the translated instruction stream may include emulating the state that would have been observed during execution of the original instruction stream.

In some embodiments, instruction stream 1804 may include one or more non-working instructions (NWIs) of the micro-ISA that were added by a binary translator during translation of a collection of original instructions from an externally-exposed ISA to the micro-ISA. For example, NWIs may be added to instruction stream 1804 to perform auxiliary tasks, such as committing state before a speculative operation. In another example, NWIs may be added to instruction stream 1804 by a binary translator to perform tasks for emulating the execution of an original (untranslated) instruction stream. For example, one or more NWIs may be added to instruction stream 1804 to perform a mapping between memory addresses or branch target addresses in instruction stream 1804 and in an original (untranslated) instruction stream. In another example, one or more NWIs may be added to instruction stream 1804 to manipulate the value of an instruction pointer, page offset, or performance counter to emulate the execution of an original (untranslated) instruction stream.

In one embodiment, processor 1830 may include a register in which an emulated instruction pointer is maintained. For example, in an embodiment in which instructions have been translated from a version of the x86 instruction set, the value of this emulated instruction pointer may, at least some of the time, reflect the value that would have been stored in the instruction pointer during execution of the original x86 instruction stream. In this example, one or more NWIs may be added to instruction stream 1804 to adjust the value in this register to match the instruction pointer of the original x86 instruction stream. In one embodiment, only the least significant bits of the value may be adjusted. In another embodiment, a page offset associated with this register may be adjusted. In one embodiment, the value in this register may be adjusted to be kept up-to-date with the state of the original x86 instruction stream only on control-flow transfers. For example, it may be adjusted by an NWI that is added at an exit point from a translation. This may include control flow NWIs added before and/or after function or procedure calls (which may also place the return location or other state in a register or memory location), NWIs added before chaining (such as NWIs used to directly connect translated regions together), NWIs added before side-exits (such as NWIs used to connect translated regions to the rest of the code in the binary translation system), or at other control-flow transition points.

In some embodiments, instruction stream 1804 may include one or more translated instruction that have been annotated by the binary translator. For example, the binary translator may annotate a translated instruction to indicate that it is associated with auxiliary information stored in an auxiliary cache, as described in detail below. In another example, the binary translator may annotate a translated instruction to include information usable to emulate the execution of one or more original (untranslated) instructions. In yet another example, the binary translator may generate and divert information usable to emulate the execution of one or more original (untranslated) instructions to aux cache 1816 for retrieval when a corresponding translated instruction is subsequently executed.

In one embodiment, processor 1830 may include a front end 1806, which may include an instruction fetch pipeline stage (such as instruction fetch unit 1808) and a decode pipeline stage (such as decide unit 1810). Front end 1806 may receive and decode instructions from instruction stream 1804 using instruction fetch unit 1808 and decode unit 1810, respectively. The decoded instructions (shown as instruction stream 1818) may be dispatched, allocated, and scheduled for execution by an allocation stage of a pipeline (not shown) and allocated to specific execution units, such as out-of-order execution engine 1826. In one embodiment, decoded instruction stream 1818 may include microcode (ucode) or more specific machine language.

In at least some embodiments, processor 1830 may include an auxiliary cache, such as aux cache 1816. In one embodiment, aux cache 1816 may include a relatively small hardware table, the use of which may enable a reduction in the number of non-working instructions (NWIs) added to a translated instruction stream by a binary translator. For example, aux cache 1816 may include as few as eight, sixteen or thirty-two entries. In one embodiment, the use of aux cache 1816 may enable a reduction in the size of translated instructions corresponding to original instructions with long immediate values. In one embodiment, a binary translator may determine that an instruction in an original (untranslated) instruction stream includes metadata or other information that will not be consumed until the instruction, or a corresponding translated instruction, is executed. In response to this determination, the binary translator may pre-decode and extract this information (which is referred to herein as “auxiliary information”) and divert it to aux cache 1816 for retrieval at execution time. In one embodiment, the binary translator may determine a respective key or index value usable to identify the location within aux cache 1816 at which any auxiliary information diverted to aux cache should be stored. For example, an encoding that represents an index value may be included in an original (untranslated) instruction. In another embodiment, the key or index value may be generated by the binary translator, as described in more detail below. In some embodiments, auxiliary information that is diverted to aux cache 1816 may not be included in instruction stream 1804 and may not be fetched or decoded by front end 1806. Thus, the bandwidth requirements on front end 1806 (more specifically, for instruction fetch unit 1808 and decode unit 1810) may be reduced. In one embodiment, the effective execution bandwidth of processor 1830 may be increased by placing frequently used values into aux cache 1816 and eliminating them from the code stream. Each instruction that employs one of these values may be annotated to indicate that the value should be obtained from aux cache 1816 at execution. In this way, redundant information that would otherwise have been included in the instruction stream will not take up space in the instruction stream and will not be repeatedly fetched and decoded.

In one embodiment, information about NWIs that are added to instruction stream 1804 by the binary translator may be diverted by the binary translator to aux cache 1816 for retrieval at execution time. In one example, rather than adding a separate non-working instruction to instruction stream 1804, information about an operation to be performed by a non-working instruction following the execution of one of the translated instructions in instruction stream 1804 may be stored in aux cache 1816 and associated with the translated instruction. In this case, when the translated instruction is allocated and/or scheduled for execution, the information about the non-working instruction may be retrieved from aux cache 1816 so that both the original function specified by the translated instruction and the non-working instruction are performed as part of the execution of the translated instruction. In another example, a non-working instruction may be added to instruction stream 1804 by the binary translator, but metadata or other information associated with the non-working instruction that will not be consumed until the non-working instruction is executed may be diverted to aux cache 1816. In these and other examples, the combination of auxiliary information obtained from aux cache 1816 with fetched instructions may be thought of as a form of “instruction fusion” in which, rather than fusing together multiple instructions that come from a fetched code stream, auxiliary information is fused with an instruction after it is fetched and decoded, but prior to its execution.

In embodiments of the present disclosure, the hardware table within aux cache 1816 may store auxiliary information associated with NWIs and/or auxiliary information associated with instructions of instruction stream 1804. In one example, this auxiliary information may include long immediate values that are used in state management. In another example, this auxiliary information may include long immediate values used in ALU operations. In some systems, these instructions may include long immediate fields, even though the immediate values themselves may be small. For example, some commonly-used immediate values (e.g., 0, 1, 2, or -1) may not require very many bits, but the ISA may define a much larger bit-field in which to encode them, thus wasting space in the encodings. In some embodiments, by utilizing aux cache 1816 to store the immediate value, the translated instruction produced by the binary translator may be as small as possible, regardless of the actual immediate value that will be consumed when the instruction is executed. In some applications, the distribution (usage) of instructions that have immediate values may be quite high, and many of them may use the same immediate value. For example, multiple instructions in an original (untranslated) instruction stream may include an immediate value of 1, indicating that another operand should be incremented by a delta value of 1. In some embodiments, instead of including the immediate values in the encodings of the translated instructions for all of these instructions, the binary translator may de-duplicate them. For example, the binary translator may write a single delta value of 1 into an entry of aux cache 1816 and may annotate multiple instructions so that they point to that auxiliary cache entry. In one embodiment, the binary translator may apply this approach when different ones of the original instructions in a translation include different common immediate values (e.g. values of −1, 0, 1, 2, 4, 8, or another commonly used delta value). In this case, the binary translator may store each delta value in a different entry within aux cache 1816 and may annotate each of the corresponding translated instructions to point a particular one of those values.

In some embodiments, diverting long immediate values to aux cache 1816 may increase the fetch and decode bandwidth of the processor. In one example, a processor may decode four instructions per cycle, but a long immediate may be the size of an entire instruction. In this case, when an instruction that includes a long immediate is fetched and decoded in a particular cycle, at most three instructions can be decoded during that cycle, and a fourth instruction has to wait for the next cycle. If the instruction with the long immediate is used multiple times in the instruction stream, this penalty may be paid every time the instruction is fetched and decoded (for every iteration of that instruction). In some embodiments, if the binary translator diverts the long immediate to aux cache 1816 and reduces the size of the translated instruction accordingly, the processor front end may be able to fetch and decode farther ahead and run four wide at all times, thus increasing its efficiency without modifying the front end itself.

In one embodiment of this co-designed mechanism, the binary translator may update the instruction stream and reduce its size by utilizing aux cache 1816. In one example embodiment, the binary translator may initialize the hardware table within aux cache 1816 for a particular code stream before its execution. In one embodiment, the binary translator may operate on one collection of instructions within the original instruction stream at a time, and may initialize the hardware table by loading all of the auxiliary information associated with the instructions in the collection into the hardware table prior to execution of that collection of instructions. In one example, the binary translator may operate on one basic block at a time, where each basic block is a sequence of instructions with a single entry point and a single exit point. In another example, the binary translator may operate on one super block at a time, where each super block is made up of a collection of basic blocks and has a single entry point.

In one embodiment, aux cache 1816 may be a software-managed hardware structure. For example, aux cache may be managed by binary translation software. In one embodiment, binary translation software may responsible for the proper placement of auxiliary information within aux cache 1816 and for its subsequent retrieval or removal. In embodiments in which aux cache 1816 is a software-managed hardware structure, it may be implemented as a relatively simple hardware cache that does not include support for handling overflow or misses. In one embodiment, the binary translation runtime system may have the ability to insert entries into aux cache 1816 and remove entries from aux cache 1816, and the instructions that are annotated to access entries in aux cache 1816 may hit or miss accordingly. In one embodiment in which aux cache 1816 is fully managed by software, the hardware table may be implemented as a scratchpad memory without tagging. In another embodiment, aux cache 1816 may be implemented using tags. The use of tags may enable at least some automatic (hardware) management of the hardware table, such as an automatic “fill on miss” mechanism. In one embodiment, aux cache 1816 may include circuitry or logic to manage the proper placement of auxiliary information within aux cache 1816 and its subsequent retrieval or removal. In another embodiment, the binary translator may be implemented wholly or in part by dedicated circuitry or logic. In one embodiment, a tagged version of the hardware table may be implemented as a content addressable memory structure.

In at least some embodiments, processor 1830 may include circuitry or logic to implement the functionality of instruction blending logic 1822, as described herein. In one embodiment, during execution of instruction stream 1804, the value of instruction pointer 1812 may identify a decoded instruction within decoded instruction stream 1818 that has been allocated and/or scheduled for execution. If the decoded instruction that has been allocated or scheduled for execution is associated with auxiliary information stored in aux cache 1816, it may be retrieved from aux cache 1816 and provided to instruction blending logic 1822 as auxiliary information 1820. In one embodiment, aux cache 1816 may be accessed only when an instruction annotated with a special hint bit (one that indicates that auxiliary information associated with the instruction is stored in aux cache 1816) is allocated and/or scheduled for execution. The auxiliary information retrieved from aux cache 1816 may then be blended with the decoded instruction by instruction blending logic 1822 before being passed to the execution unit (e.g., out-of-order execution engine 1826) that is to execute it.

In one embodiment, instruction blending logic 1822 may retrieve auxiliary information 1820 from aux cache 1816 using the value of aux index 1814. In one embodiment, circuitry or logic within processor 1830 may determine the value of aux index 1814 based on the value of instruction pointer 1812. In another embodiment, circuitry or logic within processor 1830 may determine the value of aux index 1814 based on the contents of a register whose value reflects the value that an instruction pointer would have had if the corresponding instruction in the original (untranslated) instruction stream were being executed. In yet another embodiment, circuitry or logic within processor 1830 may determine the value of aux index 1814 based on the value of a key included in the decoded instruction. In one embodiment, instruction blending logic 1822 may combine auxiliary information 1820 with ucode information included in decoded instruction stream 1818 and may provide this blended instruction information to out-of-order execution engine 1826 as an enhanced ucode stream 1824.

During execution, access to data or additional instructions (including data or instructions resident in memory system 1850) may be made through memory subsystem 1840. Moreover, results from execution may be stored in memory subsystem 1840 and may subsequently be flushed to memory system 1850. Memory subsystem 1840 may include, for example, memory, RAM, or a cache hierarchy, which may include one or more Level 1 (L1) caches or Level 2 (L2) caches, some of which may be shared by multiple cores or processors 1830. In one embodiment, aux cache 1816 may include its own hierarchy of caches. For example, a level 2 (L2) auxiliary cache may be introduced to keep from having to pollute the standard L1/L2 caches. After execution by out-of-order execution engine 1826, instructions may be retired by a writeback stage or retirement stage in retirement unit 1828. Various portions of such execution pipelining may be performed by one or more cores of processor 1830 (not shown).

Embodiments of the present disclosure are described herein as including a dynamic binary translator that generates executable code from program instructions at runtime. In some embodiments, the binary translator may be implemented as a just-in-time interpreter. For example, in one embodiment, the system may include a software interpreter of the external ISA. In another example, the system may include a hardware-based interpreter, and the hardware may be capable of direction execution. In yet another example, the system may implement a hybrid mechanism in which hardware supports direction execution of the majority of the external ISA (e.g., 80% or more of the external ISA), but some special or rare cases are handled by a software-based interpreter. In one embodiment, the execution of original (untranslated) instructions in an externally-exposed ISA may begin in an interpreted mode in which the instructions do not have to be translated in order to make forward progress. In at least some embodiments, a profiler may monitor execution of the original (untranslated) instructions to determine when and if it is appropriate to perform a translation to an internal “micro-ISA.” The profiler may be hardware-based or software-based, in different embodiments. For example, if the binary translation system includes a software-based interpreter, the profiler may also be software-based. However, if the binary translation system includes a hardware-based interpreter, the profiler may be hardware-based. In one example, a hardware profiler may determine that performance and/or resource unitization would be improved by translating a collection of instructions in the original (untranslated) instruction stream to instructions of a more optimized micro-ISA. If the hardware profiler determines that translation is appropriate, it may issue a special interrupt to pause execution of the instructions, run the binary translator, and write the translated instructions out to an alternate location in instruction memory. In this case, the processor may subsequently begin executing the translated instructions out of their alternate memory locations. For example, if an instruction pointer whose value at any given time represents the location of an original (untranslated) instruction contains a value for an instruction that has been translated, the processor may be forced to execute the translated instruction in the alternate memory location instead. In one embodiment, pausing the execution of the instructions may include pausing the running core in order to switch to the translator. In another embodiment, pausing the execution of the instructions may include interrupting an idle core in order to run the translator. In yet another embodiment, pausing the execution of the instructions may include interrupting a hidden core (or accelerator) that is dedicated to performing translations.

Executing the translated instruction may include accessing an entry within aux cache 1816 that is associated with the translated instruction and/or the corresponding original (untranslated) instruction. In some embodiments, executable instructions may be generated by, for example, a compiler, another type of just-in-time interpreter, or other suitable mechanism (which may or may not be included in system 1800). In still other embodiments, executable instructions may be generated be designated by a drafter of code resulting in instruction stream 1804. For example, a compiler may take application code and generate executable code in the form of instruction stream 1804. These instructions may be received by processor 1830 from instruction stream 1804.

In one embodiment, instruction memory 1802 may include a public portion that is exposed to programmers and is addressable by application code. The public portion of instruction memory 1802 may store original (untranslated) instructions. Instruction memory 1802 may also include a private portion that is concealed from programmers and is not addressable by application code. The private portion of instruction memory 1802 may store instructions that have been translated to a micro-ISA. For example, the private portion of instruction memory 1802 may store instructions that have been modified by a binary translator through translation and/or annotation, as described herein.

FIG. 18 illustrates an embodiment in which instruction stream 1804 is loaded from instruction memory 1802. In other embodiments, instruction stream 1804 may be loaded to processor 1830 in any suitable manner. For example, instructions to be executed by processor 1830 may be loaded from storage, from other machines, or from other memory, such as memory system 1850. The instructions may arrive and be available in resident memory, such as RAM, wherein instructions are fetched from storage to be executed by processor 1830. The instructions may be fetched from resident memory by, for example, a prefetcher or fetch unit (such as instruction fetch unit 1808).

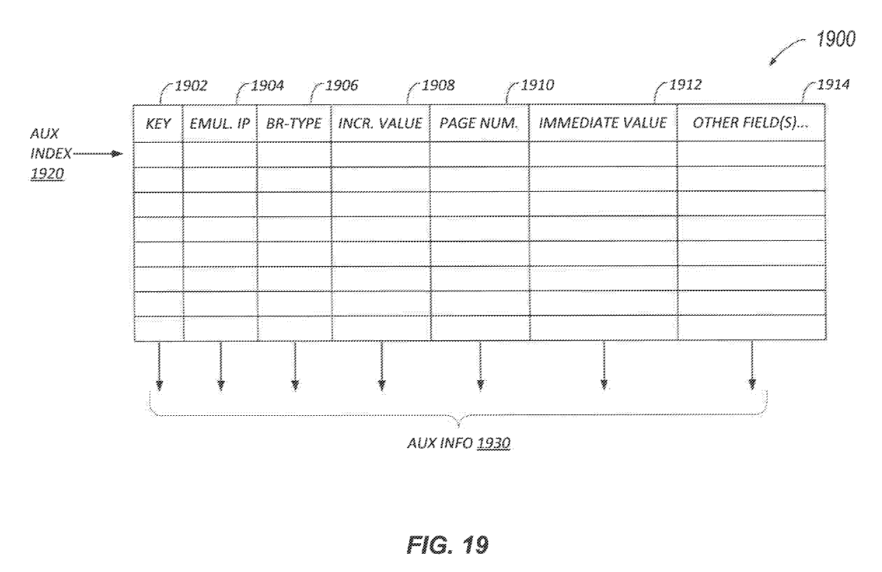

FIG. 19 is an illustration of a portion of an auxiliary cache 1900, according to embodiments of the present disclosure. This portion of auxiliary cache 1900 includes a hardware table for storing auxiliary information to be retrieved and blended with a decoded instruction at execution time. In one embodiment, auxiliary cache 1816 shown in FIG. 18 may be implemented by an auxiliary cache similar to auxiliary cache 1900. In other embodiments, auxiliary cache 1816 shown in FIG. 18 may have a different structure than auxiliary cache 1900. For example, a hardware table within auxiliary cache 1816 shown in FIG. 18 may include more, fewer, or different columns than the hardware table within auxiliary cache 1900, or may include a different number of entries than the hardware table within auxiliary cache 1900. In one embodiment, the hardware table within auxiliary cache 1900 may include eight entries. In other embodiments, the hardware table within auxiliary cache 1900 may include a different number of entries, such as sixteen, thirty-two, or another number of entries. In one embodiment, each entry of the hardware table within auxiliary cache 1900 may be 64-bits wide.

In one embodiment, each entry of the hardware table within auxiliary cache 1900 may include auxiliary information associated with a particular instruction to be executed by a processor 1830. In another embodiment, each entry of the hardware table within auxiliary cache 1900 may include auxiliary information associated with a particular group of instruction, such as instructions of a particular type or instructions associated with a particular key or tag. In one embodiment, each entry of the hardware table within auxiliary cache 1900 may be accessed by a respective index value, shown as aux index 1920. In one embodiment, each entry of the hardware table within auxiliary cache 1900 may be indexed by an aux index value representing a subset of the bits in one or more of the modified instructions produced by the binary translator. For example, the aux index value usable to access a given entry of the hardware table within auxiliary cache 1900 may be encoded in three or four bits of a modified instruction whose auxiliary information is stored in the given entry. In some embodiments, the auxiliary information stored in one entry of the hardware table within auxiliary cache 1900 may be associated with more than one of the modified instructions. In this case, the binary translator may include the same aux index encoding in all of the modified instructions that are to be blended with that entry for execution. In one embodiment, the value of aux index 1920 may be generated as a function of an instruction pointer value and a key or index value encoded in the modified instructions associated with that aux index value. In one example, the value of aux index 1920 may be generated as a function of register whose value at any given time represents the value that an instruction pointer would have had when executing a corresponding instruction in the original (untranslated) instruction stream.

In one embodiment, each column of the hardware table within auxiliary cache 1900 may store values representing auxiliary information of a specific pre-defined type. In such an embodiment, the values stored in the same positions within each entry of the hardware table within auxiliary cache 1900 may serve similar purposes. In some embodiments, the information stored in each entry may be auxiliary information that was pre-decoded and/or extracted from an original instruction by the binary translator during translation. In other embodiments, at least some of the information stored in each entry may be auxiliary information that was generated by the binary translator during translation. In at least some embodiments, the information stored in each entry of the hardware table within auxiliary cache 1900 may be auxiliary information that does not pass through the instruction fetch and decode portions of the execution pipeline of processor 1830, such as instruction fetch unit 1808 and decode unit 1810, prior to execution of the translated instruction associated with the auxiliary cache entry. Instead, this auxiliary information may, at execution time, be provided directly to the components of processor 1830 that will consume them.

In the example illustrated in FIG. 19, the hardware table within auxiliary cache 1900 may include a column 1902 in which a key for each entry is stored. In one embodiment, the hardware table within auxiliary cache 1900 may also include a column 1904 in which an emulated instruction pointer value for each entry is stored. For example, a value stored in this column may represent the value that an instruction pointer would have had when executing a corresponding instruction in the original (untranslated) instruction stream. In one embodiment, auxiliary cache 1900 may also include a column 1906 in which an original branch type may be stored (if applicable). For example, in some embodiments, processor 1830 may implement one or more branch filtering policies that are dependent on the branch type. However, during translation, an original branch instruction may be replaced by a branch instruction of a different type. For example, an original indirect branch instruction that always has the same target may be replaced with a direct branch instruction by the binary translator. In this case, the binary translator may store the branch type of the original branch instruction as auxiliary information in column 1906 of an auxiliary cache entry associated with the translated branch instruction. This may allow the filtering policy to be applied during execution of the translated branch instruction in the manner that was expected by the programmer.

In one embodiment, the hardware table within auxiliary cache 1900 may include a column 1908 in which an amount by which to increment or decrement an instruction pointer or other counter may be stored (if applicable). For example, when executing an original (untranslated) instruction stream, each instruction may flow through the execution pipeline such that, once the instruction is retired, an instruction pointer or a performance monitoring counter value is incremented or decremented by one. However, the translated instruction stream may include a different number of instructions than the original (untranslated) instruction stream. In some embodiments, the binary translator may determine that the amount by which the instruction pointer or performance monitoring counter value should be incremented or decremented when a translated instruction retires in order to emulate the behavior of the original (untranslated) instruction stream, and may store that value as auxiliary information in column 1908 of an auxiliary cache entry associated with the translated instruction. By diverting this auxiliary information to auxiliary cache 1900, rather than encoding it in the translated instruction, the amount of instruction cache space, fetch bandwidth, and decode bandwidth required to correctly emulate the original instruction may be reduced. In one example, an original (untranslated) basic block may include ten instructions, and it may only take nine translated instructions to implement the same functionality using instructions of the target micro-ISA. However, in order to emulate the behavior of the original basic block with respect to a performance counter whose value indicates the number of executed instructions, an extra operation may need to be performed to manipulate the value of the performance counter (e.g., to set it to a value of 10). In a system that does not include an auxiliary cache, the binary translator may add an NWI to the translated instruction stream to perform this manipulation, thus negating any performance advantage gained by translating the basic block to the micro-ISA. In one embodiment of the systems described herein, instead of adding an NWI to the translated instruction stream, the binary translator may tag the last (9th) translated instruction for the basic block with an annotation indicating that, when the instruction is executed, the performance counter value should be incremented by an additional amount whose value retrieved from the auxiliary cache (in this case, by a value of 1). In this manner, the emulation of the performance counter may be retained without polluting the otherwise-more-efficient translated instruction stream with an NWI.

In one embodiment, the hardware table within auxiliary cache 1900 may also include a column 1910 in which a physical page number may be stored (if applicable). This auxiliary information may be stored in the auxiliary cache by the binary translator during (or as a result of) a translation and may be used to ensure that, when executed, the behavior of the translated instruction stream emulates the behavior of the original (untranslated) instruction stream. In one example, a value stored in this column of a given auxiliary cache entry may identify the physical page on which an original (untranslated) instruction corresponding to the translated instruction associated with the auxiliary cache entry is found in instruction memory 1802. In another example, a value stored in this column of a given auxiliary cache entry may identify the physical page on which the translated instruction associated with the auxiliary cache entry is found in instruction memory 1802.

In one embodiment, the hardware table within auxiliary cache 1900 may also include a column 1912 in which an immediate value may be stored (if applicable). For example, the binary translator may pre-decode and extract a long immediate value from an original instruction encoding during its translation and may store that value as auxiliary information in column 1912 of an auxiliary cache entry associated with the corresponding translated instruction. By diverting this auxiliary information to auxiliary cache 1900, rather than encoding it in the translated instruction, the amount of instruction cache space, fetch bandwidth, and decode bandwidth required to execute the translated instruction may be reduced.

In some embodiments, the hardware table within auxiliary cache 1900 may include one or more additional columns 1914 in which other types of auxiliary information may be stored, as applicable in the system. In other embodiments, more, fewer, or different types of auxiliary information may be stored in the entries of the hardware table within auxiliary cache 1900. The auxiliary information stored in a given entry of the hardware table within auxiliary cache 1900 may, collectively, be referred to as aux info 1930. Various portions of aux info 1930 (e.g., the values stored in one or more columns) may be blended with a decoded instruction and provided to other components of processor 1830 at execution time. For example, the values stored in one or more columns within a given auxiliary cache entry may be provided to an execution unit, such as out-of-order execution engine 1826. In another example, the values stored in one or more columns within a given auxiliary cache entry may be provided to one or more registers, such as register in which operands for the decoded instruction are expected to be found. In other examples, the values stored in one or more columns within a given auxiliary cache entry may be provided to an issue queue, or to prediction logic, as applicable. In one embodiment, the contents of the hardware table within auxiliary cache 1900 may be managed by binary translation software. In other embodiments, the contents of the hardware table within auxiliary cache 1900 may be managed, at least in part, by circuitry or logic within auxiliary cache 1900 or another component of processor 1830 or system 1800.

In at least some embodiments, diverting auxiliary information to the auxiliary cache may reduce stalls in the processor pipeline due to misses in the instruction cache. For example, in a system that does not include an auxiliary cache, if a miss is encountered in the instruction cache when the processor front end attempts to fetch a long immediate value, the execution pipeline can stall until the long immediate can be obtained from the memory system. In the systems described herein, the auxiliary cache is not accessed by the front end of the processor, but is accessed inside of the out-of-order window of the processor. Thus, if a miss is encountered when attempting to retrieve a long immediate from the auxiliary cache, the time it takes to load the auxiliary cache with the long immediate (e.g., from instruction memory) may be absorbed in an out-of-order way without stalling the front end of the execution pipeline. In this case, the front end may continue to process the instruction stream, fetching bytes, decoding them and providing them to various execution units.

In some embodiments, the auxiliary information diverted to the auxiliary cache may be information associated with the instructions of a particular “translation”. In this context, the term “translation” may refer to the granularity at which collections of instructions are modified by the binary translator. As noted above, in one embodiment, each translation may operate on a single basic block of instructions, where each basic block is a sequence of instructions with a single entry point and a single exit point. In other embodiments, each translation may operate on one super block at a time, where each super block is made up of a collection of basic blocks and has a single entry point. In some embodiments, when a miss is encountered for the auxiliary cache, all of the auxiliary information that was produced for the current translation may be loaded into the auxiliary cache. In one embodiment, this approach may result in the auxiliary cache exhibiting good locality. Thus, only a single miss may be encountered for a given translation. In some embodiments, the larger the number of instructions included in a translation, the more opportunities there may be for optimization using the mechanisms described herein. For example, the larger the number of instructions included in a translation, the fewer NWIs may be added to the instruction stream.

In embodiments of the present disclosure, auxiliary information that was diverted from the instruction stream, or that is associated with an instruction in the instruction stream, a basic block of instructions in the instruction stream, a super block of instructions in the instruction stream, or any NWIs that were added during the translation of the instruction stream (and that is not needed until execution time) may be blended with the corresponding ucode instruction stream at execution time. For example, in some embodiments, to perform the blending, ucode functions, operands (including long immediate values), and/or control signals may be added to the ucode stream or may be modified by the binary translator to produce an enhanced ucode stream, which is then fed to a co-designed backend for execution. In some embodiments, the system may support two modes of operation: a base mode that does not include support for an auxiliary cache, and an enhanced mode that takes advantage of an auxiliary cache. In embodiments of the present disclosure, there may be many instances in which metadata, such as properties and annotations that would have been embedded in the translated code stream by the binary translator, may instead be diverted to the auxiliary cache. These may include, for example, any or all of the following:
metadata associated with commit boundaries (e.g., metadata usable in managing atomicity and transaction commits)
metadata associated with translation entry points (e.g., metadata identifying the single entry point of a basic block or super block, or control information associated with such an entry point)
branch type information (e.g., for last-branch-record updates)
prefetch hints (e.g., “prefetch with this offset”)
branch hints (e.g., “the next branch is in n cycles”)
renaming hints (e.g., dependencies, etc.)
performance characteristics, such as instructions-per-cycle (IPC) characteristics (e.g., high, low, or memory-bound)
instruction pointer information (e.g., for emulation of the original instruction stream)
large (long) immediate values

Instead of encoding this information in existing and additional instructions that are fetched as part of the micro-ISA code stream, at least some micro-ISA instructions may be annotated to indicate that additional instruction properties needed at execution time are stored in the auxiliary cache. In one embodiment, the assertion of a special “aux” bit in a micro-ISA instruction may trigger a lookup into the auxiliary cache. In some embodiments, a “hit” in the auxiliary cache structure may pull in the additional information, which may then be used within the execution pipeline. In some embodiments, a “miss” in the auxiliary cache structure may trigger a disruption. In one embodiment, the disruption may be handled by the binary translation run-time system, which may fill the auxiliary cache with the information produced by a current or recent translation. In another embodiment, a “miss” in the auxiliary cache structure may be handled by hardware in the auxiliary cache or processor. As described in more detail below, the use of an auxiliary cache may, in some embodiments, eliminate a large percentage of non-working instructions from the translated code stream. This may ease the burden of emulating the execution of the original instruction stream when utilizing performance monitoring features of the processor.

In some embodiments, by utilizing the auxiliary cache to store information about an NWI, the binary translator may not need to add the NWI as a separate instruction in the translated instruction stream. For example, in a system without an auxiliary cache, if an original instruction stream included two “add” instructions and, in addition to performing those two add operations, the instructions in the translated instruction stream also need to modify the value of an emulated instruction pointer, the binary translator might add a third instruction (an NWI instruction) to the instruction stream to manipulate the emulated instruction pointer value. In some embodiments of the systems described herein, rather than adding a third instruction, the binary translator may set a bit in a translated instruction corresponding to one of the two original instructions to indicate that it should access the auxiliary cache when it executes, and may write auxiliary information needed to perform the manipulation of the emulated instruction pointer into an auxiliary cache entry for annotated instruction. In this example, the binary translator may fuse NWI metadata into the translated instruction stream without adding an additional instruction that would need to be fetched and decoded. When the annotated instruction is allocated for execution, the NWI metadata may be retrieved from the auxiliary cache and provided to an execution unit, which may perform the specified manipulation of the emulated instruction pointer.

The mechanisms described herein for modifying an instruction stream to make use of an auxiliary cache structure and reduce fetch bandwidth utilization may be further illustrated by the following examples. In one embodiment, these mechanisms may target hot loops so that the cost of initializing the auxiliary cache structure is amortized.

As described herein, the instruction stream generated by a binary translator in a software-hardware co-designed processor may contain NWIs. In certain types of applications, and for a large variety of workloads, the extent of these NWI instructions has been measured to include 8-15% of the total instruction stream. In one example, the instruction stream generated by the binary translator may include a commit instruction that was added by the binary translator before each loop iteration to save the state for recovery in the case that a speculative operation performed inside the iteration is incorrect. An example of one such loop body, representing a portion of an original (untranslated) instruction stream, is shown in the pseudo-code below. In this example, the commit instruction at the beginning of each iteration (“cmit”) uses a particular commit identifier (“cmit_id”) to preserve the state related to the iteration for use in the case of a speculation failure.

Loop:

cmit.<cmit_id>
<loop body>
jcc Loop

In one embodiment of the systems described herein, binary translation software may modify the instruction stream to take advantage of the existence of the auxiliary cache structure, which may be a hardware table. More specifically, the binary translator may modify the instruction stream such that the commit instruction is fetched only once when it updates the “cmit_id” information to the hardware table. In this example, the binary translator also modifies the back-edge branch so that it indexes (using “indx”) into the hardware table to initiate commit related operations each time the branch is taken (each time the loop iterates). The fact that the cmit and jcc instructions will take these special actions may be indicated by a special bit (shown as “sp”) with which they are annotated by the binary translator. An example of the translated code, which removes the NWI from inside the loop, is shown in the pseudo-code below.

cmit.sp.<cmit_id>

Loop:

<loop body>
jcc.sp.<indx> Loop

Another category of instructions that may benefit from the mechanisms described herein includes ALU instructions with long immediate values. Typically, such instructions are handled by letting a register hold the immediate value. However, in software-hardware co-designed binary-translation-based systems that strive to translate relatively large portions of the instruction stream in order to amortize the cost of translation, register pressure can be high and it may not always be easy to find a free register. Such instructions can be a major contributor to fetch bandwidth usage when they are location inside loops. One such loop, containing original (untranslated) instructions, is shown in the example pseudo-code below.

Loop:

cmit.<cmit_id>
add r2, <long_imm>
<rest of the loop body>
jcc Loop

In one embodiment of the systems described herein, binary translation software may modify the instructions of this loop to make use of the hardware structure and, thus, to reduce fetch bandwidth. An example of the translated code is shown in the pseudo-code below. In this example, the binary translator adds to the instruction stream a special instruction that manages the hardware structure. More specifically, the added instruction (“ins”) inserts the long immediate value in an entry of the hardware structure at index “indx”. The ALU operation inside the loop (“add”) is then patched to access the hardware structure at index “indx” during execution. This is indicated by a special bit (shown as “sp”) with which it is annotated by the binary translator. This may significantly reduce the size of a frequently executed instruction.

ins <long_imm>, <indx>

Loop:

cmit.<cmit_id>
add.sp r2, <indx>
<rest of the loop body>
jcc Loop

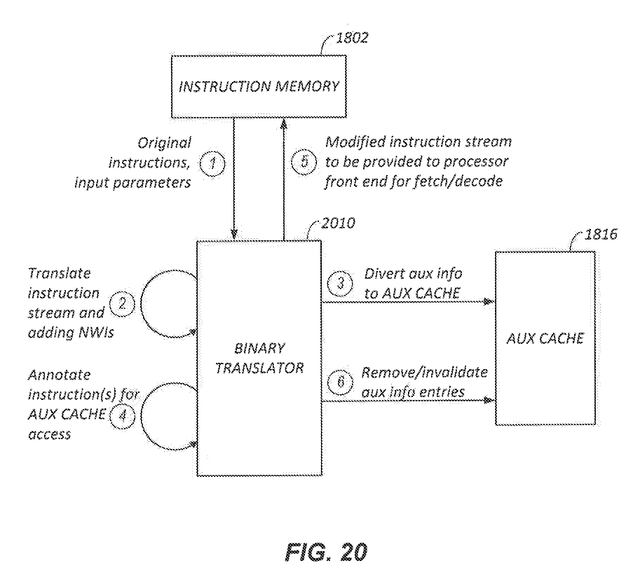

FIG. 20 is an illustration of the operation of a binary translator that utilizes an auxiliary cache, according to embodiments of the present disclosure. In the example embodiment illustrated in FIG. 20, at (1) an instruction stream containing original instructions and their input parameters may be retrieved from instruction memory 1802 by binary translator 2010. The instructions may be defined by a particular instruction set architecture (ISA). In one embodiment, the instructions may be instructions of a particular version of the x86 instruction set. At (2), binary translator 2010 may modify the received instruction stream to generate a ucode instruction stream. For example, binary translator 2010 may translate the received (original) instructions to ucode instructions, as described above. In some embodiments, translating the original instructions to ucode instructions may include the binary translator 2010 adding one or more non-working instructions (NWIs) to the ucode instruction stream. For example, in some embodiments, one or more NWIs may be added for managing atomicity and transaction commits, such as on a translation boundary. In another example, one or more NWIs may be added to perform mapping operations between locations in memory accessed by the translated instructions and locations in memory accessed by the original (untranslated) instructions. In another example, one or more NWIs may be added to perform mapping operations between branch targets in the translated instructions and those in the original (untranslated) instructions. In another example, one or more NWIs may be added to manipulate the values of an instruction pointer so that it emulates the values that an instruction pointer would have had during execution of the original (untranslated) instructions. In yet another example, one or more NWIs may be added to manipulate the values of a hardware or software performance counter so that it emulates the values that a hardware or software performance counter would have had during execution of the original (untranslated) instructions. In some embodiments, binary translator 2010 may determine that an instruction encoding includes, or is associated with, auxiliary information that is not needed until execution.

At (3), in this example, binary translator 2010 may divert the auxiliary information to aux cache 1816 for storage and subsequent retrieval. For example, one or more of the received instructions may include, or be associated with, auxiliary information that is to be written to aux cache 1816 for retrieval during execution of the instruction. In another example, one or more added NWIs may include, or be associated with, auxiliary information that is to be written to aux cache 1816 for retrieval during execution of the instruction. In one embodiment, the auxiliary information may be stored in a particular column (or particular columns) within aux cache 1816 according to the type of the auxiliary information. For example, aux cache 1816 may include a hardware table with multiple columns, each of which stores auxiliary information of a respective different type. The types of auxiliary information stored in aux cache 1816 may include, but may not be limited to, immediate values, branch hints, prediction hints, next-branch-distances, jump distances, prefetch hints, branch type indicators, amounts by which to increment an instruction pointer, page identifiers, keys, or identifiers of functions to be performed during execution of the instructions in addition to functions defined for the instructions by the ISA. At (4), binary translator 2010 may annotate the ucode instruction encodings for the received instructions and/or NWIs that are associated with such auxiliary information to indicate that the auxiliary information is stored in aux cache 1816. For example, binary translator 2010 may set a bit in the ucode instruction encoding to indicate that the ucode instruction is to be blended with auxiliary information retrieved from aux cache 1816 prior to being provided to an execution unit.

At (5), in this example, binary translator 2010 may write out a modified instruction stream into instruction memory 1802. For example, in one embodiment, binary translator 2010 may write out a translated and annotated ucode instruction stream to a private or concealed portion of instruction memory 1802. In another embodiment, binary translator 2010 may write out a translated and annotated ucode instruction stream to a concealed portion of a memory other than instruction memory 1802, such as a private memory. In some embodiments, binary translator 2010 may be responsible for managing the contents of aux cache 1816. In one embodiment, binary translator 2010 may, at (6), remove or otherwise invalidate one or more entries within aux cache 1816. For example, binary translator 2010 may flush the contents of aux cache 1816 when beginning the translation of a super block of instructions in order to make room for any auxiliary information associated with the instructions in the super block and/or any NWIs added during the translation. In another example, binary translator 2010 may overwrite the contents of aux cache 1816 during translation of a super block of instructions. In one embodiment, the auxiliary information associated with individual instructions of a translated super block may be written to aux cache 1816 as the translation progresses. In another embodiment, all of the auxiliary information associated with the instructions of a translated super block may be loaded to aux cache 1816 at substantially the same time, such as by a single operation.

In some embodiments, binary translator 2010 may repeat the operations illustrated in FIG. 20 as execution of the instructions in the ucode instruction stream continues. For example, binary translator 2010 may be a dynamic binary translator that continuously receives instructions of an instruction stream, translates the instructions (individually or one super block at a time) or otherwise modifies the instruction stream as described herein, as appropriate, and writes out the modified instruction stream to instruction memory, as needed. In one embodiment, the binary translator may refill aux cache 1816 on a miss (not shown). For example, the binary translator may load all of the auxiliary information associated with the instructions of a translated super block into aux cache 1816 in response to an auxiliary cache miss.

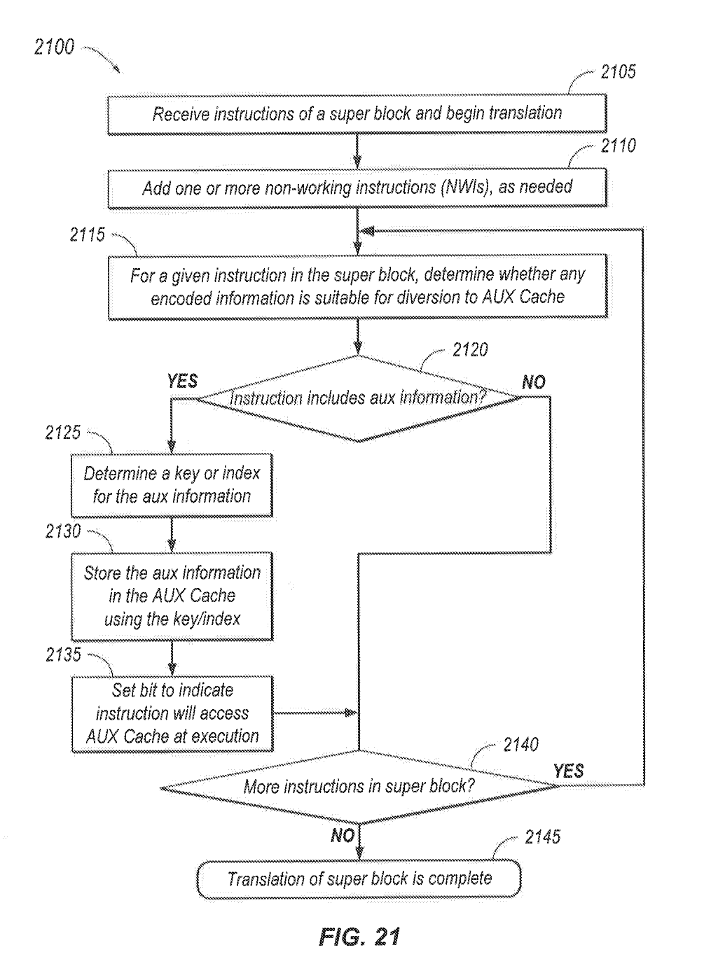

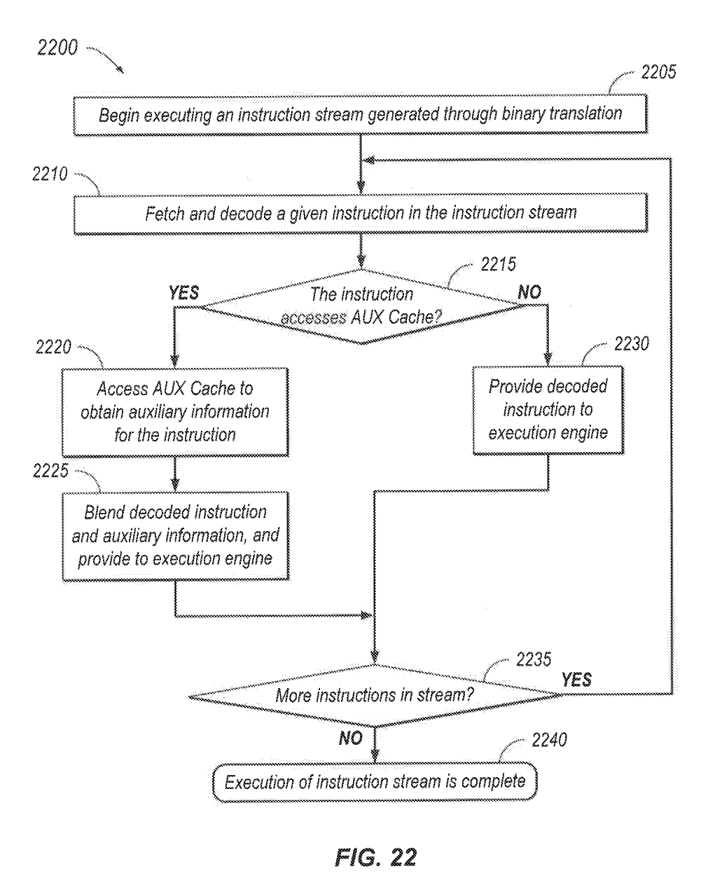

FIG. 21 is an illustration of a method 2100 for translating a super block of instructions so that an auxiliary cache is utilized during their execution, according to embodiments of the present disclosure. Method 2100 may be implemented by any of the elements shown in FIGS. 1-20. Method 2100 may be initiated by any suitable criteria and may initiate operation at any suitable point. In one embodiment, method 2100 may initiate operation at 2105. Method 2100 may include greater or fewer steps than those illustrated. Moreover, method 2100 may execute its steps in an order different than those illustrated below. Method 2100 may terminate at any suitable step. Moreover, method 2100 may repeat operation at any suitable step. Method 2100 may perform any of its steps in parallel with other steps of method 2100, or in parallel with steps of other methods.

At 2105, in one embodiment, instructions within a super block may be received and translation of those instructions may begin. For example, the instructions within the super block may be instructions of a first ISA and may be translated to instructions of a second ISA. In one embodiment, the first ISA may be an ISA that is exposed to programmers, and the second ISA may be an internal-only ISA that includes features that are not available to the programmers. In one embodiment, the instructions of the second ISA may take advantage of hardware or logic in the processor to improve performance or resource utilization during execution, when compared to the execution of the instructions of the first ISA. In at least some embodiments, translating the instructions may cause different memory locations to be accessed by the translated instructions than those that would have been accessed by the original (untranslated) instructions. In at least some embodiments, translating the instructions may cause the targets of one or more branches by the translated instructions to be different from the targets of corresponding branches by the original (untranslated) instructions. In at least some embodiments, the number of instructions in the translated instructions may be different than the number of original (untranslated) instructions.

At 2110, one or more non-working instructions (NWIs) may be added to the translated instructions, as needed. For example, in some embodiments, one or more NWIs may be added for managing atomicity and transaction commits, such as on a translation boundary. In another example, one or more NWIs may be added to perform mapping operations between locations in memory accessed by the translated instructions and locations in memory accessed by the original (untranslated) instructions. In another example, one or more NWIs may be added to perform mapping operations between branch targets in the translated instructions and those in the original (untranslated) instructions. In another example, one or more NWIs may be added to manipulate the values of an instruction pointer so that it emulates the values that an instruction pointer would have had during execution of the original (untranslated) instructions. In yet another example, one or more NWIs may be added to manipulate the values of a hardware or software performance counter so that it emulates the values that a hardware or software performance counter would have had during execution of the original (untranslated) instructions.

At 2115, in one embodiment, it may be determined, for a given instruction in the super block, whether or not any encoded information is suitable for diversion to the auxiliary cache. For example, it may be determined whether or not the given instruction includes any encoded information associated with an added NWI. In another example, it may be determined whether or not the instruction includes any encoded information representing an immediate value for the instruction. In one embodiment, it may be determined whether or not the instruction includes an encoding usable to identify a memory location, branch instruction type, or branch target specified in the original (untranslated) instructions. In one embodiment, it may be determined whether or not the instruction includes any other type of encoded information that is not to be consumed until execution of the translated instruction stream.

If (at 2120) it is determined that the given instruction includes, or is associated with, information that is suitable for diversion to the auxiliary cache, then at 2125, a key or index for the auxiliary information may be determined. The key or index value may be usable to access a location in the auxiliary cache at which the auxiliary information should be stored. In one embodiment, an encoding that represents an index value may be included in the original (untranslated) instruction. In another embodiment, the key or index value may be generated by the binary translator. For example, the key or index value may be selected randomly by the binary translator from among keys or index values associated with unused entries in the auxiliary cache. In another example, the key or index value may be generated by the binary translator based on information encoded in the instruction. In another example, the key or index value may be generated by the binary translator based on the auxiliary information. In yet another example, the key or index value may be generated by the binary translator based an instruction pointer value. At 2130, the auxiliary information may be stored in the auxiliary cache at a location that is identified by (or accessible using) the key or index value. At 2135, a bit in the encoding of the translated instruction may be set to indicate that, at execution, the instruction will access auxiliary cache to retrieve the auxiliary information.

If (at 2120) it is determined that the given instruction does not include, nor is it associated with, information that is suitable for diversion to the auxiliary cache, the operations shown as 2125-2135 may be elided. While (at 2140), there are additional instructions within the super block being translated, any or all of the operations shown in 2115-2125 may be repeated, as applicable. Once (at 2140), there are no additional instructions within the super block to be translated, the translation of the super block may be complete, as in 2145.

In some embodiments, not every instruction translated by the binary translator or executed by the processor will utilize the auxiliary cache. Instead, instructions may be modified by the binary translator to utilize the auxiliary cache selectively, such as in situations in which it will exhibit good locality. In some embodiments, instructions may be modified by the binary translator to utilize the auxiliary cache in situations in which an instruction that includes metadata or other information that is not consumed until execution will execute frequently.

FIG. 22 is an illustration of a method 2200 for executing an instruction stream that utilizes an auxiliary cache, according to embodiments of the present disclosure. Method 2200 may be implemented by any of the elements shown in FIGS. 1-20. Method 2200 may be initiated by any suitable criteria and may initiate operation at any suitable point. In one embodiment, method 2200 may initiate operation at 2205. Method 2200 may include greater or fewer steps than those illustrated. Moreover, method 2200 may execute its steps in an order different than those illustrated below. Method 2200 may terminate at any suitable step. Moreover, method 2200 may repeat operation at any suitable step. Method 2200 may perform any of its steps in parallel with other steps of method 2200, or in parallel with steps of other methods.

At 2205, in one embodiment, execution of an instruction stream generated through binary translation may begin. In various embodiments, the instruction stream may include one or more original, annotated, and/or non-working instructions (NWI). For example, the instruction stream may include one or more untranslated instructions of a first ISA. In another example, the instruction stream may include a translated instruction of a second ISA that has been annotated by the binary translator to include an indication that auxiliary information for the translated instruction has been stored in the auxiliary cache for subsequent retrieval. In yet another example, the instruction stream may include one or more NWIs that were added by the binary translator. At 2210, a given instruction in the instruction stream may be fetched and decoded. The given instruction may be an original instruction, an annotated instruction, or a non-working instruction. If (at 2215), it is determined that the given instruction is not to access the auxiliary cache, then at 2230, the decoded instruction may be provided to an execution engine as is (e.g., without first being blended with auxiliary information). For example, in one embodiment, if a particular bit in the encoding of the instruction is set, this may indicate that auxiliary information associated with the given instruction has been stored in the auxiliary cache. In this example, if the particular bit in the encoding of the instruction is not set, this may indicate that no auxiliary information associated with the given instruction was stored in the auxiliary cache.

If (at 2215), it is determined that the given instruction accesses the auxiliary cache, then at 2220, the auxiliary cache may be accessed to obtain the auxiliary information for the given instruction. In one embodiment, the auxiliary information may be obtained from a location in the auxiliary cache identified by (or accessed using) a key or index value for the instruction. At 2225, the decoded instruction may be blended with the auxiliary information, and the blended instruction may be provided to the execution engine. In one embodiment, while (at 2235) there are additional instructions in the instruction stream, the operations shown in 2210-2230 may be repeated, as applicable. Once (at 2235) it is determined that there are no additional instructions in the instruction stream, execution of instruction stream may be complete, as in 2240. In some cases, when attempting to obtain the auxiliary information for the given instruction (at 2220), an auxiliary cache miss may occur (not shown). In some embodiments, an auxiliary cache miss may be satisfied by a hardware state machine that performs an automatic fill of the requested information from memory. In other embodiments, an auxiliary cache miss may trigger a micro-exception to the binary translation system, and the binary translation software may perform a fill of the requested information from memory. In either case, the fill mechanism may populate multiple auxiliary cache entries using a single fill operation.

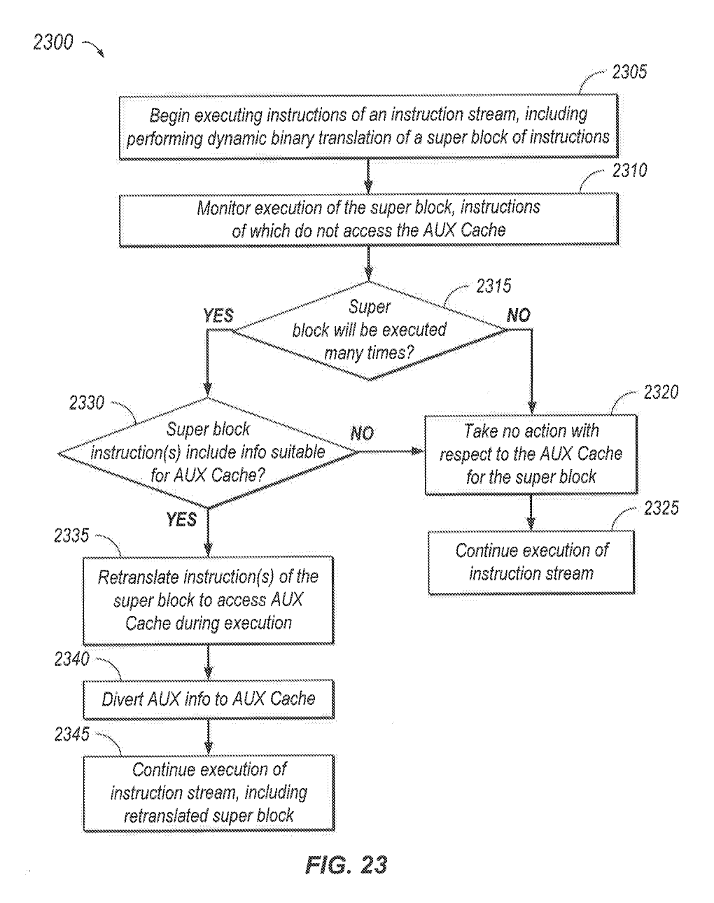

FIG. 23 is an illustration of a method 2300 for dynamically retranslating an instruction stream to take advantage of an auxiliary cache, according to embodiments of the present disclosure. Method 2300 may be implemented by any of the elements shown in FIGS. 1-20. Method 2300 may be initiated by any suitable criteria and may initiate operation at any suitable point. In one embodiment, method 2300 may initiate operation at 2305. Method 2300 may include greater or fewer steps than those illustrated. Moreover, method 2300 may execute its steps in an order different than those illustrated below. Method 2300 may terminate at any suitable step. Moreover, method 2300 may repeat operation at any suitable step. Method 2300 may perform any of its steps in parallel with other steps of method 2300, or in parallel with steps of other methods.

At 2305, in one embodiment, execution of the instructions of an instruction stream may begin. This may include performing a dynamic binary translation of a super block of instructions within the instruction stream. Executing the instructions of the instruction stream may include (at 2310) monitoring the execution of the super block of instructions. In this example, it is assumed that, based on the initial translation of the instructions of the super block, no auxiliary information for the translated instructions is stored in the auxiliary cache, and that the translated instructions do not access the auxiliary cache.

If (at 2315) it is determined that the super block will be executed many times, and if (at 2330) it is determined that at least some of the instructions in the super block include information suitable for diversion to the auxiliary cache, then at 2335, the instructions in the super block may be retranslated so that at least some of them access the auxiliary cache during execution. For example, the binary translator may annotate some of the retranslated instructions to include an indication that auxiliary information has been stored in the auxiliary cache for subsequent retrieval. Retranslating the instructions of the super block may include (at 2340) diverting auxiliary information for at least some of the instructions to the auxiliary cache. Following the retranslation, execution of instruction stream may continue, including execution of the instructions of the retranslated super block, as in 2345.

If (at 2315) it is determined that the super block will not be executed very many times or if (at 2330) it is determined that none of the instructions of the super block include information suitable for diversion to the auxiliary cache, then (as shown at 2320), no action may be taken with respect to the auxiliary cache for the super block. In this case, execution of instruction stream may continue without retranslation of the super block, as in 2325. In some embodiments, by dynamically retranslating an instruction stream, or a portion thereof, in response to a profiling result, instruction fetch and decode bandwidth requirements may be reduced.

Furthermore, method 2300 may be executed multiple times to translate and/or retranslate instructions within a super block of instructions. Method 2300 may be executed over time to reduce fetch and decode bandwidth requirements of an application while it is running.

The mechanisms described herein for utilizing an auxiliary cache to reduce fetch and decode bandwidth requirements may be applied to improve the performance and resource utilization of a wide variety of instructions translated from an original instruction stream. In some embodiments, they may also improve the performance and resource utilization of an application as a whole by reducing the number and footprint of NWIs added to the instruction stream by a binary translator. For example, when NWIs are required to manage one or more instruction pointers in order to emulate the behavior of an original instruction stream, auxiliary information indicating an amount by which an instruction pointer value should be incremented or decremented may be stored in the auxiliary cache, reducing the footprint of the NWI. In some embodiments, the NWI itself may be subsumed by another instruction in the translated instruction stream.

In another example, when translated to a micro-ISA, call and return instructions, which perform a variety of operations, may include multiple micro-ISA instructions to perform all of the constituent operations. For example, the execution of a call instruction may include jumping to a new location, calculating an address, and pushing it onto the stack. The execution of a return instruction may include popping something from the stack, incrementing the stack pointer, and jumping to a new location. Thus, each call or return instruction may be represented in the translated instruction stream by as many as 6 micro-ISA instructions. In some embodiments, by storing some instruction-pointer-related information in the auxiliary cache, the translated stream may include fewer of these micro-ISA instructions and at least some of them may be smaller than if the instruction-pointer-related information were encoded in the micro-ISA instructions themselves. In many types of workloads, calls and returns are frequent instructions. Therefore, making them efficient may have a large impact on overall performance.

In some embodiments, translation metadata may be stored in the auxiliary cache so that it can be utilized by other processor hardware components. For example, in a processor that does not include an auxiliary cache, in order to predict the whole program well, the branch predictor has to know all the branches in the program. The original instructions of the program may be translated on a super block basis, which may change the number, type, and targets of at least some branches, and may provide coarser-grained branch information to the branch predictor. In some embodiments, the binary translator may store information in the auxiliary cache indicating to the hardware that particular basic blocks are part of a given translation (e.g., a translation A or a translation B). In one embodiment, the binary translator may store information in the auxiliary cache indicating to the hardware that, for example, translation A always jumps to translation B. This information may be used to influence branch prediction using less information than is typically available to the branch predictor. In one embodiment, this information may be used to influence prefetching. For example, when beginning execution of translation A, the hardware may perform a single pre-fetch of the instruction at the beginning of translation B, thus loading information about that instruction, as well as other auxiliary information for translation B into the auxiliary cache.

In some embodiments, the auxiliary cache may be used to reduce the number of times that branch prediction is performed. For example, when original instructions are translated by the binary translator, some, if not many, branches may be eliminated in the translated instruction stream. In one embodiment, the binary translator may store branch hint information in the auxiliary cache indicating the distance (e.g., n cycles) to the next branch. When a translated instruction associated with one of these branch hints is allocated for execution, this auxiliary information may inform the execution unit that it does not need to access the branch predictor for the next (n−1) cycles. In embodiments in which the branch predictor is a large circuit, avoiding accessing the branch predictor on every cycle, in this manner, may save a non-trivial amount of power.

In different embodiments of the present disclosure, the auxiliary cache may be implemented and managed in different ways. In at least some embodiments, the auxiliary cache may be fully software managed. In one embodiment, a single bit in the instruction may indicate that the auxiliary cache should be accessed at execution time, and the auxiliary cache entries may be indexed using information embedded in the translated instruction. For example, each translated instruction may include a few bits that represent an index value and each auxiliary cache entry may be indexed using an index value. In this example, if an instruction is tagged with and index value ID5, it would hit or miss in the auxiliary cache depending on whether an auxiliary cache entry is indexed using index value ID5. In some embodiments, the auxiliary cache may be implemented as a cache in which the hardware is aware of the indexing policy and the translated instructions only need to include an indication of whether or not the auxiliary cache should be accessed at execution time. In this example, if the indication of whether or not the auxiliary cache should be accessed is true, the hardware may access the correct auxiliary cache entry implicitly.

In some embodiments, the fill mechanism for the auxiliary cache may be hardware based. In other embodiments, the fill mechanism for the auxiliary cache may be managed by software. For example, the fill mechanism for the auxiliary cache may be managed by the binary translation runtime. In some embodiments, if there is a miss on the auxiliary cache, but the auxiliary information associated with a given translated instruction consists of hints, the auxiliary cache access may be dropped and execution may continue without that auxiliary information. In some embodiments, if there is a miss on the auxiliary cache, and the auxiliary information associated with a given translated instruction is “architectural”, then a demand-miss mechanism may be employed to fill in the required information. In one embodiment, the demand-miss mechanism may access binary translation metadata using a hardware-based memory walker. In one embodiment, a hardware-based memory walked may allow multiple such fill operations to take place in parallel in the out-of-order window. In another embodiment, the demand-miss mechanism may access binary translation metadata using a software-based mechanism in which an interrupt is issued and a software-based memory walker obtains the auxiliary information. In some embodiments, a single demand-miss may load an entire cache's line worth of auxiliary information into the auxiliary cache.

In embodiments in which the auxiliary cache is being used only for NWIs, an auxiliary cache that includes 64 entries or fewer may be sufficient to provide the performance and resource utilization benefits described herein. In one embodiment, if the entire micro-ISA were designed around the use of the auxiliary cache (e.g., if on the order of 80% of micro-ISA instructions access the auxiliary cache), a larger auxiliary cache, such as one having 1K entries, may be more appropriate.

Fetch and decode bandwidth is a critical and constrained commodity in the front-end or modern processors, and it is becoming an even bigger constraint in processors that support longer immediate values and non-working instructions (NWIs). Some existing systems include hardware-only mechanisms to address this issue, such as a Decode Stream Buffer (DSB). However, as processor designs continue to increase the out-of-order execution window, fetch and decode bandwidth is expected to become a critical bottleneck, even in processors that include DSB. The mechanisms described herein, which utilize an auxiliary cache to reduce fetch and decode bandwidth requirements, may address the root cause of the issue by reducing the size of instructions, and the instruction count itself, in certain cases. Embodiments of the present disclosure include a hardware-software co-designed approach that may be able to handle cases that a hardware-only approach cannot achieve; since a co-designed approach provides the freedom to dynamically customize the incoming code stream. In at least some embodiments, the hardware-software co-designed mechanism uses a small hardware structure (referred to herein as an auxiliary cache) to store information related to the targeted instructions, such as long immediate values, so that the size of the instruction can be reduced. This may lead to reduced fetch and decode bandwidth usage. The software portion of this co-designed mechanism, which may be implemented within the binary translator, may modify and annotate the instruction stream so that it initializes and makes use of the hardware structure to reduce fetch and decode bandwidth usage.

Mechanisms that utilize an auxiliary cache to reduce fetch and decode bandwidth requirements are described herein in terms of their application to a hardware-software co-designed processor. In such embodiments, the described approach depends on hardware and software interacting with each other to implement this approach, which improves functionality and performance over traditional processors. In various embodiments, any in-order or out-of-order processor may make use of this approach to improve the performance of memory operations. Additionally, any processor that uses dynamic binary translation, may find this approach useful to handle fetch bandwidth pressure using software help. With the increasing emphasis on power consumption, many mobile processor designers are expected to develop hardware-software co-designed processors in the future. Any or all such processors may potentially make use of this approach.

Embodiments of the mechanisms disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code may be applied to input instructions to perform the functions described herein and generate output information. The output information may be applied to one or more output devices, in known fashion. For purposes of this application, a processing system may include any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine-readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Accordingly, embodiments of the disclosure may also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part-on and part-off processor.

Thus, techniques for performing one or more instructions according to at least one embodiment are disclosed. While certain exemplary embodiments have been described and shown in the accompanying drawings, it is to be understood that such embodiments are merely illustrative of and not restrictive on other embodiments, and that such embodiments not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

Some embodiments of the present disclosure include a processor. In at least some of these embodiments, the processor may include a front end to decode an instruction in an instruction stream, an execution unit to execute the instruction, an auxiliary cache to store auxiliary information for the instruction, an instruction blender, and a retirement unit to retire the instruction. In some embodiments, the auxiliary information may not be decoded by the front end. The auxiliary cache may include logic or circuitry to receive a request from a binary translator to write the auxiliary information to the auxiliary cache, logic or circuitry to store the auxiliary information in the auxiliary cache, and logic or circuitry to provide the auxiliary information to the instruction blender prior to execution of the instruction. The instruction blender may include logic or circuitry to receive, from the auxiliary cache prior to execution of the instruction, the auxiliary information for the instruction, logic or circuitry to blend the decoded instruction with the auxiliary information to produce a blended instruction, and logic or circuitry to provide the blended instruction to the execution unit for execution. In combination with any of the above embodiments, the request to write the auxiliary information to the auxiliary cache may include information usable to identify the location within the auxiliary cache at which to store the auxiliary information. In combination with any of the above embodiments, the instruction may be an instruction of a first instruction set architecture (ISA) implemented by the processor, the instruction may be produced by the binary translator dependent on an instruction of a second ISA, and the auxiliary information may include information included in the instruction of the second ISA that is not to be consumed until execution of the instruction. In combination with any of the above embodiments, the instruction may be an instruction of a first instruction set architecture (ISA) implemented by the processor, the instruction may be produced by the binary translator dependent on an instruction of a second ISA, and the auxiliary information may include information associated with a non-working instruction that was added to the instruction stream by the binary translator, the non-working instruction being dependent on translation of an instruction stream including instructions of the second ISA to the instruction stream including the instruction of the first ISA. In combination with any of the above embodiments, the instruction may include an encoding to indicate that the decoded instruction is to be blended with the auxiliary information for the instruction, the encoding having been added to the instruction by the binary translator. In combination with any of the above embodiments, the auxiliary cache may include a hardware table with a plurality of columns, each of which may store auxiliary information of a respective one of multiple auxiliary information types supported in the processor. The multiple auxiliary information types may include one or more of immediate values, branch hints, prediction hints, next-branch-distances, jump distances, prefetch hints, branch type indicators, amounts by which to increment an instruction pointer, page identifiers, keys, or identifiers of functions to be performed during execution of the instruction in addition to functions defined for the instruction by an instruction set architecture (ISA) implemented by the processor. In combination with any of the above embodiments, the instruction may be an instruction of a first instruction set architecture (ISA) implemented by the processor, the instruction may be produced by the binary translator dependent on an instruction of a second ISA, the instruction of the second ISA may be an instruction within a super block of instructions on which the binary translator performed a translation, and the auxiliary cache may further include logic or circuitry to load all auxiliary information for instructions within the super block of instructions into the auxiliary cache in a single operation. In combination with any of the above embodiments, the processor may include logic or circuitry to receive a request to remove the auxiliary information from the auxiliary cache or to invalidate the auxiliary information in the auxiliary cache. In any of the above embodiments, the execution unit may include an out-of-order execution engine. In combination with any of the above embodiments, the instruction may be an instruction of a first instruction set architecture (ISA) implemented by the processor, the instruction may be produced by the binary translator dependent on an instruction of a second ISA, the instruction of the second ISA may be an instruction within a super block of instructions on which the binary translator performed a translation, and the auxiliary information may include information associated with a non-working instruction that was added to the instruction stream by the binary translator, the non-working instruction to be added at a boundary of the result of the super block translation. In combination with any of the above embodiments, the auxiliary cache may include circuitry to manage the replacement and removal of entries in the auxiliary cache. In combination with any of the above embodiments, the auxiliary cache may include circuitry to load one or more entries of the auxiliary cache from an instruction memory. In combination with any of the above embodiments, the replacement and removal of entries in the auxiliary cache may be managed by program instructions executing on the processor. In combination with any of the above embodiments, entries of the auxiliary cache may be loaded from an instruction memory by program instructions executing on the processor. In combination with any of the above embodiments, the instruction may be an instruction of a first instruction set architecture (ISA) implemented by the processor, the instruction may be produced by the binary translator dependent on an instruction of a second ISA, and the instruction of the second ISA may include an encoding representing an index into the auxiliary cache, the index usable to identify the location within the auxiliary cache at which to store the auxiliary information. In combination with any of the above embodiments, the instruction may be an instruction of a first instruction set architecture (ISA) implemented by the processor, the instruction may be produced by the binary translator dependent on an instruction in a stream of instructions of a second ISA, and the auxiliary information may include information associated with a non-working instruction that was added to the instruction stream by the binary translator, the non-working instruction to perform manipulating an instruction pointer to emulate an instruction pointer for the stream of instructions of the second ISA. In combination with any of the above embodiments, the instruction may be an instruction of a first instruction set architecture (ISA) implemented by the processor, the instruction may be produced by the binary translator dependent on an instruction of a second ISA, and the auxiliary information may include information associated with a non-working instruction that was added to the instruction stream by the binary translator, the non-working instruction to perform committing an atomic operation.

Some embodiments of the present disclosure include a method. The method may be for executing instructions. In at least some of these embodiments, the method may include receiving, by an auxiliary cache in a processor, a request from a binary translator to write auxiliary information for an instruction in an instruction stream to the auxiliary cache, storing the auxiliary information to the auxiliary cache, receiving the instruction, decoding the instruction, executing the instruction, and retiring the instruction. Executing the instruction may include accessing the auxiliary information stored in the auxiliary cache, blending the auxiliary information with the decoded instruction to produce a blended instruction, and providing the blended instruction to an execution unit for execution. In combination with any of the above embodiments, the instruction may be an instruction of a first instruction set architecture (ISA) implemented by the processor, the method may further include producing, by the binary translator dependent on an instruction of a second ISA, the instruction, and the auxiliary information may include information included in the instruction of the second ISA that is not to be consumed until execution of the instruction. In combination with any of the above embodiments, the instruction may be an instruction of a first instruction set architecture (ISA) implemented by the processor, the method may further include producing, by the binary translator dependent on an instruction of a second ISA, the instruction, and adding, to the instruction stream by the binary translator dependent on translation of an instruction stream including instructions of the second ISA to the instruction stream including the instruction of the first ISA, a non-working instruction, and the auxiliary information may include information associated with the non-working instruction. In combination with any of the above embodiments, the instruction may be an instruction of a first instruction set architecture (ISA) implemented by the processor, the method may further include, prior to receiving the instruction, producing, by the binary translator dependent on an instruction of a second ISA, the instruction, determining, by the binary translator, that the instruction of the second ISA may include the auxiliary information, and adding, to the instruction by the binary translator, an encoding to indicate that the decoded instruction is to be blended with the auxiliary information for the instruction. In combination with any of the above embodiments, the instruction may be an instruction of a first instruction set architecture (ISA) implemented by the processor, the method may further include, prior to receiving the instruction, translating, by the binary translator, instructions within a super block of instructions of a second ISA to the instruction stream including the instruction of the first ISA, including producing, by the binary translator dependent on an instruction of a second ISA, the instruction, and storing, by the binary translator in a single operation, all auxiliary information for instructions within the super block of instructions into the auxiliary cache. In combination with any of the above embodiments, the method may include receiving, by the auxiliary cache in the processor, a request from the binary translator to remove the auxiliary information from the auxiliary cache or to invalidate the auxiliary information in the auxiliary cache. In combination with any of the above embodiments, the request to write the auxiliary information to the auxiliary cache may include information usable to identify the location within the auxiliary cache at which to store the auxiliary information. In combination with any of the above embodiments, the execution unit may include an out-of-order execution engine. In combination with any of the above embodiments, the auxiliary cache may include a hardware table with a plurality of columns, each of which may store auxiliary information of a respective one of multiple auxiliary information types supported in the processor. The multiple auxiliary information types may include one or more of immediate values, branch hints, prediction hints, next-branch-distances, jump distances, prefetch hints, branch type indicators, amounts by which to increment an instruction pointer, page identifiers, keys, or identifiers of functions to be performed during execution of the instruction in addition to functions defined for the instruction by an instruction set architecture (ISA) implemented by the processor. In combination with any of the above embodiments, the instruction may be an instruction of a first instruction set architecture (ISA) implemented by the processor, the method may further include, prior to receiving the instruction, translating, by the binary translator, instructions within a super block of instructions of a second ISA to the instruction stream including the instruction of the first ISA, including producing, by the binary translator dependent on an instruction of a second ISA, the instruction, and adding a non-working instruction at a boundary of the result of the super block translation, and the auxiliary information may include information associated with the non-working instruction. In combination with any of the above embodiments, the method may include performing, by circuitry within the auxiliary cache, replacement or removal of one or more entries in the auxiliary cache. In combination with any of the above embodiments, the method may include performing, by circuitry within the auxiliary cache, loading one or more entries of the auxiliary cache from an instruction memory. In combination with any of the above embodiments, the method may include executing program instructions to replace or remove one or more entries of the auxiliary cache. In combination with any of the above embodiments, the method may include executing program instructions to load one or more entries of the auxiliary cache from an instruction memory. In combination with any of the above embodiments, the instruction may be an instruction of a first instruction set architecture (ISA) implemented by the processor, the method may further include, prior to receiving the instruction, producing, by the binary translator dependent on an instruction of a second ISA, the instruction, the instruction of the second ISA may include an encoding representing an index into the auxiliary cache, and storing the auxiliary information to the auxiliary cache may include storing the auxiliary information at the identified location. In combination with any of the above embodiments, the instruction may be an instruction of a first instruction set architecture (ISA) implemented by the processor, the method may further include producing, by the binary translator dependent on an instruction in a stream of instructions of a second ISA, the instruction, and adding, to the instruction stream by the binary translator, a non-working instruction to perform manipulating an instruction pointer to emulate an instruction pointer for the stream of instructions of the second ISA. In combination with any of the above embodiments, the instruction may be an instruction of a first instruction set architecture (ISA) implemented by the processor, the method may further include producing, by the binary translator dependent on an instruction of a second ISA, the instruction, and adding, to the instruction stream by the binary translator, a non-working instruction to perform committing an atomic operation. In combination with any of the above embodiments, the instruction may be an instruction of a first instruction set architecture (ISA) implemented by the processor, the method may further include translating, by the binary translator prior to receiving the instruction, instructions within a super block of instructions of a second ISA to a stream of instructions of the first ISA that do not access the auxiliary cache, executing the stream of stream of instructions of the first ISA that do not access the auxiliary cache, determining, by a hardware profiler, that an instruction in the stream of instructions of the first ISA that do not access the auxiliary cache is to be executed multiple times, and that the instruction in the stream of instructions of the first ISA that do not access the auxiliary cache may include the auxiliary information, retranslating, by the binary translator prior to receiving the instruction, instructions within the super block of instructions of the second ISA to the instruction stream including the instruction of the first ISA, including producing, by the binary translator dependent on an instruction of a second ISA, the instruction. In combination with any of the above embodiments, decoding the instruction does not include decoding the auxiliary information for the instruction.

Some embodiments of the present disclosure include a system. In at least some of these embodiments, the system may include a binary translator, and a processor. The processor may include a front end to decode an instruction in an instruction stream, an execution unit to execute the instruction, an auxiliary cache to store auxiliary information for the instruction, an instruction blender, and a retirement unit to retire the instruction. The auxiliary information may not be decoded by the front end. The auxiliary cache may include logic or circuitry to receive a request from the binary translator to write the auxiliary information to the auxiliary cache, logic or circuitry to store the auxiliary information in the auxiliary cache, and logic or circuitry to provide the auxiliary information to the instruction blender prior to execution of the instruction. The instruction blender may include logic or circuitry to receive, from the auxiliary cache prior to execution of the instruction, the auxiliary information for the instruction, logic or circuitry to blend the decoded instruction with the auxiliary information to produce a blended instruction, and logic or circuitry to provide the blended instruction to the execution unit for execution. In combination with any of the above embodiments, the request to write the auxiliary information to the auxiliary cache may include information usable to identify the location within the auxiliary cache at which to store the auxiliary information. In combination with any of the above embodiments, the instruction may be an instruction of a first instruction set architecture (ISA) implemented by the processor, the binary translator may include logic or circuitry to produce the instruction dependent on an instruction of a second ISA, and the auxiliary information may include information included in the instruction of the second ISA that is not to be consumed until execution of the instruction. In combination with any of the above embodiments, the instruction may be an instruction of a first instruction set architecture (ISA) implemented by the processor, the binary translator may include logic or circuitry to produce the instruction dependent on an instruction of a second ISA, and logic or circuitry to add a non-working instruction to the instruction stream, the non-working instruction being dependent on translation of an instruction stream including instructions of the second ISA to the instruction stream including the instruction of the first ISA, and the auxiliary information may include information associated with the non-working instruction. In combination with any of the above embodiments, the instruction may include an encoding to indicate that the decoded instruction is to be blended with the auxiliary information for the instruction, the encoding having been added to the instruction by the binary translator. In combination with any of the above embodiments, the binary translator may include logic or circuitry to issue the request to write the auxiliary information to the auxiliary cache, and logic or circuitry to issue a request to remove the auxiliary information from the auxiliary cache or to invalidate the auxiliary information in the auxiliary cache. In combination with any of the above embodiments, the execution unit may include an out-of-order execution engine. In combination with any of the above embodiments, the auxiliary cache may include a hardware table with a plurality of columns, each of which may store, auxiliary information of a respective one of multiple auxiliary information types supported in the processor. The multiple auxiliary information types may include one or more of immediate values, branch hints, prediction hints, next-branch-distances, jump distances, prefetch hints, branch type indicators, amounts by which to increment an instruction pointer, page identifiers, keys, or identifiers of functions to be performed during execution of the instruction in addition to functions defined for the instruction by an instruction set architecture (ISA) implemented by the processor. In combination with any of the above embodiments, the instruction may be an instruction of a first instruction set architecture (ISA) implemented by the processor, the instruction may be produced by the binary translator dependent on an instruction of a second ISA, the instruction of the second ISA may be an instruction within a super block of instructions on which the binary translator performed a translation, and the auxiliary cache may further include logic or circuitry to load all auxiliary information for instructions within the super block of instructions into the auxiliary cache in a single operation. In combination with any of the above embodiments, the instruction may be an instruction of a first instruction set architecture (ISA) implemented by the processor, the instruction may be produced by the binary translator dependent on an instruction of a second ISA, the instruction of the second ISA may be an instruction within a super block of instructions on which the binary translator performed a translation, and the auxiliary information may include information associated with a non-working instruction that was added to the instruction stream by the binary translator, the non-working having been added at a boundary of the result of the super block translation. In combination with any of the above embodiments, the auxiliary cache may further include circuitry to manage the replacement and removal of entries in the auxiliary cache. In combination with any of the above embodiments, the auxiliary cache may further include circuitry to load one or more entries of the auxiliary cache from an instruction memory. In combination with any of the above embodiments, the replacement and removal of entries in the auxiliary cache may be managed by program instructions executing on the processor. In combination with any of the above embodiments, entries of the auxiliary cache may be loaded from an instruction memory by program instructions executing on the processor. In combination with any of the above embodiments, the instruction may be an instruction of a first instruction set architecture (ISA) implemented by the processor, the instruction may be produced by the binary translator dependent on an instruction of a second ISA, and the instruction of the second ISA may include an encoding representing an index into the auxiliary cache. The index may be usable to identify the location within the auxiliary cache at which to store the auxiliary information. In combination with any of the above embodiments, the instruction may be an instruction of a first instruction set architecture (ISA) implemented by the processor, the instruction may be produced by the binary translator dependent on an instruction in a stream of instructions of a second ISA, and the auxiliary information may include information associated with a non-working instruction that was added to the instruction stream by the binary translator, the non-working instruction being an instruction to perform manipulating an instruction pointer to emulate an instruction pointer for the stream of instructions of the second ISA. In combination with any of the above embodiments, the instruction may be an instruction of a first instruction set architecture (ISA) implemented by the processor, the instruction may be produced by the binary translator dependent on an instruction of a second ISA, and the auxiliary information may include information associated with a non-working instruction that was added to the instruction stream by the binary translator, the non-working instruction being an instruction to perform committing an atomic operation.

Some embodiments of the present disclosure include a system for executing instructions. In at least some of these embodiments, the system may include a processor, including an auxiliary cache, means for receiving, by the auxiliary cache, a request from a binary translator to write auxiliary information for an instruction in an instruction stream to the auxiliary cache, means for storing the auxiliary information to the auxiliary cache, means for receiving the instruction, means for decoding the instruction, means for executing the instruction, including means for accessing the auxiliary information stored in the auxiliary cache, means for blending the auxiliary information with the decoded instruction to produce a blended instruction, and means for providing the blended instruction to an execution unit for execution, and means for retiring the instruction. In combination with any of the above embodiments, the instruction may be an instruction of a first instruction set architecture (ISA) implemented by the processor, the system may further include means for producing, by the binary translator dependent on an instruction of a second ISA, the instruction, and the auxiliary information may include information included in the instruction of the second ISA that is not to be consumed until execution of the instruction. In combination with any of the above embodiments, the instruction may be an instruction of a first instruction set architecture (ISA) implemented by the processor, the system may further include means for producing, by the binary translator dependent on an instruction of a second ISA, the instruction, and means for adding, to the instruction stream by the binary translator dependent on translation of an instruction stream including instructions of the second ISA to the instruction stream including the instruction of the first ISA, a non-working instruction, and the auxiliary information may include information associated with the non-working instruction. In combination with any of the above embodiments, the instruction may be an instruction of a first instruction set architecture (ISA) implemented by the processor, the system may further include means for producing, by the binary translator prior to receiving the instruction and dependent on an instruction of a second ISA, the instruction, means for determining, by the binary translator prior to receiving the instruction, that the instruction of the second ISA may include the auxiliary information, and means for adding, to the instruction by the binary translator prior to receiving the instruction, an encoding to indicate that the decoded instruction is to be blended with the auxiliary information for the instruction. In combination with any of the above embodiments, the instruction may be an instruction of a first instruction set architecture (ISA) implemented by the processor, the system may further include means for translating, by the binary translator prior to receiving the instruction, instructions within a super block of instructions of a second ISA to the instruction stream including the instruction of the first ISA, including means for producing, by the binary translator dependent on an instruction of a second ISA, the instruction, and means for storing, by the binary translator in a single operation, all auxiliary information for instructions within the super block of instructions into the auxiliary cache. In combination with any of the above embodiments, the system may further include means for receiving, by the auxiliary cache, a request from the binary translator to remove the auxiliary information from the auxiliary cache or to invalidate the auxiliary information in the auxiliary cache. In combination with any of the above embodiments, the request to write the auxiliary information to the auxiliary cache may include information usable to identify the location within the auxiliary cache at which to store the auxiliary information. In combination with any of the above embodiments, the execution unit may include an out-of-order execution engine. In combination with any of the above embodiments, the auxiliary cache may include a hardware table with a plurality of columns, each of which may store auxiliary information of a respective one of multiple auxiliary information types supported in the processor. The multiple auxiliary information types may include one or more of immediate values, branch hints, prediction hints, next-branch-distances, jump distances, prefetch hints, branch type indicators, amounts by which to increment an instruction pointer, page identifiers, keys, or identifiers of functions to be performed during execution of the instruction in addition to functions defined for the instruction by an instruction set architecture (ISA) implemented by the processor. In combination with any of the above embodiments, the instruction may be an instruction of a first instruction set architecture (ISA) implemented by the processor, the system may further include means for translating, by the binary translator prior to receiving the instruction, instructions within a super block of instructions of a second ISA to the instruction stream including the instruction of the first ISA, including means for producing, by the binary translator dependent on an instruction of a second ISA, the instruction, and means for adding a non-working instruction at a boundary of the result of the super block translation, and the auxiliary information may include information associated with the non-working instruction. In combination with any of the above embodiments, the system may further include means for performing, by circuitry within the auxiliary cache, replacement or removal of one or more entries in the auxiliary cache. In combination with any of the above embodiments, the system may further include means for performing, by circuitry within the auxiliary cache, loading one or more entries of the auxiliary cache from an instruction memory. In combination with any of the above embodiments, the system may further include means for executing program instructions to replace or remove one or more entries of the auxiliary cache. In combination with any of the above embodiments, the system may further include means for executing program instructions to load one or more entries of the auxiliary cache from an instruction memory. In combination with any of the above embodiments, the instruction may be an instruction of a first instruction set architecture (ISA) implemented by the processor, the system may further include means for producing, by the binary translator prior to receiving the instruction and dependent on an instruction of a second ISA, the instruction, the instruction of the second ISA may include an encoding representing an index into the auxiliary cache, and the means for storing the auxiliary information to the auxiliary cache may include means for storing the auxiliary information at the identified location. In combination with any of the above embodiments, the instruction may be an instruction of a first instruction set architecture (ISA) implemented by the processor, the system may further include means for producing, by the binary translator dependent on an instruction in a stream of instructions of a second ISA, the instruction, and means for adding, to the instruction stream by the binary translator, a non-working instruction to perform manipulating an instruction pointer to emulate an instruction pointer for the stream of instructions of the second ISA. In combination with any of the above embodiments, the instruction may be an instruction of a first instruction set architecture (ISA) implemented by the processor, the system may further include means for producing, by the binary translator dependent on an instruction of a second ISA, the instruction, and means for adding, to the instruction stream by the binary translator, a non-working instruction to perform committing an atomic operation. In combination with any of the above embodiments, the instruction may be an instruction of a first instruction set architecture (ISA) implemented by the processor, the system may further include means for translating, by the binary translator prior to receiving the instruction, instructions within a super block of instructions of a second ISA to a stream of instructions of the first ISA that do not access the auxiliary cache, means for executing the stream of stream of instructions of the first ISA that do not access the auxiliary cache, means for determining that an instruction in the stream of instructions of the first ISA that do not access the auxiliary cache is to be executed multiple times, and that the instruction in the stream of instructions of the first ISA that do not access the auxiliary cache may include the auxiliary information. The system may also include means for retranslating, by the binary translator prior to receiving the instruction, instructions within the super block of instructions of the second ISA to the instruction stream including the instruction of the first ISA, including means for producing, by the binary translator dependent on an instruction of a second ISA, the instruction. In combination with any of the above embodiments, the means for decoding the instruction does not decode the auxiliary information for the instruction prior to its storage in the auxiliary cache.

What is claimed is:

1. A processor, comprising:
a front end including circuitry to decode an instruction in an instruction stream;
an execution unit including circuitry to execute the instruction;
an auxiliary cache including circuitry to store auxiliary information for the instruction;
an instruction blender; and
a retirement unit including circuitry to retire the instruction;
wherein:
the auxiliary information is not decoded by the front end;
the auxiliary cache comprises circuitry to:
receive a request from a binary translator to write the auxiliary information to the auxiliary cache;
store the auxiliary information in the auxiliary cache; and
provide the auxiliary information to the instruction blender prior to execution of the instruction;
the instruction blender comprises circuitry to:
receive, from the auxiliary cache prior to execution of the instruction, the auxiliary information for the instruction;
blend the decoded instruction with the auxiliary information to produce a blended instruction; and
provide the blended instruction to the execution unit for execution.

2. The processor of claim 1, wherein the request to write the auxiliary information to the auxiliary cache includes information usable to identify the location within the auxiliary cache at which to store the auxiliary information.

3. The processor of claim 1, wherein:
the instruction is an instruction of a first instruction set architecture (ISA) implemented by the processor;
the instruction is produced by the binary translator dependent on an instruction of a second ISA; and
the auxiliary information comprises information included in the instruction of the second ISA that is not to be consumed until execution of the instruction.

4. The processor of claim 1, wherein:
the instruction is an instruction of a first instruction set architecture (ISA) implemented by the processor;
the instruction is produced by the binary translator dependent on an instruction of a second ISA; and
the auxiliary information comprises information associated with a non-working instruction that is added to the instruction stream by the binary translator, the non-working instruction to be dependent on translation of an instruction stream comprising instructions of the second ISA to the instruction stream comprising the instruction of the first ISA.

5. The processor of claim 1, wherein the instruction comprises an encoding to indicate that the decoded instruction is to be blended with the auxiliary information for the instruction, the encoding added to the instruction by the binary translator

6. The processor of claim 1, wherein:
the auxiliary cache comprises a hardware table with a plurality of columns, each of which is to store auxiliary information of a respective one of multiple auxiliary information types supported in the processor, the multiple auxiliary information types to include one or more of:
immediate values;
branch hints;
prediction hints;
next-branch-distances;
jump distances;
prefetch hints;
branch type indicators;
amounts by which to increment an instruction pointer;
page identifiers;
keys; or
identifiers of functions to be performed during execution of the instruction in addition to functions defined for the instruction by an instruction set architecture (ISA) implemented by the processor.

7. The processor of claim 1, wherein:
the instruction is an instruction of a first instruction set architecture (ISA) implemented by the processor;
the instruction is produced by the binary translator dependent on an instruction of a second ISA;
the instruction of the second ISA is an instruction within a super block of instructions on which the binary translator performed a translation; and
the auxiliary cache further comprises circuitry to:
load all auxiliary information for instructions within the super block of instructions into the auxiliary cache in a single operation.

8. A method, comprising:
receiving, by an auxiliary cache in a processor, a request from a binary translator to write auxiliary information for an instruction in an instruction stream to the auxiliary cache;
storing the auxiliary information to the auxiliary cache;
receiving the instruction;
decoding the instruction;
executing the instruction, including:
accessing the auxiliary information stored in the auxiliary cache;
blending the auxiliary information with the decoded instruction to produce a blended instruction; and
providing the blended instruction to an execution unit for execution; and
retiring the instruction.

9. The method of claim 8, wherein:
the instruction is an instruction of a first instruction set architecture (ISA) implemented by the processor;
the method further includes producing, by the binary translator dependent on an instruction of a second ISA, the instruction; and
the auxiliary information comprises information included in the instruction of the second ISA that is not to be consumed until execution of the instruction.

10. The method of claim 8, wherein:
the instruction is an instruction of a first instruction set architecture (ISA) implemented by the processor;
the method further includes:
producing, by the binary translator dependent on an instruction of a second ISA, the instruction; and
adding, to the instruction stream by the binary translator dependent on translation of an instruction stream comprising instructions of the second ISA to the instruction stream comprising the instruction of the first ISA, a non-working instruction; and
the auxiliary information comprises information associated with the non-working instruction.

11. The method of claim 8, wherein:
the instruction is an instruction of a first instruction set architecture (ISA) implemented by the processor;
the method further includes, prior to receiving the instruction:
producing, by the binary translator dependent on an instruction of a second ISA, the instruction;
determining, by the binary translator, that the instruction of the second ISA includes the auxiliary information; and
adding, to the instruction by the binary translator, an encoding to indicate that the decoded instruction is to be blended with the auxiliary information for the instruction.

12. The method of claim 8, wherein:
the instruction is an instruction of a first instruction set architecture (ISA) implemented by the processor;
the method further includes, prior to receiving the instruction:
translating, by the binary translator, instructions within a super block of instructions of a second ISA to the instruction stream comprising the instruction of the first ISA, including:
producing, by the binary translator dependent on an instruction of a second ISA, the instruction; and
storing, by the binary translator in a single operation, all auxiliary information for instructions within the super block of instructions into the auxiliary cache.

13. The method of claim 8, further comprising:
receiving, by the auxiliary cache in the processor, a request from the binary translator to remove the auxiliary information from the auxiliary cache or to invalidate the auxiliary information in the auxiliary cache.

14. A system, comprising:
a binary translator; and
a processor, including:
a front end including circuitry to decode an instruction in an instruction stream;
an execution unit including circuitry to execute the instruction;
an auxiliary cache including circuitry to store auxiliary information for the instruction;
an instruction blender; and
a retirement unit including circuitry to retire the instruction;
wherein:
the auxiliary information is not decoded by the front end;
the auxiliary cache comprises circuitry to:
receive a request from the binary translator to write the auxiliary information to the auxiliary cache;
store the auxiliary information in the auxiliary cache; and
provide the auxiliary information to the instruction blender prior to execution of the instruction;
the instruction blender comprises circuitry to:
receive, from the auxiliary cache prior to execution of the instruction, the auxiliary information for the instruction;
blend the decoded instruction with the auxiliary information to produce a blended instruction; and
provide the blended instruction to the execution unit for execution.

15. The system of claim 14, wherein the request to write the auxiliary information to the auxiliary cache includes information usable to identify the location within the auxiliary cache at which to store the auxiliary information.

16. The system of claim 14, wherein:
the instruction is an instruction of a first instruction set architecture (ISA) implemented by the processor;
the binary translator comprises circuitry to produce the instruction dependent on an instruction of a second ISA; and
the auxiliary information comprises information included in the instruction of the second ISA that is not to be consumed until execution of the instruction.

17. The system of claim 14, wherein:
the instruction is an instruction of a first instruction set architecture (ISA) implemented by the processor;
the binary translator comprises circuitry to:
produce the instruction dependent on an instruction of a second ISA; and
add a non-working instruction to the instruction stream, the non-working instruction to be dependent on translation of an instruction stream comprising instructions of the second ISA to the instruction stream comprising the instruction of the first ISA; and
the auxiliary information comprises information associated with the non-working instruction.

18. The system of claim 14, wherein the instruction comprises an encoding to indicate that the decoded instruction is to be blended with the auxiliary information for the instruction, the encoding added to the instruction by the binary translator

19. The system of claim 14, wherein the binary translator comprises circuitry to:
issue the request to write the auxiliary information to the auxiliary cache; and
issue a request to remove the auxiliary information from the auxiliary cache or to invalidate the auxiliary information in the auxiliary cache.

20. The system of claim 14, wherein the execution unit comprises an out-of-order execution engine.
